(19) United States
(12) Patent Application Publication
(10) Pub. No.: US 2026/0337446 A1
(43) Pub. Date: Oct. 29, 2026

(54) END-LINKED POLYURETHANEUREA AND SHAPED ARTICLES THEREFROM

(71) Applicant: THE LYCRA COMPANY LLC, Wilmington, DE (US)

(72) Inventor: Hong Liu, Waynesboro, VA (US)

(21) Appl. No.: 19/702,239

(22) Filed: Jun. 9, 2026

Related U.S. Application Data
(63) Continuation of application No. PCT/US2026/016285, filed on Feb. 23, 2026.
(60) Provisional application No. 63/761,235, filed on Feb. 21, 2025.

(51) Int. Cl. C09D 175/12; C08G 18/10; C08G 18/64; C08K 3/22; C09D 5/24; C09D 7/61; H01G 9/00; H01G 9/042; H01G 9/048; H01M 4/02; H01M 4/131; H01M 4/525; H01M 4/62; H01M 4/66

(52) U.S. Cl. CPC C09D 175/12; C08G 18/10; C08G 18/6423; C09D 5/24; C09D 7/61; H01G 9/0029; H01G 9/0425; H01G 9/048; H01M 4/131; H01M 4/525; H01M 4/622; H01M 4/661; C08K 2003/2293; C08K 2201/001; H01M 2004/028

(57) ABSTRACT

The present disclosure describes end-linked linear segmented polyurethaneurea (end-linked sPUU) polymers chemically crosslinked through end-linking reactions to preserve the structural functions of the soft segments and hard segments of the component linear sPUU chains. The disclosure also relates to shaped articles made of the polymers in which the end-linking reactions occur during and/or after articles are shaped. The crosslinked polymers, which can be fluorine free, are useful for a variety of purposes, including electronic applications, with the polymers and shaped articles having improved stability and durability to heat and/or solvent exposure. The end-linked sPUUs and articles comprising them are insoluble in many organic solvents and find use as binders for cathode active materials of lithium ion and other batteries.

### CROSS REFERENCE TO RELATED APPLICATION

This application claims the benefit of U.S. Provisional Patent Application No. 63/761,235, filed Feb. 21, 2025.

### BACKGROUND

Many conventional polymers used in electronics and other applications incorporate fluorinated components. Those fluorinated polymers include the conventional binders found in batteries, such as polyvinylidene fluoride (PVDF), copolymers of vinylidene difluoride (VdF), and hexafluoropropene (HFP). Attempts to replace fluorinated organic materials and to improve the performance of electronic materials have produced some useful compositions. Indeed, other polymers used in applications such as binders for primary cell (non-rechargeable) and/or secondary cell (rechargeable) battery electrodes include carboxymethylcellulose (CMC) or its sodium salt (CMC-Na), poly(acrylic acid) (PAA) or its sodium salt (PAA-Na), and styrene-butadiene rubber (SBR), but such binders have limitations on their use at the cathodes or anodes. Accordingly, polymers for electronic applications, and particularly polymers for use as binders for secondary cell cathodes, can benefit from further development of non-fluorinated polymeric binders with suitable chemical and electrical performance over a broad range of temperatures.

U.S. Pat. No. 4,963,310 discloses a process for production of polyester polyurethane elastomeric fibers with the use of a diaminosilyl compound as a co-extender in extending the isocyanate terminated prepolymer and thus introduces crosslinking through alkoxysilane groups during or after the fiber spinning. In spite of the crosslinking achieved by this method aimed at improved hydrolytic stability of the polyester based spandex fiber, incorporation of such co-extenders will inevitably compromise the hard segment integrity and thus the physical, thermal and mechanical properties of the fiber. Further, for the crosslinking of alkoxysilane groups to occur, moisture must be present with the assistance of heat and acid catalyst. It is therefore very difficult to achieve the crosslinking in as-spun fibers without additional post spinning treatment.

U.S. Pat. No. 6,637,181 describes a process of spinning segmented polyurethanes in the melt state to produce elastane yarn and filament having improved mechanical and thermal properties by using a macrodiol mixture containing a hydroxyalkyl-terminated polysiloxane, an isocyanate mixture of diisocyanates and specific crosslinking-capable polyisocyanates with NCO functionality of greater than 2, and diols of low molecular weight as chain extenders. It is very difficult to control the crosslinking reaction extent as the premature crosslinking reaction can cause gel-formation prior to the spinning which can cause spinneret pressure build-up and/or yarn breaks during the spinning. In addition, this type of crosslinking reaction also interferes with the intermolecular hard segment associations as the crosslinks are randomly distributed along the polymer backbones.

U.S. Pat. No. 7,357,889 discloses a melt spinning process of polyether based thermoplastic polyurethanes in combination with an isocyanate-terminated non-polyether-based urethane prepolymer as a crosslinking agent to minimize spinneret pressure build-up and reduce the tendency of yarn breakage during spinning. The cross-linking reaction again occurs at the urethane groups of the polymer backbones and runs the risk of interrupting hard segment integrity and associations. That type of crosslinking reactions requires high activation temperatures and is limited to processing of polymers in the molten state.

U.S. Pat. No. 5,512,064 discloses a process for modifying various natural and synthetic fibers including polyurethane fibers through topical treatments during the dyeing step, with the use of a water soluble polyalkyleneimine polymer and a bi-functional crosslinking agent such as glyoxal. Although this process preserves the bulk properties of the fibers treated, it requires a modified dyeing process and thus limits its applications.

While those skilled in the art have recognized the need to introduce chemical crosslinks into segmented polyurethanes for improved resistances to heat and solvents, they have not been able to use crosslinking chemistry for the production of shaped articles simultaneously meeting performance and processing requirements. By way of example, it was not previously possible to prepare in solution crosslinked segmented polyurethanes such as polyurethaneureas using multi-functional amines in the chain extension step and resulting in a formed three-dimensional polymer-like gel that could be freely processed into a desired shaped article such as by spinning.

An improved method is therefore needed to provide well-defined chemical crosslinks in segmented polyurethanes, and especially for polyurethaneureas, in polymer solution-based processes without the deficiencies and limitations of the prior arts described above.

### SUMMARY

The present disclosure describes segmented polyurethaneurea (sPUU) polymers chemically crosslinked through polymer chain end groups (end-linking reactions) to form end-linked sPUUs, so that the structural functions of the soft segments and hard segments are not disrupted. Those end-linked segmented polyurethaneurea polymers may be prepared by using a controllable delayed end-linking reaction triggered by heat activation after the polymer chains are formed, which has not been previously described or suggested in the art. The disclosure also relates to shaped articles prepared from end-linked polymers wherein the end-linking reactions occur in the polyurethaneurea polymer post polymerization and during and/or after the process of forming shaped articles. Thus, the formed and shaped articles have improved stability and durability upon exposures to heat and/or solvents.

Segmented polyurethanes including polyurethaneureas consist of multi-block phase-separated soft segments and hard segments. The soft segments are long, flexible and amorphous, generally consisting of a long chain polyether or polyester based diol or its dimerized or trimerized derivatives formed during a prepolymerization step, while the hard segments are short, rigid, and crystalline, typically consisting of urethane or urea repeat units formed during a chain extension step. In shaped articles such as spandex or elastane fibers, or in films or nonwoven articles, the soft segments of the polymer provided stretch with applied force and the recovery upon released tension, while the hard segments in the polymer act as the tie points, to prevent the polymer chains from slippage upon stretching and to thus minimize the permanent set of the fiber. The combination of the soft segments and hard segments forms a “virtually cross-linked” network structure through non-covalent intermolecular crosslinks at hard segment tie points, which accounts for the elasticity of articles shaped from those polymers. Such non-covalent intermolecular crosslinks are based on hydrogen bonds involving the urethane or urea groups and can be reversibly overcome by heat or by solvation. Accordingly, although beneficial for the polymer processability and physico-mechanical properties, such non-covalent crosslinks do not provide adequate performance in special end use applications. Where improved properties such as heat resistance and/or solvent resistance are desired or even required, covalent chemical crosslinking of the segmented polyurethanes or polyurethaneureas is preferred. In order to maintain elastomeric properties, covalent crosslinks introduced into the polymer should not interfere with the segmental structures of the polymer, and accordingly, the elastic behavior of the shaped articles. The present disclosure provides a method of substantially or completely restricting crosslinking to the ends of polyurethaneureas. Additionally, by providing a method of forming crosslinks through end-linking reactions after the polyurethaneurea polymer is fully formed and during or after formation of shaped articles (e.g., dry-spun fibers, stretch nonwoven articles and coated films), the disclosure provides a means of avoiding interference of the crosslinks in the processability of the polymers.

The end-linked polymers described herein are useful for a variety of purposes, including electronic applications. Among the electronic applications in which the segmented polyurethaneureas described herein may be employed are various insulators, moisture resistant coatings for electronic components (resistors, circuit boards etc.), and binders for primary and secondary cell electrodes (anodes and cathodes). The polyurethaneurea compositions described herein find particular use in alkali metal (e.g., lithium or sodium) batteries, such as lithium-ion batteries (e.g., as binders in cathodes). The combination of: (i) elasticity, (ii) ability to stabilize and retain particulates (e.g., particles of cathode active materials and/or electrically conductive materials), (iii) ability to adhere to current collecting materials (e.g., aluminum or nickel), and (iv) stability in harsh chemical environment (e.g., electrolytes and active species) found in the batteries over a broad range of temperatures makes them particularly useful as binders for cathode secondary cells based on alkali metals. The high molecular weight embodiments of the polymers described herein are understood to be particularly stable to the chemical environment found in lithium-ion batteries. Although segmented polyurethaneureas have low conductivity and are moisture resistant, making them suitable as insulators, they may be mixed with a variety of metallic and non-metallic materials to form compositions with increased conductivity. The ability to form (shape) such conductive compositions contributes to their suitability in a variety of electronic applications including as binders for the above-mentioned battery electrodes.

The sPUU component (the linear sPUU polymer chains) of the end-linked sPUUs described in the present disclosure comprise a soft segment, and a hard segment, wherein the hard segment content of the sPUU component may be from about 4.5% to about 15.5%, or about 5.75% to about 15.25% by weight of the sPUU component as defined according to European Patent EP3724248B, or the corresponding U.S. Pat. Pub. US20210087388A1. The soft segment content of the sPUU component may be from about 84% to about 96%, or about 84.5% to about 94.5% by weight of the sPUU component as defined according to European Patent EP3724248B, or the corresponding U.S. Pat. Pub. US20210087388A1. The sPUU component (the linear sPUU polymer chains) may have having a soft segment molecular weight (SSMW) to the hard segment molecular weight (SSMW/HSMW) ratio, (i.e., soft segment Mn/hard segment Mn) in a range of about 5 to about 20 or about 5.5 to about 16.25 as defined according to European Patent EP3724248B, or the corresponding U.S. Pat. Pub. US20210087388A1; both of which are incorporated by reference for their description of polymer molecular weight and calculation, its synthetic control, and hard and soft segment definitions. The molecular weight ranges of those sPUU components may vary over ranges controlled by factors including, but not limited to, adjusting the molecular weight of the diol prepolymer, amount of blocking agents/chain terminators, molecular weight of the amine group chain extenders, processing time, and temperatures, for example as discussed in EP3724248B1. In some embodiments, the sPUUs may have a number average molecular weight (Mn) in the range of about 25,000 to about 75,000 Daltons (Da). In some embodiments, weight averaged molecular weight (Mw) may be in the range of about 100,000 to about 345,000 Da. The average molecular weight (Mz) may be in the range of about 170,000 to about 645,000 Da.

The segmented polyurethaneureas of the present disclosure offer a variety of advantages aside from chemical resistance and tailorable conductivity. The polyurethanes themselves may be prepared from non-fluorinated materials, and other components in compositions comprising the segmented polyurethaneureas, including dispersants and additives (e.g., antioxidants, lubricants, etc.) along with electrically conductive materials may also comprise no fluorine (e.g., be comprised of non-fluorinated organic molecules). Accordingly, the sPUU polymers described herein may be used to replace many fluorinated polymers used in electronic components including fluorinated polymers such as polyvinylidene fluoride (PVDF) or polytetrafluoroethylene (PTFE) used as a binder in many secondary cells based on alkali metal chemistry such as lithium-ion batteries thereby eliminating the generation of environmentally hazardous materials. Additionally, sPUUs described herein, including those supplemented with dispersants, provide excellent adhesion to metals (e.g., used as current collectors in battery electrodes) and other components such as particles of electrically conductive materials and active materials (e.g., cathode active materials) found in such secondary cells. Accordingly, the end-linked sPUUs of the present disclosure represent a non-fluorinated alternative to polymers such as PTFE and PVDF used in electrochemical cells (secondary cells such as rechargeable Li-ion batteries), performance about equal or superior to those fluorinated polymers. Physically, the sPUUs described herein have advantageously superior: stretch and recovery, substantial elongation at break, and limited shrinkage upon drying/curing. Polyurethaneureas have also been reported to reduce dissolution of metals from cathodes, which would contribute to extended secondary cell life (see, e.g., WO 2025/012257). Furthermore, the sPUUs described herein may also be comprised of bio-derivable materials (e.g., poly(tetramethylene ether) glycols (PTMEGs) derived from bioderived 1,4-butane diol). At the end of their life cycle, the end-linked sPUUs may be decomposed, reused, or recycled.

The present disclosure also includes and provides for methods of making the sPUUs, and their use as binders in the preparation of electronic components including, but not limited to, battery components (e.g., cathodes, anodes, and insulators). The elastomeric nature of the sPUUs permits objects formed with components comprising sPUUs to be reshaped following their initial preparation. The elasticity and adhesion properties of the sPUUs allow production of, for example, electronic components comprising layers of coated substrates to be prepared as flat sheets in continuous or semi continuous processes, after which the sheet(s) are reformed into other shapes such as wound cathodes or anodes for cylindrical batteries or capacitors (e.g., metalized, discrete, or hybrid foil electrodes, any of which may be wound) prepared with non-conductive sPUU insulator layers.

Additionally, the application includes and provides the articles prepared from the sPUUs including but not limited to films, fibers, yarns, extruded articles, and their use in the aforementioned electronic components.

### BRIEF DESCRIPTION OF THE DRAWING

FIG. 1A at A shows a generic synthesis of a sPUU (e.g., having no fluorine atoms, or fluoroalkyl or perfluoroalkyl components) wherein x and y are integers. At B the figure shows a schematic of a sPUU structure for comparison with the schematic shown in FIG. 1C.

FIG. 1B shows two synthetic routes for the preparation of end-linked sPUU polymers or articles prepared from them (xi). Route A proceeds through one or more protected prepolymer(s) (v) that is reacted with one or more chain extenders (extender vi) and one or more crosslinkers (viii). Route B proceeds through a full formed sPUU in the form of a protected polymer (vii) that is reacted with a crosslinking agent (viii). Solvent and additive(s) (x) indicate some nonlimiting locations where those inputs may be added and “—Solvent” indicates some nonlimiting locations where solvent is removed. Route C shows a path to a segmented polyurethane urea that is not end-linked as no crosslinking agent was included, but which can be used for comparison of physical properties.

FIG. 1C in the upper portion shows a generic synthesis of a protected sPUU polymer prepared with exemplary blocking agents of the form R1R2NH where R1 and R2 are, for example, alkyl groups or C1-C4 lower alkyl groups (x and y are integers). The lower portion of the figure shows reaction of the protected polymer with a crosslinking agent to produce an end-linked sPUU shown schematically in the lower portion of the figure. The reaction to the end-linked sPUU proceeds thorough route B of FIG. 1B, and as with the sPUU may have no fluorine atoms, fluoroalkyl. or perfluoroalkyl components.

FIG. 1D at a-k shows some polymers that maybe utilized as crosslinking agents. At i and k the figure shows dendrimeric polyethylenimine (PEI) and dendrimeric polyamidoamine (PAMAM) polymers as examples of dendrimeric polymers that may be utilized as crosslinking agents.

FIG. 2 shows a battery electrode (e.g., a cathode) at A comprising a current collector in the form of a sheet (1), an insulating edge comprising an electrically nonconductive polymer composition (e.g., a sPUU as described herein) (2), and a layer of active material (e.g., a cathode active material) in a sPUU binder of the present disclosure. A cross section, indicated by the dashed circle, at the edge of the electrode A is shown at B. Cross sections C and D depict cross sections at the edge of electrodes formed on a sheet of current collector where the insulating edge (2) wraps around the current collector. The electrodes at C and D have active material in a sPUU binder (3) on one or both sides of the electrode.

FIG. 3 shows a plot of the amount of polymer as an insoluble gel as the weight percent relative to the weight of total solids expected from a polymerization reaction versus the amount of PEI used to prepare the polymer.

FIG. 4 shows the change in viscosities (given in poise) that occurs over two weeks of holding a composition for the preparation of an end-linked sPUU comprising a blocked polymer and differing levels of crosslinker (PEI) at 40 °C. More details are described in Example 18.

FIG. 5 shows at A Differential Scanning Calorimetry (DSC) thermograms of a control sPUU that is not end-linked and at B a DSC thermogram of the corresponding end-linked sPUU.

FIG. 6 shows thermogravimetric analysis TGA of a control sPUU and an end-linked sPUU.

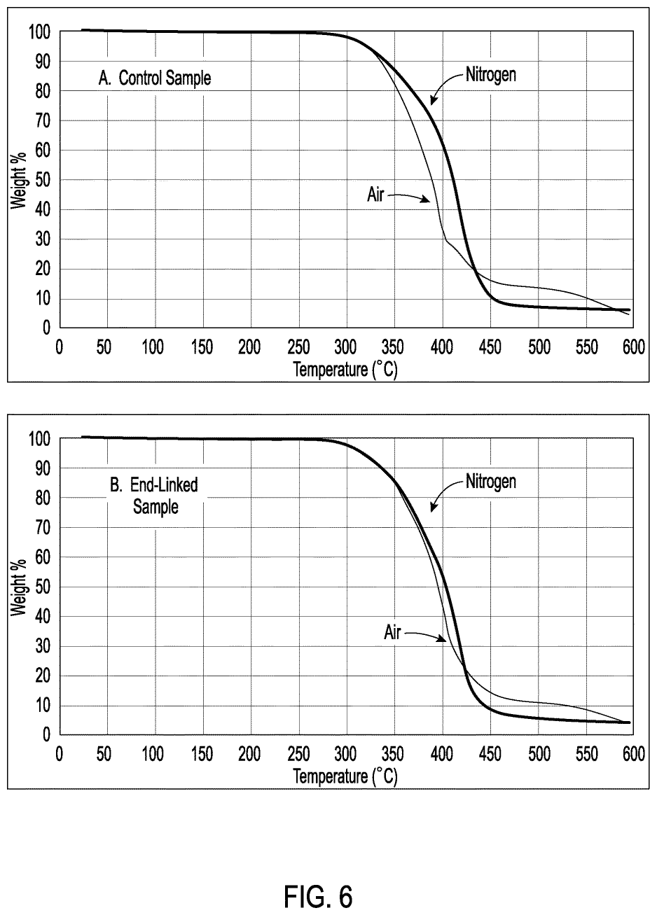

FIG. 7 shows scanning electron micrograph (SEM) cross-sections battery cathodes prepared on an aluminum current collector (bottom of each micrograph, but readily visible in C). The scale bar represents 30 microns. SEM images of nickel manganese cobalt (NMC) oxide particles in a cathode binder comprising about 1% by weight of an end-linked sPUU are shown before cycling (A) and after repeated cycling (B). SEM images of lithium iron phosphate (LFP, LiFePO4) particles in a cathode binder comprising about 1% by weight of an end-linked sPUU are shown before cycling (C) and after repeated cycling (D).

FIG. 8 shows in the upper portion a voltage trace for the initial charge and discharge of lithium-ion secondary cells prepared with end-linked sPUU polymer binder (“End-Linked voltage”) trace or PVDF (“PVDF voltage”) trace. The lower portion of FIG. 8 shows electrochemical impedance measurements for three lithium-ion cells prepared with end-linked sPUU polymer binder (“End-Linked”) and three cells prepared with PVDF binder (“PVDF HFP” 1 to 3).

FIG. 9 shows in the upper portion a plot of the percent capacity retention (relative to their initial value) over multiple charge cycles (CC) and discharge cycles (DC) for three lithium-ion secondary cells with cathodes comprising NMC as the active material and end-linked sPUU as the binder. The lower portion of FIG. 9 compares the specific capacity of three lithium-ion secondary cells with cathodes comprising NMC as the active material and either PVDF or end-linked sPUU as the binder. The comparison is conducted over multiple charge and discharge cycles at different current densities.

FIG. 10 shows a plot of the percent capacity retention (relative to their initial value) over multiple charge cycles (CC) and discharge cycles (DC) for three lithium-ion secondary cells with cathodes comprising LFP as the active material and end-linked sPUU as the binder.

### DETAILED DESCRIPTION

### I. Definitions

As used herein polyurethaneurea (sometimes referred to as a polyurethane-urea or polyurethane/polyurea) is segmented polyurethane that contains both urethane and urea linkages. Polyurethaneurea elastomers are polyurethanes that contain soft polyol segments terminated at urethane linkages and joined by hard segments that contain urea linkages. Polyurethaneureas with soft segments comprising urethane linkages alternating with hard segments comprising urea linkages may be formed by (i) reacting a glycol and an excess diisocyanate in the pre-polymer formation step, and (ii) reacting the remaining isocyanates in the prepolymer with one or more diamine chain extenders and where desired a chain terminator in a chain extension step.

“Elastomeric” or “elastomer” as used herein to describe a sPUU polymer or end-linked sPUU polymer means that the polyurethaneurea is deformable and may return to its original shape if deformed. In other words, an elastomeric sPUU or end-linked sPUU is not rigid and when deformed may substantially or completely recover its original size and shape.

As used herein, “spandex” means a manufactured fiber in which the fiber-forming substance is a long-chain synthetic elastomer comprised of at least 85% by weight of a segmented polyurethane. Polyurethaneureas are a sub-class of such segmented polyurethanes. “Spandex” can be used interchangeably with “elastane.”

“Crosslinked” polymer means the polymer chains of a segmented polyurethane are linked together to form a three-dimensional network structure. Once crosslinked, the polymer cannot be re-dissolved back into a solvent to form a homogeneous solution. “Chemically crosslinked” means that the polymer chains are linked together by covalent bonds. “End-linking” is a special type of crosslinking, by which three or more chain ends of a polyurethaneurea are linked together through covalent bonds.

Deblocking and unblocking mean the conversion of a blocked or protected functionality, particularly isocyanate groups, to regenerate an isocyanate group or its synthetic equivalent. Deblocking temperature means the temperature at which most (more than 50%) or all blocked functionalities, particularly blocked isocyanates, are converted back to the active functionality (e.g., an isocyanate) or their synthetic equivalent in the time period of the desired end-linking reaction.

“Shaped article” means a processed article, such as fibers either in filament or staple form, stretch webs, nonwovens with uniform or non-uniform pore sizes, cast articles, extruded articles, sheets or films, and coated films (coatings) either in continuous or discontinuous patterns.

The term “nonwoven” or “nonwoven material” refers herein to a material made from continuous (long) filaments (fibers) and/or discontinuous (short) filaments (fibers) by processes such as solution spunbonding, solution blowing, carding, molding, compressing, impregnating, and the like. Nonwovens do not have a woven or knitted filament pattern.

The term insoluble, with regard to the end-linked sPUUs described herein, means the end-linked polymers have a solubility less than 1% in DMAc on a weight to weight basis. In contrast, soluble with regard to a sPUU (not end-linked) means the polymer has a solubility greater than or equal to 1% on a weight basis in a stated solvent such as DMAc.

As used herein, the term “about” used in connection with an amount indicates that the amount can vary by 5% of the stated amount. For example, “about 100” means an amount of from 95-105. Where “about” is used in the context of a range, the “about” used in reference to the lower amount of the range means that the lower amount includes an amount that is 5% lower than the lower amount of the range, and “about” used in reference to the higher amount of the range means that the higher amount includes an amount 5% higher than the higher amount of the range. For example, from about 100 to about 1000 means that the range extends from 95 to 1050.

Functionality of at least 2 means there are at least two of the referenced functional groups present on a molecule. For example, the amine functionality of 1,6-diamino hexane is 2. Functionality of at least 2 in conjunction with a mixture (population) of molecules means that on average there are at least two of the referenced functional groups present on the molecules in the mixture. A functionality of 3, a functionality of 4, or higher functionalities are treated in the same manner.

Unless stated otherwise Mw (weight average molecular weight), Mn (number averaged molecular weight), and Mz (Z-average molecular weight) are determined by gel permeation chromatography (GPC) as described herein below. Where Mw or the other values are indicated as being measured by light scattering (LS), as in the case of some commercial reagents, the values, including Mw, may be determined consistent with ASTM D4001-20 for polymers in the 10,000-10,000,000 Mw range.

Soft and hard segments and their weight percentages are defined as described in European Patent EP3724248B1

As used herein the terms anode and cathode refer to the electrodes of a primary or secondary cell acting to supply current (as a galvanic cell). Accordingly, the anode is the negatively charged electrode at which oxidation occurs and the cathode is the positively charged electrode at which reduction occurs.

Anode and cathode active materials refer to the materials that are used to prepare those electrodes and which undergo redox reactions in the operation of the electrochemical cells in which they are utilized.

Melting point of materials, and particularly of polymer that may melt over a range, is understood to mean the main peak of the melting curve determined by means of a differential scanning calorimeter (DSC) device. Specifically, as an example, 8 mg of a sample may be placed into a DSC device, and the temperature raised under an atmosphere of N₂, at a rate of 10 °C/min, thereby melting the sample and producing a DSC curve from which the temperature of the principal peak is used as the melting point.

### II. Description

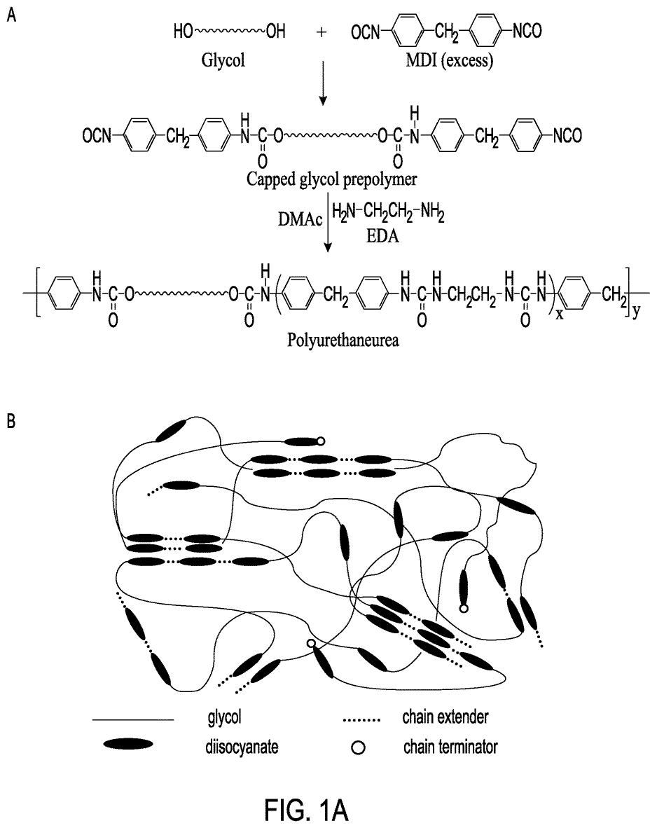

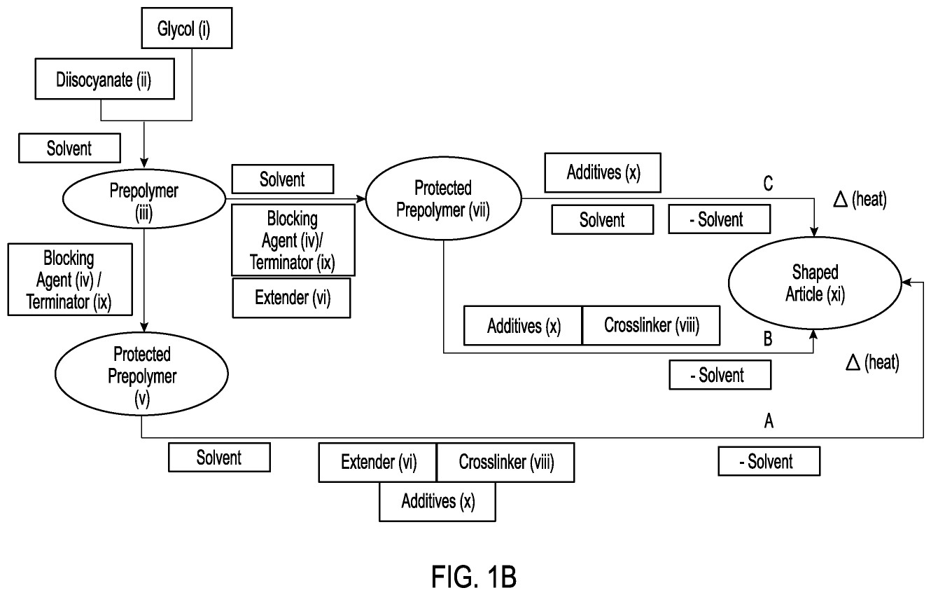

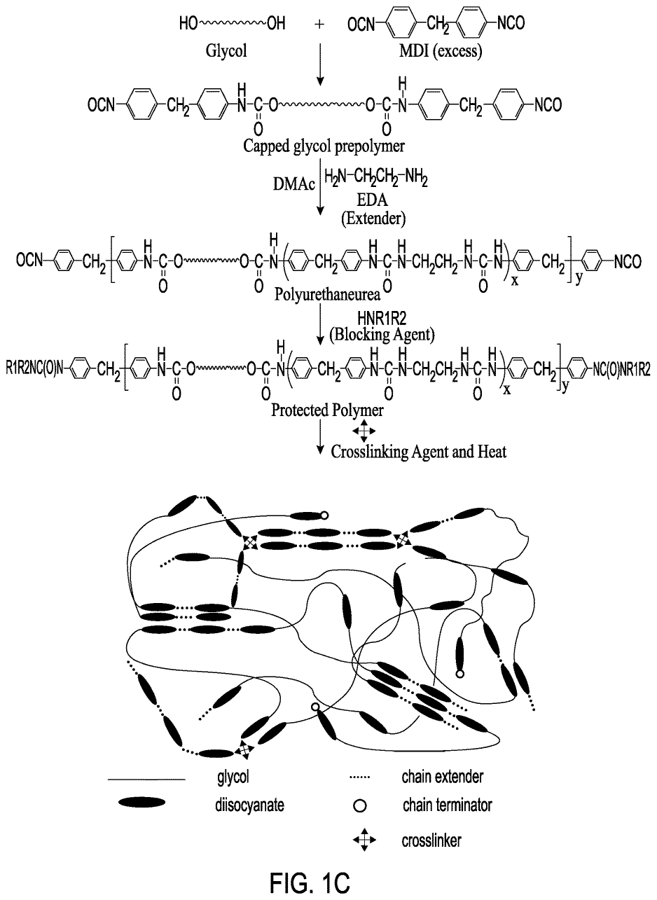

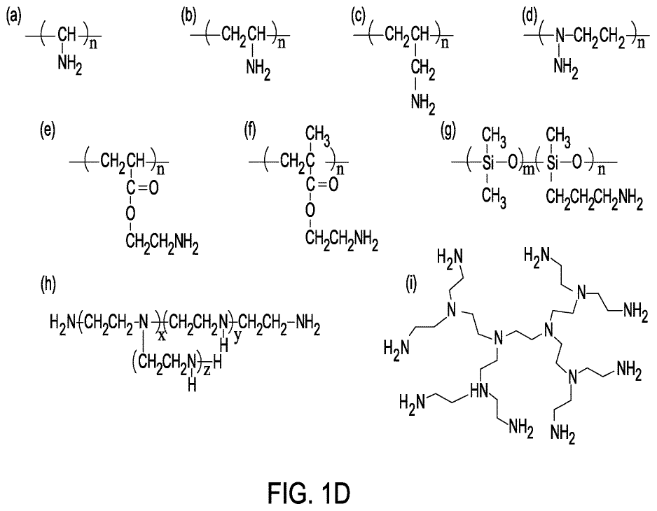

The present disclosure includes and provides for sPUUs that have properties suitable for use in a diverse array of applications, including in the production of a variety of electronic components. The end-linked sPUUs described herein may be prepared via two routes outlined in FIG. 1B. The synthetic routes both start with the formation of a prepolymer formed from a diisocyanate and a glycol. In the first synthetic route the prepolymer is then reacted with a blocking agent (e.g., heat labile chain terminator) to form a protected prepolymer with blocked isocyanate functionalities. Mixing of the protected prepolymer with a difunctional chain extender (e.g., an organic molecule with two primary amines), crosslinker, and any desired additives (see route A across the bottom of FIG. 1B), followed by heating permits polymerization to form the end-linked sPUU polymer. Polymerization is conducted in conjunction with forming, such as by spinning or casting, results in a shaped article. In the second synthetic route (see route B in FIG. 1B), the prepolymer is combined with a difunctional chain extender (e.g., an organic molecule with two primary amines), a blocking agent (e.g., heat labile chain terminator) to form blocked isocyanates, and any solvents necessary for processing, to form a protected polymer. That protected polymer is combined with optional additives and a crosslinker, after which it is subject to solvent removal and heating to activate the blocked isocyanate and form the end-linked polymer. When the end-linked polymer is prepared in conjunction with forming, the result is a shaped article. It should be noted that the protected polymer can be mixed with additives and subject to solvent removal and heating to form a non-crosslinked version of the polymer or article as, for example, a control when testing the effect of end-linking (see route C in FIG. 1B).

The end-linked sPUUs of the present disclosure find use as, among other things, binders of active material particles used in electrodes of electrochemical cells (e.g., secondary cells). The elastomeric nature of the end-linked polymers permits repeated deposition of and dissolution of the activated materials or their components. In an embodiment, the cell is a lithium-ion secondary cell where the end-linked sPUUs are binders of cathode active materials. In addition to their ability to adjust to repeated changes in the size of active material particles (e.g., cathode active materials) due to deposition and dissolution during repeated charge and discharge cycles, the sPUUs offer additional advantages. Chemically, the sPUUs of the present disclosure are end-linked and accordingly retain hard segments of sPUUs comprising both urethane and urea groups that are capable of hydrogen bonding and which serve to stabilize the polymer and that can stabilize electrode structures without interference from the crosslinking agents at the end of polymer chains. The disclosed end-linked sPUUs, when used as an electrode binder, can bond (e.g., by hydrogen bonding) to the surface of particles attached to or embedded in the electrode, such as particles of cathode active materials, thereby stabilizing their association within the binder and with the electrode. The sPUUs can also bind (e.g., by hydrogen bonding) to electrically conductive materials (e.g., graphite powder) and current collectors of the anode or cathode (e.g., to metal oxides or hydroxides formed on the surface of the current collector) such as oxides on the surface of a cathode aluminum current collector. Additionally, the hard segment groups capable of hydrogen bonding can form intrachain hydrogen bonds that can stabilize the sPUU structure.

The prepolymers utilized to prepare the end-linked sPUUs of the present disclosure may exclude components such as multivalent (e.g., trivalent or higher) isocyanates, amines, or hydroxyl containing components that can lead to crosslinking of prepolymer chains at positions other than their ends.

Physically, the disclosed end-linked sPUU polymers are elastomers with superior ability to recover their shape after deformation and that substantially retain the high elongation at break observed for their non-crosslinked counterparts. In addition, the disclosed end-linked polymers are more resistant to being dissolved by solvents including, but not limited to, ethylene carbonate, propylene carbonate, dimethyl carbonate, ethyl methyl carbonate, diethyl carbonate, and combinations thereof used in lithium ion batteries. They are also resistant to degradation and dissolution electrolytes comprising those solvents and typical lithium ion battery electrolyte salts such as lithium hexafluorophosphate, lithium tetrafluoroborate, and lithium perchlorate. Electrically, they are nonconductive and may act as insulators, but may be doped with conductive materials rendering them electrically conductive. Their dielectric constant renders them suitable for use in some electronic applications, where they may act as replacements for some fluorinated polymeric materials. The end-linked sPUUs described herein may be prepared with components that lack fluorine (other than as a trace contaminant), which renders them suitable replacements for fluorinated polymers such as PVDF and PTFE in many applications.

The present disclosure includes and provides for end-linked sPUUs and articles prepared from end-linked sPUUs. The end-linked sPUUs and shaped articles comprising them are typically made in processes that comprise the following steps. First, as illustrated in FIG. 1B, a polymeric glycol (e.g., with terminal hydroxyl groups) (i) is reacted or capped with a diisocyanate (ii) to form a prepolymer (iii a capped glycol with isocyanate terminal groups). The molar ratio of the diisocyanate to the glycol, or the capping ratio, is typically in a range of about 1.30 to about 2.50. Other capping ratio ranges include about 1.3 to about 1.8, or about 1.8 to about 2.3. Additionally, the capping ratio may be in the range of about 1.3 to about 1.8, or about 1.8 to about 2.0. Capping ratio ranges over 2 include 2.0 to about 2.25 and about 2.25 to about 2.5. The prepolymer can be made either in a batch reactor or in a continuous reactor. An isocyanate reactive block agent (c) (e.g., heat labile chain terminators) can be added before, during or after the formation of the prepolymer.

Second, as shown in FIG. 1B as route B, the viscous prepolymer is dissolved in a polar aprotic solvent such as N,N-dimethylacetamide (DMAc), N,N-dimethylformamide (DMF), or N-methylpyrrolidone (NMP), and is chain extended with a diamine (vi) in the presence of the isocyanate reactive terminator or block agent (ix) to form a protected polymer (vii, a protected sPUU polymer) with blocked isocyanate end groups. Alternatively, as in FIG. 1B route A, the block agent (iv) can be added and mixed with the prepolymer (iii) during or after the dissolution with a solvent to form a protected prepolymer (v).

Third, in route B the protected polymer (vii, sPUU polymer) is reacted with a crosslinking agent (viii), or alternatively, the protected prepolymer (v) is reacted with a crosslinking agent (viii) and a diamine chain extender (vi). For the reaction a solution comprising protected polymer (vii) or protected prepolymer (v) (e.g., 5% to 50% by weight), with optionally added functional additives, is mixed with one or more crosslinking agents (viii) (e.g., a polyamine crosslinking agent) prior to entering a process to produce the end-linked sPUU or a shaped article comprising an end-linked sPUU. Following FIG. 1B route A the protected prepolymer (v) is mixed with one or more chain extenders (vi), one or more crosslinking agents (viii), and optionally one or more additives. When following route B of FIG. 1B the protected polymer (vii) is mixed with one or more crosslinking agents (viii), and optionally one or more additives.

Fourth, the process of forming the end-linked sPUU or article comprising the end-linked sPUU continues with the application of heat to evaporate the solvent and trigger release of the blocking agents, thereby permitting reaction of the formerly blocked isocyanate with the crosslinking agent and/or chain extender and resulting in formation of the end-linked polymer. Shaping the compositions subject to heating while releasing the blocking agents results in a shaped article. Regardless of the route chosen, the temperature of the compositions must be controlled in the above-mentioned steps to prevent premature dissociation or undesired deblocking of the ends of the blocked polymer chain ends, thereby avoiding premature activation of isocyanate groups and polymer end-linking before polymer formation is desired, or the intended article is shaped.

For the preparation of end-linked sPUUs, at least 50% or at least 80% of the polymer chain ends of segmented polyurethaneurea polymer chains (protected polymer) are present as blocked isocyanate groups. Generally, the blocked isocyanate group can be deblocked (e.g., the blocking agent can be dissociated and regenerate an isocyanate group or its synthetic equivalent) at an onset temperature no higher than 200 °C. Suitable deblocking temperatures may be, for example, in the range of 60 °C to 150 °C. The concentration of these blocked isocyanate groups is at least 10 and up to about 100 milliequivalent (meq) per kilogram (kg) (meq/kg) of the polymer solids, where 1 meq/kg equals 1 millimole of a functionality, blocked isocyanate in this instance, per kilogram of the polymer. The remainder of the polymer chain end groups can be the unreacted amino (—NH₂) group from, for example, the diamine chain extender. Optionally, polymer end groups can also be permanently blocked or terminated by, for example, reaction with a chain terminator to produce so-called “dead ends” that are not able to regenerate isocyanate groups or their synthetic equivalent at a deblocking temperature below 200 °C during the time required for the crosslinking phase of end-linked sPUU preparation.

The amount of crosslinking agent (e.g., polyamine crosslinking agent) used to prepare end-linked sPUU polymers is dependent on the relative ratio of the available amino (—NH₂) groups present in the crosslinker (viii) (e.g., on a polyamine crosslinker such as a polyethylenimine or PEI) to the blocked isocyanate end groups of the protected polyurethaneurea polymer (vii). For the formation of a network structure through the end-linking reactions, the relative ratio of the amino (e.g. isocyanate reactive amino groups such as —NH₂) groups to the blocked isocyanate groups (e.g., written as (isocyanate reactive amine groups)/(isocyanate groups)) is in a range of 0.5 to 5.0. The relative ratio may be for example from a ratio of 0.5 to a ratio of 1.0, or from a ratio of 1.0 to a ratio of 2.5 The relative ratio may be from a ratio of 2.5 to a ratio of 4.0 or from a ratio of 4.0 to a ratio of 5.0. Alternatively, the relative ratio may be from a ratio of 0.75 to a ratio of 1.25 or from a ratio of 0.9 to a ratio of 1.1. Alternatively, the relative ratio may be from a ratio of 0.95 to a ratio of 1.05 or from a ratio of 1.05 to 1.10. It may be preferred to have a slight excess of amine groups (isocyanate reactive amine groups) that is less than 5% greater than the isocyanate groups present on a molar basis that may be expressed as a ratio greater 1.00 up to a ratio of 1.05.

When utilizing polyamine polymers as crosslinking agents, such as PEI (e.g., with a weight average molecular weight or Mw from about 800 to 25,000 Da), the weight percentage of the polyamine crosslinking agent used in the end-linked polymer (excluding additives) may, for example, be from about 0.1% to about 10% of the protected polymer (synthesis route B) or the sum of the protected prepolymer and extender (synthesis route A). The weight ratio may be from about 0.1% to about 2.5% or from about 2.5% to about 5%. The weight ratio may also be from about 5.0% to about 7.5% or from about 7.5% to about 10%.

Where protected polymers are being crosslinked to form the end-linked sPUUs, as in route B in FIG. 1B, any residual amino groups in the polymer stemming from the extender may be added to the calculation of the ratio; however, the amount may be negligible relative to the amount of amine groups present in the crosslinker.

The end-linked sPUUs, and articles prepared from them, may comprise as components:
(a) one or more linear glycols (i), wherein the one or more linear glycols comprise a linear polyether glycol, linear polyester-glycol, linear polycarbonate-glycol or combinations of any thereof, and optionally wherein at least one of the one or more linear glycols has a number average molecular weight (Mn) from about 650 to about 5000 Da,
(b) one or more diisocyanates (ii) (e.g., a mixture of diisocyanates including, but not limited to, mixtures of diisocyanate isomers),
(c) one or more chain extenders (vi) selected from aliphatic diamines or a mixture of diamines, comprising at least one diamine having a molecular weight less than 300 Da,
(d) one or more isocyanate reactive blocking agents (iv) (e.g., a heat labile chain terminator) or a mixture of one or more blocking agents and one or more chain terminators, and
(e) one or more polyamine crosslinking (end-linking) agents (viii) with a functionality of primary amino (·NH₂) groups greater than two (e.g., 3 or more, or four or more) in the molecule.

The present disclosure includes and provides for end-linked segmented polyurethaneurea (end-linked sPUU) polymers comprising:
one or more crosslinking agents, each having an amine functionality greater than two, said crosslinking agents being bound to more than two linear sPUU polymer chains at their ends through urea linkages formed with the amine groups of the crosslinking agent(s);
wherein the linear sPUU polymer chains are comprised of soft segments and hard segments, and wherein the soft segments comprise one or more linear glycols selected from the group consisting of linear polyether glycols, linear polyester-glycols, linear polycarbonate-glycols and combinations of any thereof.

Such end-linked sPUU polymers may be described as comprising molecules of crosslinking agents in which multiple (more than two) amine groups on the molecules of the crosslinking agents are covalently bound through urea linkages to the ends of segmented polyurethaneurea polymer chains. The crosslinking agents may be small molecules comprising three or more amine functionalities (e.g., wherein one or more or at least three are primary amine groups). The crosslinking agents also may be polyamines having an amine functionality greater than three, such as with amine terminated polymeric crosslinking agents such as amine terminated PEI polymers.

Those end-linked sPUU polymers, in the case in which synthesis route A of FIG. 1B is employed, may be described as being a product comprised of:
(i) one or more protected prepolymers (v) (e.g., a linear prepolymer comprising blocked terminal isocyanate groups) prepared from (comprising)
   (a) one or more linear glycols (i), (e.g., one or more linear glycols comprising at least one linear polyether glycol, linear polyester-glycol, linear polycarbonate-glycol, or combinations of any thereof), wherein at least one of the one or more linear glycols optionally has a number average molecular weight (Mn) from about 650 to about 5000 Da, reacted with
   (b) one or more diisocyanates (ii) (e.g., a mixture of diisocyanates including, but not limited to, mixtures of diisocyanate isomers),
to form an isocyanate capped prepolymer (iii), that is subsequently reacted with
   (c) one or more isocyanate reactive thermolabile blocking agents (iv) or a mixture of two or more thermolabile blocking agents, and optionally one or more chain terminators (ix),
to form the one or more protected prepolymers (v) comprising blocked isocyanate end groups;
which are then reacted (in a solvent) with
(ii) one or more chain extenders (vi) (e.g., selected from aliphatic diamines or a mixture of diamines), wherein at least one of the diamines optionally has a molecular weight less than 300 Da, and one or more polyamine crosslinking agents (vii) each having an amine functionality greater than two,
   to form the end-linked sPUU polymer (e.g., in the form of a shaped article) by heating (e.g., by heating to a sufficient temperature) to remove the blocking agent and permit the previously blocked isocyanate groups to react with the one or more chain extenders (e.g., to form urea or urethane linkages) and one or more crosslinking agents (e.g., to form urea linkages).

This disclosure includes and provides for a method of preparing an end-linked sPUU polymer comprising:
(i) reacting
   (a) one or more linear glycols (i), (e.g., one or more linear glycols comprising at least one linear polyether glycol, linear polyester-glycol, linear polycarbonate-glycol or combinations of any thereof), wherein at least one of the one or more linear glycols optionally has a number average molecular weight (Mn) from about 650 to about 5000 Da, and
   (b) one or more diisocyanates (ii) (e.g., a mixture of diisocyanates including, but not limited to, mixtures of diisocyanate isomers),
   to form an isocyanate capped prepolymer (iii),
   (c) the isocyanate capped prepolymer (iii) is subsequently reacted one or more isocyanate reactive thermolabile blocking agents (iv) or a mixture of two or more thermolabile blocking agents, and optionally one or more chain terminators (ix),
   to form the one or more protected prepolymers (v) comprising blocked isocyanate end groups;
(ii) the one or more protected prepolymers (v) are then combined (in a solvent) with one or more chain extenders (vi) (e.g., selected from aliphatic diamines or a mixture of diamines), wherein at least one of the diamines optionally has a molecular weight less than 300 Da, and one or more polyamine crosslinking agents (viii) each having an amine functionality greater than two, to form a composition for producing an end-linked sPUU polymer;
(iii) heating the composition for producing an end-linked sPUU polymer (e.g., in the form of a shaped article) to remove the blocking agent from prepolymer (v), thereby permitting the previously blocked isocyanate groups to react with the amine groups of the one or more chain extenders (e.g., to form urea or urethane linkages) and amine groups of the one or more crosslinking agents (viii) (e.g., to form urea linkages) that results in production of the end-linked sPUU polymer.
   Polyamine crosslinking agents that have an isocyanate reactive amine functionality greater than three or greater than four may be utilized in the method. The polyamine crosslinking agents may be one or more polymeric polyamine crosslinking agents such as PEI and/or PAMAM.

One or more additives may be present in the final polymer composition if the additives are added at any point in the synthetic process that does not interfere with end-linked sPUU polymer formation. Additive addition is exemplified, but not limited to, the position indicated in route A of FIG. 1B.

The above-mentioned end-linked sPUU polymers, in the case in which synthesis route B of FIG. 1B is employed, also may be described as being a product comprised of:
(i) one or more protected polymers (vii) (e.g., a linear prepolymer comprising blocked terminal isocyanate groups) prepared from (comprising)
   (a) one or more linear glycols (i) (e.g., one or more linear glycols comprising a linear polyether glycol, linear polyester-glycol, linear polycarbonate-glycol or combinations of any thereof), wherein at least one of the one or more linear glycols optionally has a number average molecular weight (Mn) from about 650 to about 5000 Da, reacted with
   (b) one or more diisocyanates (ii) (e.g., a mixture of diisocyanates including, but not limited to, mixtures of diisocyanate isomers),
to form a prepolymer (iii), that is subsequently reacted (in a solvent) with
   (c) one or more isocyanate reactive blocking agents (iv) (e.g., a heat labile chain terminator) or a mixture of one or more blocking agents, and one or more diamine chain extenders (vi) (e.g., selected from aliphatic diamines or a mixture of diamines), wherein at least one of the diamine chain extenders optionally has a molecular weight less than 300 Da,
to form the one or more protected polymers (linear protected sPUU polymer chains) (vii) comprising blocked isocyanate end groups (e.g., only two isocyanate groups such as at the end of the linear polymer);
which are then reacted with
(ii) one or more polyamine crosslinking agents (viii), each having an amine functionality greater than two, to form the end-linked sPUU polymer (e.g., in the form of a shaped article) by heating to remove the blocking agent (e.g., by heating to a sufficient temperature) and permit the previously blocked isocyanate groups to react with the crosslinker.
   Although FIG. 1B route B shows only one position for the addition of additives, as indicted above, one or more additives may be present in the final polymer composition if the additives are added at any point in the synthetic process that does not interfere with end-linked sPUU polymer formation. Points of additive addition are not limited to those specifically indicated in FIG. 1B.

This disclosure includes and provides for a method of preparing an end-linked sPUU polymer comprising:
(i) reacting
   (a) one or more linear glycols (i) (e.g., one or more linear glycols comprising at least one linear polyether glycol, linear polyester-glycol, linear polycarbonate-glycol, or combinations of any thereof), wherein at least one of the one or more linear glycols optionally has a number average molecular weight (Mn) from about 650 to about 5000 Da, with
   (b) one or more diisocyanates (ii) (e.g., a mixture of diisocyanates including, but not limited to, mixtures of diisocyanate isomers), to form a prepolymer (iii),
   (c) prepolymer (iii), is subsequently reacted with one or more isocyanate reactive blocking agents (iv) (e.g., a heat labile chain terminator) or a mixture of one or more blocking agents, and one or more diamine chain extenders (vi) (e.g., selected from aliphatic diamines or a mixture of diamines), wherein at least one of the diamine chain extenders optionally has a molecular weight less than 300 Da,
   to form the one or more protected polymers (linear protected sPUU polymer chains) (vii) comprising blocked isocyanate end groups (e.g., only two isocyanate groups such as at the end of the linear polymer);
(ii) the one or more protected polymers (linear protected sPUU polymer chains) (vii) are the combined (mixed in a solvent) with one or more polyamine crosslinking agents (viii), each having an amine functionality greater than two, to form a composition for producing an end-linked sPUU polymer;
(iii) heating the composition for producing an end-linked sPUU polymer (e.g., in the form of a shaped article) to remove the blocking agent from the one or more protected polymers (vii) and permit the previously blocked isocyanate groups to react with the amines of the one or more crosslinking agent (viii) (e.g., to form urea linkages) that results in production of the end-linked sPUU polymer.

Polyamine crosslinking agents that have an amine functionality greater than three or greater than four may be utilized in the method. The polyamine crosslinking agents may be one or more polymeric polyamine crosslinking agents such as PEI and/or PAMAM. he two routes to the end-linked sPUUs and/or shaped articles depicted in FIG. 1B differ most significantly when the extender is added relative to the crosslinker. In one instance the chain extender (vi) is added to the protected prepolymer (v) with the crosslinker (viii) (route A of FIG. 1B). In a second instance, the chain extender (vi) is added with the blocking agent (iv) that will form the blocked isocyanate polymer (vii) (route B in FIG. 1B). Those different routes may be utilized to obtain end-linked sPUUs with different molecular weights, and differing ratios of extender, terminator, and glycols. Because the protected prepolymer of route A will generally have a lower viscosity than the protected polymer of route B, it is amenable to forming articles where a lower viscosity assists in shaping (e.g., coating) a substrate. Route B permits full control of the characteristics of protected polymer chain(s) (vii), including SSMs/HSMW and Mw ranges. Addition of the components in routes A and B may be conducted by simultaneous addition of individual components (e.g. in admixture), or by ordered addition of components.

Components of the end-linked sPUUs may vary regardless of the synthetic route employed. The polymers may be formed using a variety of different glycols, isocyanates, chain extenders, blocking agents, chain terminators, and crosslinking agents. Any one or more of those components may comprise two or more nonidentical molecules, such as two or more isocyanates, two or more blocking agents, or two or more crosslinking groups.

As discussed in more detail below, the end-linked sPUUs, and shaped articles comprising them, may comprise one or more, or two or more, isocyanates and/or one or more or two or more isocyanate blocking agents. The isocyanates may comprise, for example, aromatic isocyanates and/or non-aromatic isocyanates. Similarly, the process used to form the end-linked polymers may utilize one or more, or two or more, isocyanate reactive blocking agents, and may further utilize one or more, or two or more, isocyanate reactive chain terminators. Blocking agents are generally selected to dissociate or deblock (unblock the isocyanate) at an onset temperature of no higher than 200 °C. In some instances, the deblocking may occur at a temperature greater than 60 °C, such as in the range of 60 °C to 150 °C. Blocking agents (chain terminators that form blocked isocyanates) are described in more detail in the sections that follow.

Where two or more isocyanate reactive blocking agents are employed, they may both be activated under the same conditions (e.g., at the same temperature). Alternatively, the blocking agents may be activated under different conditions of, for example, time and temperature. Unblocking only a portion of the isocyanate groups either by (i) using insufficient temperature and/or time of exposure to a temperature sufficient to unblock the isocyanate(s), or (ii) using more than one blocking agent having different deblocking temperatures, can permit end-linking in two or more stages. By conducting end linking in two or more stages, the partially polymerized polymer can be formed or shaped in a second step and heated to complete the crosslinking, helping a shaped article avoid stresses resulting from secondary shaping (e.g., rolling of a cast polymer sheet).

Regardless of the specific route chosen, the crosslinker may be selected to be an organic compound with a functionality of primary amino (—NH₂) groups greater than two in the molecule (e.g., three or more). One or more such crosslinkers may be employed. By way of example, the crosslinking agent may be a polyethylenimine (also referred to as polyethylene imine or PEI), which has multiple primary amine groups per molecule, or two or more such PEIs differing in, for example, molecular weight. PEIs may comprise three or more or 4 or more amine (e.g., primary amine) groups per molecule. PEI's, including linear PEIs and branched or dendrimeric PEIs may comprise amine groups on the ends of their polymer chains (amine terminated, for example primary amine terminated).

The present disclosure includes and provides for end-linking of sPUU polymer chains (the sPUU component of the end-linked sPUUs) comprising soft segments and hard segments (see, e.g., the protected polymer (vii) in FIG. 1B route B). The hard segment content by percent (HS wt. %) of the protected sPUU polymer(s) (vii) prior to end linking, or the sPUU polymer component of the end-linked sPUUs, may be from about 4% to about 16%, or from about 5.75% to about 15.25% by weight of the sPUU polymer or its protected polymer form (vii). Other suitable HS wt. % range are from about 4.5 to about 8.0 or from about 8.0 to about 15.23. Depending upon the ratio of components utilized in the polymerization, the hard segment content of the protected sPUU may, for example be from about 8% to about 10% or from about 10% to about 12% by weight. Alternatively, the hard segment content of the protected sPUU may be from about 11% to about 15% by weight.

The soft segment content by percent (SS wt. %) of the protected sPUU polymer(s) (vii) prior to end linking, or the sPUU polymer component of the end-linked sPUUs, may be from about 84% to about 96%, or from about 84% to about 94.5% by weight of the sPUU polymer or its protected polymer form (vii). Other suitable SS wt. % range are from about 84% to about 90% or from about 90% to about 96%. The soft and hard segment weight percentages total to 100% excluding any blocking agents and chain terminators present.

The protected sPUU polymer(s) (vii) prior to end linking, or the sPUU polymer component of the end-linked sPUUs, may have a soft segment molecular weight (SSMW) to hard segment molecular weight (SSMW/HSMW) ratio (i.e., soft segment Mn/hard segment Mn) in a range of about range of about 5 to about 20 (e.g., 20.2) or about 5.5 to about 16.25 (as defined according to European Patent EP3724248B1). Other suitable SSMW/HSMW ratio are in the range are in the range of about 5 to about 10 or from about 10 to about 15. The SSMW/HSMW ratio may also be in the range are in the range of about 14 to about 16.5 or from about 16.5 to about 20 (e.g., 20.2). The SSMW/HSMW ratio may also be from about 5 to about 7, or from about 7 to about 9. Alternatively, the SSMW/HSMW ratio may be in a range of from about 9 to about 11, or from about 11 to about 12.

The protected sPUU polymers (vii) prior to end linking, or the sPUU polymer component (the linear sPUU polymer chains) of the end-linked sPUUs may comprise a hard segments with a molecular weight (HSMW) in the range of about 400 Da to about 750 Da or about 400 to about 550 Da. The HSMW may also be in the range of about 550 Da to about 725 Da or about 500 Da to about 600 Da.

The protected sPUU polymers (vii) prior to end linking, or the sPUU polymer component (the linear sPUU polymer chains) of the end-linked sPUUs may comprise a soft segments with a molecular weight (SSMw) in the range of: about 4,000 Da to about 10,000 Da; or about 4,000 to about 6,0000 Da. The SSMW may also be in the range of about 6,000 Da to about 8000 Da or about 4500 Da to about 5,750 Da. The SSMW may also be in the range of about 8,000 Da to about 10,000 Da.

The protected sPUU polymers (vii) prior to end linking, or the sPUU polymer component of the end-linked sPUUs, may have, for example, a number average molecular weight (Mn) in the range of about 25,000 to about 75,000 Da or 10,000 Da to 100,000 Da. The Mn of those polymers may be for example from about 10,000 Da to about 50,000 Da or from about 50,000 Da to 100,000 Da. The Mn of those polymers may be for example from about 25,000 Da to about 30,000 Da or from about 30,000 Da to 35,000 Da.

The protected sPUU polymers (vii) prior to end linking, or the sPUU polymer component of the end-linked sPUUs, may have, for example, a weight average molecular weight, (Mw) in the range of about 10,000 to about 150,000 Da or about 20,000 Da to about 150,000 Da. For example, the Mw may be from about 10,000 to about 25,000 or about 25,000 to about 60,000. Alternatively, the Mw may be from about 60,000 to about 100,000. Other Mw ranges include about 80,000 to about 120,000 Da, or about 100,000-120,000 Da.

The Mw of protected sPUU polymers (vii) prior to end linking, or the sPUU polymer component of the end-linked sPUUs may also be in the range of about 100,000 to about 250,000 Da. The Mw of protected sPUU polymers (vii) prior to end linking, or the sPUU polymer component of the end-linked sPUUs may also be in the range of about 100,000 to about 150,000 Da or about 150,000 to about 200,000 Da. The Mw of protected sPUU polymers (vii) prior to end linking, or the sPUU polymer component of the end-linked sPUUs may also be in the range of about 200,000 to about 225,000 Da or about 225,000 to about 250,000 Da.

The protected sPUU polymers (vii) prior to end linking, or the sPUU polymer component of the end-linked sPUUs, may have, for example, a Z average molecular weight (Mz) in the range of about 175,000 to about 635,000 Da. For example, the Mz may be from about 175,000 to about 300,000 or about 300,000 to about 675,000.

The ratio of components and reaction conditions (e.g., time and temperature, order or manner of reactant addition), amount of blocking agent, and optionally chain terminator, can be used to control the final protected polymer composition, hard to soft segment ratio, and molecular weight. Where a protected polymer is made in conjunction with end-linking (e.g., as in route A of FIG. 1B), the molecular characteristics, including the hard to soft segment ratio, in the final product may be stated based upon the material inputs using the methods as in European Patent EP3724248B1.

Compositions comprising the end-linked sPUUs of the present disclosure suitable for use in, for example, electronics applications may include a variety of additives. Those additives include, but are not limited to, dispersants, antioxidants, lubricants, heat stabilizers, hydrolytic stabilizers, acid scavengers, and fillers. In addition to those additives, where the compositions are intended to be conductive, they may include one or more electrically conductive materials, and when used as part of a cathode or anode of an electrochemical cell (e.g., a battery), they may include one or more active materials that undergo redox reactions (e.g., during the normal charging or discharging operation of primary or secondary cells).

Components of the end-linked sPUUs and their additives, including components useful in the preparation of electrical equipment or components thereof, are described in the sections that follow.

Various types of additives known in the art may be optionally included in the end-linked sPUU compositions used to prepare shaped articles, provided that they do not detract from the end linked sPUUs' beneficial aspects. Examples of additives include: anti-oxidants, UV stabilizers, colorants, pigments, phase change materials (paraffin wax), antimicrobials, minerals (i.e., copper), microencapsulated additives (i.e., aloe vera, vitamin E gel, aloe vera, sea kelp, nicotine, caffeine, scents or aromas), nanoparticles (i.e., silica or carbon), nano-clay, calcium carbonate, talc, flame retardants, anti-tack additives, chlorine degradation resistant additives, vitamins, medicines, fragrances, electrically conductive additives, and dyeability and/or dye-assist agents (such as quaternary ammonium salts). Other additives which may be added to the end-linked sPUUs include adhesion promoters, anti-static agents, anti-creep agents, optical brighteners, coalescing agents, electroconductive additives, luminescent additives, organic and inorganic fillers, preservatives, texturizing agents, thermochromic additives, insect repellants, wetting agents, stabilizers (hindered phenols, zinc oxide, hindered amine), slip agents (silicone oil) and combinations thereof.

### III. Components of End-Linked sPUU Polymers

### IV. Linear Diols

Soft segments of the end-linked sPUUs may comprise one or more linear glycols, wherein the one or more linear glycols comprise a linear polyether glycol, linear polyester-glycol, linear polycarbonate-glycol or combinations of any thereof, and at least one of the one or more linear glycols has a number average (Mn) molecular weight from about 650 to about 5000 Da. The soft segments of the end-linked sPUUs may comprise at least one linear polyether glycol, such as PTMEG. The soft segments of the end-linked sPUUs may comprise at least one linear polyester-glycol or at least one linear polycarbonate-glycol. Additionally, while at least one of the one or more linear glycols of the end-linked sPUUs may have an Mn from about 650 to about 5000 Da, the sPUUs may also comprise at least two linear glycols, wherein at least two of the glycols have an Mn from about 650 to about 5000 Da. The one or more linear glycols of the end-linked sPUUs may also comprise at least three linear glycols, wherein at least three of the glycols have an Mn from about 650 to about 5000 Da. Any of the linear glycols used in the end-linked sPUUs described herein may have a hydroxyl functionality of 2 (e.g., with terminal hydroxyl groups).

Generally, each of the linear diols utilized to prepare the end-linked sPUUs may have a melting point less than 55 °C or less than 50 °C. The linear diols utilized may also have a melting point less than 45 °C or less than 40 °C. The linear diols utilized may also have a melting point less than 35 °C or less than 30 °C. The linear diols utilized to prepare the sPUUs may have a melting point in the range of about −5 °C to about 55 °C or about 5 °C to about 55 °C. The linear diols utilized to prepare the end-linked sPUUs may have a melting point in the range of about −5 °C to about 10 °C or about 10 °C to about 25 °C. The linear diols utilized to prepare the end-linked sPUUs may have a melting point in the range of about 25 °C to about 40 °C or about 40 °C to about 55 °C.

Examples of linear polyether glycols of the component that can be used to prepare end-linked sPUUs include those linear macrodiols obtained from ring-opening polymerization and/or copolymerization of ethylene oxide, propylene oxide, trimethylene oxide, tetrahydrofuran, and 3-methyltetrahydrofuran, or from condensation polymerization of a polyhydric alcohol, such as a low molecular weight diol or diol mixture, with less than 12 carbon atoms in each molecule. Examples of such polyether glycols include, but are not limited to, ethylene glycol, 1,3-propanediol, 1,4-butanediol, 1,5-pentanediol 1,6-hexanediol, 2,2-dimethyl-1,3 propanediol, 3-methyl-1,5-pentanediol, 1,7-heptanediol, 1,8-octanediol, 1,9-nonanediol, 1,10-decanediol and 1,12-dodecanediol.

Examples of polyether glycols (FIG. 1B component (a)) that can be used to prepare end-linked sPUUs include linear macrodiols obtained from ring-opening polymerization and/or copolymerization of one or more of ethylene oxide, propylene oxide, trimethylene oxide, tetrahydrofuran, 3-methyltetrahydrofuran. Examples of polyether glycols that can be used to prepare end-linked sPUUs include those obtained from condensation polymerization of one or more polyhydric alcohols such as a low molecular weight diol or diol mixtures, with less than 12 carbon atoms in each molecule. Such polyhydric alcohols include, but are not limited to, ethylene glycol, 1,3-propanediol, 1,4-butanediol, 1,5-pentanediol 1,6-hexanediol, 2,2-dimethyl-1,3 propanediol, 3-methyl-1,5-pentanediol, 1,7-heptanediol, 1,8-octanediol, 1,9-nonanediol, 1,10-decanediol and 1,12-dodecanediol.

The polyether glycol may be PTMEG or may comprise PTMEG. The end-linked sPUUs may comprise as their linear glycol PTMEG with a hydroxyl functionality of 2 and an Mn of about 625 Da to about 675 Da (e.g., TERATHANE® 650, Invista, Wichita, Kansas) or of about 950 to about 1050 Da (e.g., TERATHANE® 1000, Invista). The end-linked sPUUs may comprise as their linear glycol PTMEG with a hydroxyl functionality of 2 and an Mn of about 1400 Da (e.g., TERATHANE® 1400, Invista) or of about 1800 Da (e.g., TERATHANE® 1800, Invista). The end-linked sPUUs may comprise as their linear glycol PTMEG with a hydroxyl functionality of 2 and an Mn of about 2000 Da (e.g., TERATHANE® 2000, Invista) or about 2900 Da (e.g., TERATHANE® 2900, Invista). Alternatively, the end-linked sPUUs may comprise as their linear glycol PTMEG with a hydroxyl functionality of 2 and an Mn from about 650 to about 1,000 Da or from about 1,000 to about 1,700 Da. The end-linked sPUUs may comprise as their linear glycol PTMEG with a hydroxyl functionality of 2 and an Mn from about 1,700 to about 2,100 Da. The end-linked sPUUs may comprise as their linear glycol PTMEG with a hydroxyl functionality of 2 and an Mn from about 2,100 to about 3,000 Da, or PTMEG with an Mn from about 3,000 to about 5,000 Da. Other Mn ranges for PTMEG used in the end-linked sPUUs include Mn from about 650 to about 1000 Da, or from about 1000 to about 2000 Da. The PTMEG may also have an Mn from about 2000 to about 3500 Da, or from about 3500 to about 5000 Da.

The melting point of the PTMEG compositions with a hydroxyl functionality of 2 suitable for use in preparing end-linked sPUUs depends upon, among other things, the distribution of the polymer chain length within the composition; and accordingly, it may vary even for a specified molecular weight range. For example, PTMEG having an Mn of about 650 Da may have a melting point from about 11 to about 19 °C, while PTMEG with an Mn of 650±25 Da may have a melting point from about 22 to about 23 °C. For example, PTMEG having an Mn of about 1000 Da may have a melting point from about 25 to about 33 °C, while PTMEG with an Mn of 1000±50 Da may have a melting point from about 23 to about 24 °C. For example, PTMEG having an Mn of about 1400 Da may have a melting point from about 27 to about 35 °C, while PTMEG with an Mn of 1400±50 Da may have a melting point from about 24 to about 25 °C. For example, PTMEG having an Mn of about 1800 Da may have a melting point from about 27 to about 38 °C, while PTMEG with an Mn of 1800±50 Da may have a melting point from about 25 to about 26 °C. For example, PTMEG having an Mn of about 2000 Da may have a melting point from about 28 to about 40 °C, while PTMEG with an Mn of 2000±50 Da may have a melting point from about 26 to about 27 °C. For example, PTMEG having an Mn of about 2900 Da may have a melting point from about 30 to about 43 °C, while PTMEG with an Mn of 3000±50 Da may have a melting point from about 28 to about 29 °C.

Other linear polyether glycols with a hydroxyl functionality of 2 that may be used in end-linked sPUU preparation may comprise polyethylene glycol and/or polypropylene glycol (e.g., within the same Mn ranges as those recited for PTMEG). Another linear glycol that may be employed is poly(trimethylene ether) glycol (PO3G) (e.g., within the same Mn ranges as those recited for PTMEG). Alternatively, linear pentylene glycols (PTGs) (e.g., within the same Mn ranges as those recited for PTMEG) may be employed.

Examples of polyester glycols that may be utilized as a linear glycol include polyester glycols produced by condensation polymerization of one or more aliphatic dicarboxylic acids and one or more diols, wherein at least one of the dicarboxylic acids and at least one of the diols are of low molecular weight with no more than 12 carbon atoms in each molecule. In an aspect of the invention, all of the diacids and all of the diols used to prepare a polyester glycol of the end-linked sPUUs have less than 12 carbons. Suitable diacids for preparing polyester glycols include, but are not limited to, malonic acid, succinic acid, glutaric acid, adipic acid, pimelic acid, suberic acid, azelaic acid, sebacic acid, undecanedicarboxylic acid, and dodecanedicarboxylic acid. Suitable diols for preparing the polyester glycols include, but are not limited to, ethylene glycol, 1,3-propanediol, 1,4-butanediol, 1,5-pentanediol, 1,6-hexanediol, neopentyl glycol, 3-methyl-1,5-pentanediol, 1,7-heptanediol, 1,8-octanediol, 1,9-nonanediol, 1,10-decanediol and 1,12-dodecanediol. Suitable linear polyester glycols include polyester glycols with a hydroxyl functionality of 2 and a melting temperature from about 5 °C to about 50 °C. Suitable linear polyester glycols include polyester glycols with a hydroxyl functionality of 2 and a melting temperature from about 5 °C to about 25 °C or a melting temperature from about 25 °C to about 50 °C. In an aspect of the invention, the polyester glycol comprises a poly(caprolactone) or poly(valerolactone) terminated with an ester linked C2-C6 diol or a C7-C12 diol to produce a linear glycol with a hydroxyl functionality of 2. Such polylactones may, for example, have a melting point from about 50 °C to about 60 °C.

Examples of polyester glycols that can be used as linear gycols to prepare end-linked sPUUs include those ester glycols produced by condensation polymerization of aliphatic dicarboxylic acids and diols of low molecular weights with no more than 12 carbon atoms in each molecule, or mixtures thereof. Examples of suitable diacids are malonic acid, succinic acid, glutaric acid, adipic acid, pimelic acid, suberic acid, azelaic acid, sebacic acid, undecanedicarboxylic acid, and dodecanedicarboxylic acid. Examples of suitable diols for preparing the polyester glycols are ethylene glycol, 1,3-propanediol, 1,4-butanediol, 1,5-pentanediol 1,6-hexanediol, neopentyl glycol, 3-methyl-1,5-pentanediol, 1,7-heptanediol, 1,8-octanediol, 1,9-nonanediol, 1,10-decanediol and 1,12-dodecanediol. A linear bifunctional polyester polyol with a melting temperature of about 5 °C to about 50 °C is an example of a specific polyester glycol.

Examples of polycarbonate glycols that can be used as a linear glycol to prepare end-linked sPUUs include those carbonate glycols produced by condensation polymerization of phosgene, chloroformic acid ester, dialkyl carbonate or diallyl carbonate and aliphatic polyols of low molecular weights with no more than 12 carbon atoms in each molecule, or mixtures there. Examples of suitable diols for preparing the polycarbonate glycols are diethylene glycol, 1,3-propanediol, 1,4-butanediol, 2-methyl-1,4-butanediol, 1,5-pentanediol, 3-methyl-1,5-pentanediol, 1,6-hexanediol, neopentyl glycol, 1,7-heptanediol, 1,8-octanediol, 1,9-nonanediol, 1,10-decanediol and 1,12-dodecanediol. Suitable linear polycarbonate glycols include polycarbonate glycols with a hydroxyl functionality of 2 and a melting temperature from about 5 °C to about 50 °C. Suitable linear polycarbonate glycols include polycarbonate glycols with a hydroxyl functionality of 2 and a melting temperature from about 5 °C to about 25 °C or a melting temperature from about 25 °C to about 50 °C.

### V. Diisocyanates

Any number of aromatic, alicyclic, and/or aliphatic diisocyanates may be employed to prepare the end-linked sPUUs described herein. The diisocyanates of the end-linked sPUUs described herein may comprise a single diisocyanate or a mixture of two or more nonidentical diisocyanates. Where two or more nonidentical diisocyanates are employed to prepare the end-linked sPUUs, the two or more diisocyanates may comprise mixtures of isomeric diisocyanates, such as mixtures of diphenylmethane diisocyanate (MDI) containing 4,4′-methylenebis(phenyl isocyanate) (aka 4,4′-MDI) and/or 2,4′-methylenebis(phenyl isocyanate) (aka 2,4′ MDI).

The diisocyanate(s) (component (ii) in FIG. 1B) used to prepare end-linked sPUUs can be a single diisocyanate or a mixture of different diisocyanates including an isomer mixture of diphenylmethane diisocyanate (MDI) containing 4,4′-methylene bis(phenyl isocyanate) and 2,4′-methylene bis(phenyl isocyanate). Any suitable aromatic or aliphatic diisocyanate can be included. Examples of diisocyanates that can be used include, but are not limited to, 4,4-methylene bis(phenyl isocyanate), 2,4′-methylene bis(phenyl isocyanate), 1,4-phenylenediisocyanate, 4,4′-methylenebis(cyclohexyl isocyanate), 1,4-cyclohexyl diisocyanate, 1,3-diisocyanato-4-methyl-benzene, 2,2′-toluenediisocyanate, 2,4′-toluenediisocyanate, and mixtures thereof.

Examples of diisocyanates that can be employed in the preparation of the end-linked sPUUs include but are not limited to 4,4′-MDI, 2,4′-MDI, 1,4-phenylenediisocyanate, 4,4′-methylenebis(cyclohexyl isocyanate), 1,4-cyclohexyl diisocyanate, 2,4-toluene diisocyanate, 2,6-toluene diisocyanate, and mixtures thereof.

One or more diisocyanates used to prepare end-linked sPUUs may comprise aromatic diisocyanates. The one or more diisocyanates may be mostly (more than 50% or 75%) aromatic diisocyanates (on a molar basis). The one or more diisocyanates may be all (100%) aromatic diisocyanates. Nonlimiting examples of aromatic diisocyanates useful in preparing the end-linked sPUUs of the present disclosure include but are not limited to 2,4′-MDI, 4,4′-MDI, 1,4-xylenediisocyanate, 2,6-toluene diisocyanate, 2,4-toluene diisocyanate, and mixtures thereof.

One or more diisocyanates used to prepare end-linked sPUUs may comprise nonaromatic diisocyanates (e.g., aliphatic or cycloaliphatic diisocyanates). The one or more diisocyanates may be mostly (more than 50% or 75%) nonaromatic diisocyanates (on a molar basis). The one or more diisocyanates may be all (100%) nonaromatic diisocyanates. Nonlimiting examples of nonaromatic diisocyanates useful in preparing the end-linked sPUUs of the present disclosure include but are not limited to 4,4′-methylenebis(cyclohexyl isocyanate), 1,4-cyclohexyl diisocyanate, isopheronediioscyanate (5-isocyanato-1-(isocyanatomethyl)-1,3,3-trimethylcyclohexane, and mixtures thereof. Among the nonaromatic diisocyanates that may be employed are HDI (hexamethylene diisocyanate) and/or heptamethylene diisocyanate.

### VI. Diamine Chain Extenders

Alicyclic and/or aliphatic diamine chain extenders may be employed to prepare the end-linked sPUUs described herein. The diamine chain extenders may comprise, for example, a single diamine or a mixture of two or more nonidentical diamines. Where mixtures of diamine chain extenders are utilized in the preparation of the end-linked sPUUs they may comprise two or more isomeric diamines, such as a mixture of two or more of 1,4-butanediamine, 1,2-butanediamine, and 1,3-butanediamine.

A diamine chain extender (see component (vi) of FIG. 1B) can be an aliphatic diamine selected from but not limited to hydrazine, 1,2-ethylenediamine, 1,4-butanediamine, 1,2-butanediamine, 1,3-butanediamine, 1,3-diamino-2,2-dimethylbutane, 1,6-hexamethylenediamine, 1,12-dodecanediamine, 1,2-propanediamine, 1,3-propanediamine, 2-methyl-1,5-pentanediamine, 1-amino-3,3,5-trimethyl-5-aminomethylcyclohexane, 2,4-diamino-1-methylcyclohexane, N-methylamino-bis(3-propylamine), 1,2-cyclohexanediamine, 1,4-cyclohexanediamine (HPPD), 4,4′-methylene-bis(cyclohexylamine), isophorone diamine, 2,2-dimethyl-1,3-propanediamine, meta-tetramethylxylenediamine, 1,3-diamino-4-methylcyclohexane, 1,3-cyclohexane-diamine, 1,1-methylene-bis(4,4′-diaminohexane), 3-aminomethyl-3,5,5-trimethylcyclohexane, 1,3-pentanediamine (1,3-diaminopentane) m-xylylene diamine (M-XDA), and poly(propylene oxide) diamines (see, e.g., the Jeffamine® family of polymers from Huntsman Chemical, Texas).

Nonlimiting examples of diamine chain extenders suitable for use in the end-linked sPUUs of the present disclosure include but are not limited to hydrazine, 1,2-ethylenediamine, 1,4-butanediamine, 1,2-butanediamine, 1,3-butanediamine, 1,3-diamino-2,2-dimethylbutane, 1,6-hexamethylenediamine, 1,12-dodecanediamine, 1,2-propanediamine, 1,3-propanediamine, 2-methyl-1,5-pentanediamine, 1-amino-3,3,5-trimethyl-5-aminomethylcyclohexane, 2,4-diamino-1-methylcyclohexane, N-methylamino-bis(3-propylamine), 1,2-cyclohexanediamine, HPPD, 4,4′-methylene-bis(cyclohexylamine), isophorone diamine, 2,2-dimethyl-1,3-propanediamine, meta-tetramethylxylenediamine, 1,3-diamino-4-methylcyclohexane, 1,3-cyclohexane-diamine, 1,1-methylene-bis(4,4′-diaminohexane), 3-aminomethyl-3,5,5-trimethylcyclohexane, 1,3-pentanediamine (1,3-diaminopentane), poly(ethylene oxide), poly(propylene oxide) diamines (e.g., Jeffamine® diamines from Huntsman Corp., Woodlands, Texas), M-XDA, p-xylylene diamine (P-XDA), 3,5-diethyltoluene-2,4-diamine, 3,5-diethyltoluene-2,6-diamine, 4,4′-Methylenebis(2-chloroaniline), o-phenylenediamine (o-PPD), m-phenylenediamine (m-PPD), p-phenylenediamine (p-PPD), and mixtures (e.g., of two or more) thereof.

Nonlimiting examples of aliphatic diamine chain extenders suitable for use in the end-linked sPUUs of the present disclosure include but are not limited to 1,2-ethylenediamine, 1,4-butanediamine, 1,2-butanediamine, 1,3-butanediamine, 1,3-diamino-2,2-dimethylbutane, 1,6-hexamethylenediamine, 1,12-dodecanediamine, 1,2-propanediamine, 1,3-propanediamine, 2-methyl-1,5-pentanediamine, 1-amino-3,3,5-trimethyl-5-aminomethylcyclohexane, 2,4-diamino-1-methylcyclohexane, N-methylamino-bis(3-propylamine), 2,2-dimethyl-1,3-propanediamine, meta-tetramethylxylenediamine, 1,3-pentanediamine (1,3-diaminopentane), and mixtures (e.g., of two or more) thereof.

Nonlimiting examples of alicyclic diamine chain extenders suitable for use in the end-linked sPUUs of the present disclosure include but are not limited to 1,2-cyclohexanediamine, HPPD, 4,4′-methylene-bis(cyclohexylamine), isophorone diamine, 1,3-diamino-4-methylcyclohexane, 1,3-cyclohexane-diamine, 1,1-methylene-bis(4,4′-diaminohexane), 3-aminomethyl-3,5,5-trimethylcyclohexane, and mixtures (e.g., of two or more) thereof.

Nonlimiting examples of poly(ethylene oxide) and poly(propylene oxide) diamines (e.g., chain extenders) suitable for use in the end-linked sPUUs of the present disclosure include but are not limited to poly(ethylene oxide) and/or poly(propylene oxide) diamines. Such poly(ethylene oxide) and poly(propylene oxide) diamines may bear primary and/or secondary amines at both ends of the polymer chain (e.g., such as Jeffamine® D-series polymers by Huntsman Corp., Woodlands, Texas).

Nonlimiting examples of aromatic diamine chain extenders (e.g., comprising one or more aromatic rings) suitable for use in the end-linked sPUUs of the present disclosure include, but are not limited to, M-XDA, P-XDA, 3,5-diethyltoluene-2,4-diamine, 3,5-diethyltoluene-2,6-diamine, 4,4′-methylenebis(2-chloroaniline), PPD, m-PPD, p-PPD, and mixtures (e.g. of two, three or more) thereof.

Nonlimiting examples of suitable diamine chain extenders that are aliphatic, relatively rigid, have suitably high boiling point (>200 °C), are less volatile, have relatively high flash point (>100 °C), are less flammable, and which present less hazards to health and environment safety include some aromatic and cycloaliphatic-containing molecules. Aromatic molecules meeting most or all of the above-mentioned criteria include, but are not limited to, M-XDA and p-XDA. Cycloaliphatic diamines meeting most or all of the above-mentioned criteria include, but are not limited to 1,4-cyclohexanedimethanamine (1,4-H6XDA, CAS No. 2549-93-1) and 1,3-bis(aminomethyl)cyclohexane (1,3-H6XDA, CAS No. 2579-20-6). Similar cycloaliphatic diamines are HPPD (CAS No. 3114-70-3) and its cis counterpart, CAS No. 2121-79-1. Diamines with more than one ring are also suitable as chain extenders including, but not limited to, bis(aminomethyl)norbornane (CAS No. 56602-77-8) and BIS(4-dimethylamino-cyclohexyl) methane (CAS No. 13474-64-1).

### VII. Blocking Agents and Chain Terminators

For the purpose of this disclosure, molecules that react with isocyanate groups, prevent polymer chain growth, and are not heat labile (e.g., at temperatures under 200 °C), are referred to as chain terminators. As used herein blocking agents (also referred to as protective groups, protecting groups, or protective agents) like chain terminators react with isocyanate groups and prevent polymer chain growth or extension. The blocking agents used herein are heat labile, and are deblocked by sufficient heating to regenerate an isocyanate group or its synthetic equivalent. The transformation of a blocked or protected isocyanate group may be referred to as activation or deblocking (the resulting isocyanate group is referred to in the alternative as having been activated, deblocked, or unblocked). Accordingly, for the purpose of this disclosure molecules that reversibly block isocyanates acting as a form of thermolabile chain terminators are referred to as blocking agents; in contrast, molecules that irreversibly block isocyanate groups and are not thermolabile under the conditions used to prepare end-linked sPUUs are referred to as chain terminators.

### a) Blocking Agents

The blocking agents employed in the present disclosure are thermolabile isocyanate protecting groups that produce an isocyanate group (or synthetic equivalent) when subject to a temperature sufficient to cause deblocking to occur. As will be appreciated by those of skill in the art, deblocking reactions, like other chemical reactions, are subject to reaction conditions including the temperature at which the reaction occurs and the amount of time required for the reaction (i.e., the reaction rate at various temperatures under the specified reaction conditions). Blocking agents selected for the preparation of end-linked sPUUs must be selected with those time and temperature requirements in mind and additionally with other process conditions and/or limitations.

The completeness of blocking reactions can be followed by a number of means, but among the most convenient is infrared (IR) spectroscopy. Isocyanates typically have a stretch band in the mid-IR in the range of about 2300 to about 2240 cm⁻¹. The loss of that band when reacting isocyanate capped molecules to form protected prepolymers or protected polymers (see, e.g., FIG. 1B at v and vii) is indicative of blocked isocyanate formation. Similarly, heating the protected molecules in the absence of molecules with isocyanate reactive functionalities should show the reappearance of the isocyanate IR stretch band.

Among the processing conditions that impact the selection of blocking agents is the boiling point of solvent(s) that may be present at the time the deblocking and crosslinking reaction is triggered. Where it is necessary or desirable to produce end-linked sPUUs that lack or have minimal amounts of residual solvents (e.g., less than 0.5 or less than 0.1% by weight), blocking agents with a deblocking temperature above that of the solvent(s) present need to be selected. In some embodiments the blocking agent is selected so that the deblocking temperature is at least 5 °C or 10 °C above the boiling point of the solvent or solvent mixture present. In some embodiments the blocking agent is selected so that the deblocking temperature is at least 15 °C or 25 °C above the boiling point of the solvent or solvent mixture present. Another consideration in selecting blocking agents is the amount of time compositions comprising protected polymers or protected prepolymers with isocyanate blocking groups need to be held prior to use.

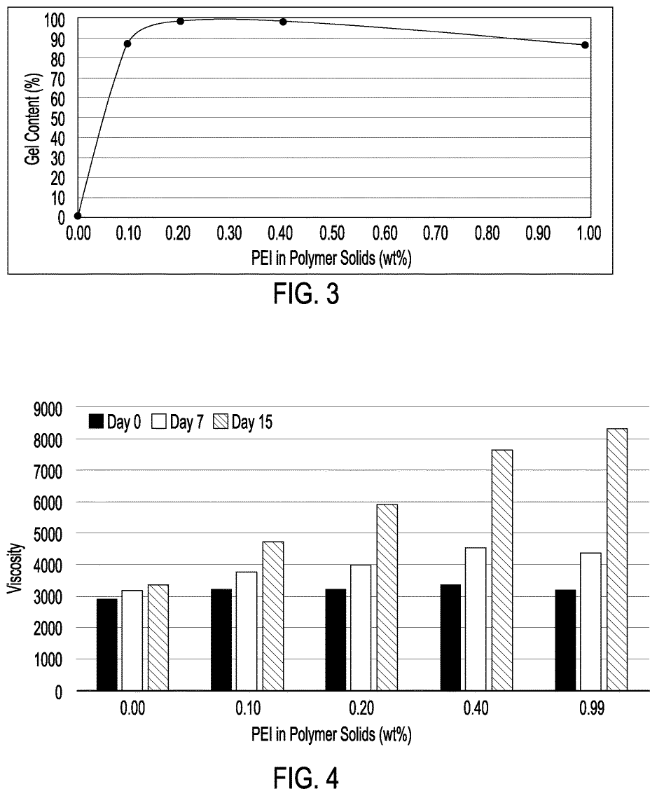

For practical purposes the deblocking temperature of the blocking agents must be above the temperature for holding compositions (holding temperature) comprising protected polymer(s) or protected prepolymers to prevent premature formation of the end-linked sPUU polymers. Deblocking during holding time periods can be followed by measuring the viscosity of the compositions, which will rise as deblocking and end-linking and/or polymerization occurs. Because the viscosity of individual component compositions varies with the specific components and holding temperature, it is not possible to easily state a specific viscosity at which the compositions become too polymerized for use in forming end-linked sPUUs or shaped articles containing them. Accordingly, it is more practical to consider the change in viscosity relative to the initial value of the composition when it is prepared and brought to the holding temperature. For example, the process may be continued (the composition is considered stable under holding conditions) while there is less than a 1.5-fold or less than a 1.25-fold increase in viscosity relative to its initial value at the holding temperature (e.g., 35 °C-45 °C, such as 40 °C). See, e.g., FIG. 4. Alternatively, the process may be continued while there is less than a two-fold or less than a four-fold increase in viscosity relative to its initial value at the holding temperature (e.g., 35 °C-45 °C, such as 40 °C).

One or more catalysts may be utilized to reduce the deblocking temperature of one or more of the blocked isocyanates in a protected prepolymer (v) or protected polymer (vii) provided that residual catalyst in the finished end-linked polymer or article does not interfere with its intended use. Consideration also needs to be given to any effect a catalyst may have on holding temperature and time. Where it is desirable to use a catalyst that can otherwise affect the holding time and/or temperature, the catalyst may be added immediately prior to elevating the temperature above the deblocking temperature.

Compositions for preparing the end-linked sPUUs, or articles made therefrom, may be held for one or more hours and even up to a week (i.e., in some instances the compositions may have a “pot-life” from 1 hour to a week and even up to ten days or up to two weeks) at or below the holding temperature depending on the deblocking temperature of the blocking agent(s) present. However, blocking agents with a deblocking temperature above 200 °C should be avoided to prevent damage to the resulting polymer. Accordingly, blocking agent(s) chosen for the composition and process may be selected to be stable at the holding temperature from 1 to 12 hours (hrs.) or 12 to 24 hrs. Alternatively, the blocking agent(s) chosen for the composition used to prepare end-linked sPUUs, and process may be selected to be stable at the holding temperature (e.g., 40 °C) from 1 day (24 hrs.) to 3 days (72 hrs.) or 3 days (72 hrs.) to 7 days (168 hrs.). The compositions may also be stable up to 240 hrs. or 336 hrs. at the holding temperature (e.g., 40 °C). Typical holding temperatures at which the deblocking agents may need to remain stable can be, for example, in the range of 35 °C-45 °C (e.g., at 40 °C as indicated above), or 45 °C-65 °C. Other holding temperature ranges can be from 65 °C-80 °C.

Lastly, the temperature required for deblocking must be sufficiently low and the deblocking reaction sufficiently rapid so that the polymer components are not damaged during the heating required to form the end-linked polymer or shaped article.

For the formation of end-linked sPUUs from protected polymers (route B, FIG. 1B), it is suggested that at least about 50% of the polymer chain ends of the protected polymer should comprise blocked isocyanate groups that can be deblocked at an onset temperature no higher than 200 °C. The fraction of blocked polymer chain ends may be, for example, from about 50% to about 70%, or from about 70% to about 90%. The fraction of blocked polymer chain ends may be, for example, from about 90% to about 95%, or greater than 95% (95% to 100%). While temperatures for deblocking isocyanate groups can be as high as 200 °C, a suitable working range may be from about 60 °C to about 150 °C, which can accommodate holding temperatures about 40 °C in most circumstances. Some suitable ranges for deblocking are from about 60 °C to about 80 °C, or from about 80 °C to about 100 °C. Other suitable ranges for deblocking are from about 100 °C to about 125 °C, or from about 125 °C to about 150 °C. Deblocking temperature ranges may also be from about 150 °C to about 200 °C. It will be understood that deblocking temperatures above 200 °C, particularly if used only transiently, may be employed, but stability of the polymer and other components present (e.g., additives) requires consideration.

For polymerization to produce the end-linked sPUUs, the concentration of blocked isocyanate groups should be at least 10 milliequivalent (meq) per kilogram (kg) (meq/kg) of the polymer solids. Some suitable ranges for blocked isocyanate groups are from about 10 to about 30 meq/kg, or from about 30 to about 50 meq/kg. In other cases suitable ranges for blocked isocyanate groups are from about 50 to about 75 meq/kg, or from about 75 to about 100 meq/kg of the polymer solids. The meq/kg can be calculated by the following equation:

Cb=[(Wt/Mt)×1000]/Wp

in which
(i) Cb is the blocked isocyanate end group concentration in meq/kg of polymer solid;
(ii) Wt is the weight in grams of the isocyanate reactive terminator or block agent in pure form and Mt is the molecular weight in grams per mole of the terminator or block agent; and
(iii) Wp is the total polymer weight in kgs, or the combined weight in kgs of the glycol (i), diisocyanate (ii), chain extender (vi), chain terminator (ix), and block agent (iv), excluding any solvents or additives.

Suitable blocking agents for use in preparing end-linked sPUUs may have a variety of different functional groups that react with the isocyanates. Among those functionalities are hydroxyl containing molecules (e.g., alcohols, phenols, pyridinols, and thiophenol). Mercaptans are similar to hydroxyl containing blocking agents but comprise a thiol functionality. Blocking agents also include amides, cyclic amides, and imides. Some suitable blocking agents comprise cyclic nitrogen compounds including, but not limited to, imidazole/imidazoline, pyrazole, and triazole. Lastly, blocking agents may comprise oxime or amidine functionalities. Exemplary ranges for those blocking agents and others are provided in Table 1.

TABLE 1

| Blocking | | Typical Class |
|---|---|---|
| Functionality | | Deblocking Temp. |
| Class | Specific examples | Range (°C) |
| Secondary Amines | N,N-diethylamine, N-ethyl-N-propylamine, | |
| (Dialkylamine Amine) | and others cited herein | |
| Alcohol | Butanol, Ethanol, Isopropanol | 95-200 |
| Phenol | o-Cresol, p-Chlorophenol | 60-180 |
| Pyridinol | 2-Chloro-3-pyridinol | 110 |
| Thiophenol | Thiophenol, Pentafluorothiophenol | 130-170 |
| Mercaptan | 1-Dodecanethiol | 75-115 |
| Amide | Acetanilide, Methylacetamide | 100-130 |
| Cyclic Amide | Pyrrolidinone, ε-Caprolactam | 70-170 |
| Imide | Succinimide, N-Hydroxyphthalimide | 110-145 |
| Imidazole/imidazoline | Imidazole, 2-Methylimidazole, | 120-290 |
| | 2-Phenylimidazole | |
| Pyrazole | Dimethylpyrazol, 2-Methyl-4-ethyl-5- | 85-200 |
| | methylpyrazole, 3,5-dimethylpyrazole | |
| Triazole | Benzotriazole, Triazole | 120-250 |
| Amidine | Bicyclic amidine | 70-175 |
| Oxime | methyl ethyl ketoxime (MEKO), | 85-260 |
| | Benzophenone Oxime | |
| Intramolecular | Uretdione, 2-Oxo-1,3-diazepane-1-carboxylate | 150-200 |

Numerous isocyanate reactive block agents are known in the prior art, including those disclosed in U.S. Pat. Nos. 6,843,933 and 4,212,962 and in the references provided therein, for applications in adhesives, coatings and sealants. Examples of suitable blocking agents include, but are not limited to, secondary amines. Some suitable blocking agents include malonates such as diethylmalonate. Some suitable blocking agents include pyrazoles such as 3,5-dimethylpyrazole. Some suitable blocking agents include oximes such as methylethylketoxime. Some suitable blocking agents include phenols. Some suitable blocking agents include caprolactams. Mono-functional dialkylamine blocking agents find particular use as blocking agents in the preparation of end-linked sPUU polymers and articles. Examples of such type of blocking agents include N,N-diethylamine, N-ethyl-N-propylamine, N,N-diisopropylamine, N-tert-butyl-N-methylamine, N-tert-butyl-N-benzylamine, N,N-dicyclohexylamine, N-ethyl-N-isopropylamine, N-tert-butyl-N-isopropylamine, N-isopropyl-N-cyclohexylamine, N-ethyl-N-cyclohexylamine, N,N-diethanolamine, and 2,2,6,6-tetramethylpiperidine.

Some specific isocyanate blocking agents suitable for use in preparing the end-linked sPUUs described herein include those that follow. A blocking agent that may be used in the preparation of end-linked sPUUs includes [symbol] es (pot-life) for 3,5-diamine extenders sitions prior to teristic odor upon used in the erature on the 35 °C-45 °C) or crosslinking of deblocking ed article as a ed to prepare the end-linked sPUUs of the present disclosure include, but are not limited to, cardanol phenols such as 3-(pentadeca-8,11-dienyl)phenol sold as Cardolite® NX-2026 (CAS No. 51546-63-5). Other hydroxyl-containing blocking agents include vanillin and ethylvanillin.

### b) Chain Terminators

As indicated previously, in addition to the use of thermolabile isocyanate reactive blocking agents (protecting groups), the end-linked sPUU polymers, and articles comprising them, may be prepared using isocyanate reactive chain terminators that do not release to reform isocyanate groups under the conditions (e.g., temperatures) used in polymer formation and/or in article formation. Chain terminators may be employed in, for example, controlling the length of protected prepolymers that will be reacted with the crosslinking agent(s). Accordingly, the chain terminators may be employed at different steps in the reaction process, or in the same step (e.g., as an admixture or added sequentially) to the reaction.

Isocyanate reactive chain terminators include, but are not limited to, one or more monofunctional amines. Nonlimiting examples of isocyanate reactive chain terminators include, but are not limited to, one or more monofunctional amines selected from ethylamine, propylamine, isopropylamine, n-butylamine, sec-butylamine, tert-butylamine, isobutylamine, isopentylamine, 1-hexylamine, 1-octylamine, 2-ethyl-1-hexaneamine, cyclohexylamine, N,N-diethylamine, N-ethyl-N-propylamine, N,N-diisopropylamine, N-tert-butyl-N-methylamine, N-tert-butyl-N-benzylamine, N,N-dicyclohexylamine, N-ethyl-N-isopropylamine, N-tertbutyl-N-isopropylamine, N-isopropyl-N-cyclohexylamine, N-ethyl-N-cyclohexylamine, N,N-diethanolamine, and 2,2,6,6-tetramethylpiperidine, and mixtures (e.g., of two or more) thereof.

The isocyanate reactive chain terminators may be limited to one or more (e.g., two or more) primary amines, which are molecules with a single primary amine group also termed “monofunctional primary amines.” At least one of those primary amines may be less than 300 Da in molecular weight. Nonlimiting examples of primary amine isocyanate reactive chain terminators include, but are not limited to, ethylamine, propylamine, isopropylamine, n-butylamine, sec-butylamine, tert-butylamine, isobutylamine, isopentylamine, 1-hexylamine, 1-octylamine, 2-ethyl-1-hexaneamine, cyclohexylamine, and mixtures (e.g., of two or more) thereof.

While the use of chain terminators in the preparation of end-linked sPUUs is optional and dependent on the specific preparation route used, combinations or mixtures of chain terminators (e.g., monofunctional primary amines) and blocking agents employed should result in at least about 50% of the polymer ends (or isocyanate groups present) in blocked form so that, upon unblocking, they can react with the crosslinker(s). Where no chain terminator is used, 100% of the isocyanate groups may be in the blocked (protected) form. Because the use of chain terminators is optional, the ratio of blocking agent to chain terminator can mathematically approach infinity; however, in practical terms, the ratio may be controlled to give effect over the range of 10,000:1 to 1:1. Accordingly, the ratio of blocking agent to chain terminator may be, for example, the range of 1,000:1 to 1:11 on a molar basis or from 1,000:1 to 2:1. The ratio may be in a range from 100:1 to 50:1 or from 50:1 to 10:1 on a molar basis. The ratio may also be in a range from 10:1 to 5:1 or from 5:1 to 2:1 on a molar basis. Mixtures of isocyanate reactive amine chain terminators utilized when preparing the end-linked sPUUs described herein may comprise (e.g., within the above-stated ratios):
(A) blocking agent(s) selected from one or more monofunctional secondary amines selected from N,N-diethylamine, N-ethyl-N-propylamine, N,N-diisopropylamine, N-tert-butyl-N-methylamine, N-tert-butyl-N-benzylamine, N,N-dicyclohexylamine, N-ethyl-N-isopropylamine, N-tertbutyl-N-isopropylamine, N-isopropyl-N-cyclohexylamine, N-ethyl-N-cyclohexylamine, N,N-diethanolamine, and 2,2,6,6-tetramethylpiperidine, and mixtures (e.g., of two or more) thereof; and
(B) chain terminator(s) selected from one or more monofunctional primary amines selected from ethylamine, propylamine, isopropylamine, n-butylamine, sec-butylamine, tert-butylamine, isobutylamine, isopentylamine, 1-hexylamine, 1-octylamine, 2-ethyl-1-hexaneamine, cyclohexylamine, and mixtures (e.g., of two or more) thereof.

Quantitatively, the amount of chain terminator added to control the molecular weight of the protected polymers (protected sPUUs in route B of FIG. 1B) may, for example, be from about 1 meq/kg of polymer to about 8 meq/kg of polymer, or from about 0.1 meq/kg of polymer to about 4 meq/kg of polymer. The amount of chain terminator added to control the molecular weight may also be from about 0.1 meq/kg of polymer to about 0.5 meq/kg of polymer, or from about 0.5 meq/kg of polymer to about 1 meq/kg of polymer.

### VIII. Crosslinking Agents

Crosslinking agents of the present disclosure for reacting with the deblocked isocyanate functionalities include organic compounds which have a functionality of primary, and optionally secondary, amino groups greater than two in each molecule, provided at least one, or at least two, of the amino groups is a primary amino group (—NH₂). Polyamine crosslinking agents include organic compounds which have a functionality of primary amino groups greater than two in each molecule. Polyamine crosslinking agents may have primary amine (—NH₂) groups, and optionally secondary amino groups that form stable urea linkages under crosslinking (end-linking) conditions, with a combined amine functionality greater than two in each molecule may be employed as crosslinking agents; optionally provided that at least one of the amines is a primary amine. Polyamine crosslinking agents may have a functionality of primary amine (—NH₂) groups, and optionally secondary amino groups that form stable urea linkages under crosslinking (end-linking) conditions, with a combined amine functionality greater than three in each molecule may be employed as crosslinking agents; optionally provided that at least one, or at least two, of the amino groups is a primary amino group. Polyamine crosslinking agents include organic compounds which have a functionality of primary amino groups of three or greater in each molecule. Virtually any molecule or polymer having a primary amine functionality higher than 2 (e.g., an amine, or specifically a primary amine, functionality of three or higher) may be utilized as a crosslinking agent. Crosslinking agents may be of several related forms. Crosslinking agents may comprise one or more specific molecules with a fully defined structure or a mixture of molecules with a fully defined structure (e.g., as opposed to a polymer with recurring elements, but not necessarily of a single fully defined structure), each of which has three or more primary amine groups. Polyamine crosslinking agents may comprise one or more polymeric or dendrimeric polyamine crosslinking agents having an amine functionality greater than 2. Crosslinking agents may comprise polymeric dendrimers, having a primary amine functionality greater than two or greater than three. Crosslinking agents may comprise polymers (e.g., non-dendrimeric polymers or dendrimeric polymers) that have a primary amine functionality greater than two or greater than three. Crosslinking agents may comprise polymers, including polymeric dendrimers, having an amine (e.g., primary amine) functionality greater than four. Polymeric crosslinking agents, including polymeric dendrimers, may be amine (e.g., primary amine) terminated.

Where crosslinking agents are specific molecules with a fully defined structure or a mixture of molecules with a fully defined structure, each of which has three or more primary amine groups, the crosslinking agents may comprise at least one molecule with a molecular weight less than 1,000 Da or less than 500 Da. Where a mixture of crosslinking agents is employed, the mixture may comprise a mixture of stereoisomers or structural isomers. Mixtures of stereoisomers may comprise mixtures of enantiomers, or mixtures of diastereomers. Mixtures of structural isomers may comprise mixtures of geometric isomers, or mixtures of positional isomers. Some examples of crosslinkers with a molecular weight less than 1000 Da include cyclohexane-1,3,5-triamine, benzene-1,2,3-triamine, pentane-1,3,5-triamine, tris(2-aminoethyl)amine (CAS No. 4097-89-6), tris(3-aminopropyl)amine (PubChem CID 547030), and (1,1′-biphenyl)-3,3′,4,4′-tetramine (CAS No. 7411-49-6).

As indicated above, polyamine crosslinking agents include polymers and dendrimers with multiple pendant amino functional groups. Polymeric and dendrimeric crosslinking agents may, for example, have a primary amine functionality greater than two, or a primary amine functionality greater than three. Those crosslinking agents may have an amine functionality greater than 4 or greater than 5. Such molecules may optionally have secondary amines that are capable of reacting with isocyanate groups that are stable under conditions (e.g., at the temperature) used for crosslinking and in the final article formed from the end-linked sPUU. Examples of such polymers and dendrimers include those illustrated in FIG. 1D, including (a) linear poly(methylene amine), (b) poly(vinyl amine), (c) poly(allyl amine), (d) poly(aminoethyl acrylate), (f) poly(aminoethyl methacrylate), (g) poly(N-amino ethylene imine), poly(aminopropyl methyl siloxane) or its copolymers, (h) branched poly(ethylene imine); (i) a dendrimeric PEI, (j) a highly branched PEI, and (k) PAMAM dendrimer (depicted with an ethylene diamine core). Each of the polymers shown are primary amine terminated. Mixtures of two or more of the listed polymeric amines may be employed as crosslinkers. Other examples of suitable crosslinking agents that find use in, for example, battery applications include, but are not limited to, primary amine terminated branched polyethylene oxide, branched polyethylenimine (see, e.g., (i) above), and mixtures thereof. From those exemplified crosslinkers it may be understood that the polymeric crosslinking agents may be linear polymers or branched polymers. Highly branched or hyperbranched polymers that resemble dendrimers but lack the symmetry and monodispersed nature of dendrimers that are a form of branched polymers may also be used as crosslinking agents provided they have suitable amino functionalities.

Polyamine crosslinking agents, including polymeric polyamine crosslinking agents (e.g., primary amine bearing polymers such as PEI), suitable for use in preparing end-linked sPUUs may have a range of molecular weights. Polyamine crosslinking agents, such as PEI, may have a weight average molecular weight (Mw) from about 300 Da to about 1,000,000 Da, or more typically from about 300 Da to about 200,000 Da as the use of very high Mw polymers results in high viscosities. Mw ranges for polyamine crosslinking agents include about 300 Da to about 2,000 Da, or about 2,000 Da to about 10,000 Da. Mw ranges for polyamine crosslinking agents include about 10,000 Da to about 50,000 Da, or about 50,000 Da to about 100,000 Da. Mw ranges for polyamine crosslinking agents include about 10,000 Da to about 30,000 Da, or about 30,000 Da to about 50,000 Da. Mw ranges for polyamine crosslinking agents also include about 100,000 Da to about 200,000 Da, or about 200,000 Da to about 1,000,000 Da. Any of those Mw ranges are applicable to polymeric polyamine crosslinking agents such as PEI and dendrimeric polyamine crosslinking agents such as PAMAM. Such polymeric polyamine crosslinking agents may be amine terminated.

In contrast to linear and highly branched polymers, dendrimeric polyamine crosslinking agents offer the advantages of being generally symmetrical and monodispersed (having substantially the same molecular weight per molecule), and accordingly may have a polydispersity index (Mw/Mn) approaching 1. For example, dendrimers suitable for use in preparing the end-linked sPUUs of the present disclosure may have a polydispersity index in the range of 1 to 1.03, or in the range of 1 to 1.05. Dendrimers suitable for use in preparing the end-linked sPUUs of the present disclosure may also have a polydispersity index in the range of 1.03 to 1.05, or in the range of 1.05 to 1.1. While strict step wise controlled growth can be used to prepare dendrimers with extremely low polydispersity (i.e. approaching 1), it is also possible to prepare and use dendrimers with a polydispersity index of 1.1 to 1.5 in the preparation of end-linked sPUUs. Dendrimer-like hyperbranched polymers with a polydispersity index from 1.1 to 1.5 may also be employed.

Dendrimeric crosslinking agents may be selected to have a variety of morphologies. Dendrimers suitable for the preparation of end-linked sPUUs include, but are not limited to, star dendrimers and/or core-shell dendrimers. Dendrimers suitable for the preparation of end-linked sPUUs also include, but are not limited to, Janus dendrimers and/or arborols. The molecular weight (e.g., the weight average molecular weight, Mw) for dendrimers suitable for use in the preparation of end-linked sPUUs may, for example, be in any of the ranges recited above. Alternatively, the Mw range may be selected from 500 to 10,000 Da or from 10,000 to 200,000 Da. The use of dendrimers having higher molecular weights is possible, but consideration of the synthetic route including viscosity and shear limitations must be considered. An example of a dendrimer with multiple pendant primary amine groups suitable for the preparation of end-linked sPUU are PAMAM dendrimers having an ethylene diamine core, for example, that are primary amine terminated (having primary amino surface groups) as depicted in FIG. 1D at j. The PAMAM dendrimer may be, for example, a zero to second generation (G0-G2) dendrimer, or a third to fifth generation (G3-G5) dendrimer. Alternatively, the PAMAM dendrimer may be sixth or seventh generation (G6-G7) dendrimer or, if the molecular weight is to extend above 200,000 Da, a G8 or higher (e.g., G8-G9) dendrimer.

### IX. End-Linked sPUU Additives

Compositions comprising the end-linked sPUUs and compositions for preparing end-linked sPUUs described herein may comprise one or more of additional materials referred to as additives. Those additives include but are not limited to dispersants, antioxidants, lubricants, and other components described below. The materials added to compositions used to prepare end-linked sPUUs may also include solvents.

Additives and other materials (e.g. solvents) may be added to compositions used to form end-linked sPUU polymers at any one or more points beginning with the synthesis. See e.g., FIG. 1B for non-limiting examples of positions where additives may be added. For example, additives such as lubricants (e.g., polydimethylsiloxane (PDMS)) and antioxidants (e.g., sterically hindered phenols) may be added during polymerization to form the prepolymer (iii), and/or during preparation of the protected prepolymer (v) or protected polymer (vii) provided the additives do not interfere with the synthetic reactions. Additives may also be added just before or during deblocking of protected polymers (vii) or protected prepolymers (v), resulting in reaction with crosslinking agent (viii) to produce the end-linked sPUUs, provided the additives do not interfere with the end-linking reaction. End-linked sPUUs are not generally soluble in solvents, and are not meltable thermoplastics; however, end-linked sPUUs can swell in some organic solvents, albeit, not to the extent that otherwise identical but non-crosslinked sPUUs will swell (or dissolve) in solvents such as N,N-dimethylacetamide. Accordingly, post crosslinking (end-linking) addition of additives is limited to additives that are soluble in a solvent that can swell the end-linked sPUUs, or that can be directly absorbed into the end-linked sPUUs. There are two drawbacks to this type of post crosslinking addition: (i) it may be difficult to remove the solvent used for swelling; and (ii) the distribution of the additive may not be uniform throughout the article subject to swelling. Different additives may be added at one or more independently selected points in the preparation of end-linked sPUU polymers or shaped articles comprising those polymers.

Where the additives are not damaged by the temperatures required for holding compositions used to make the end-linked sPUUs or shaped articles made from them, the additives may be added at any point discussed above. Where an additive is not stable to either the temperature required for holding the compositions used to prepare the polymer, or the temperatures used to activate the blocked isocyanates and deblock them, the additive may be added with the crosslinking agent or after the crosslinking agent is added as the crosslinking is occurring. When incorporating temperature sensitive additives into compositions for preparing end-linked sPUUs, damage to the additives may be minimized by selecting blocking agents with the lowest activation temperatures and making additive addition(s) just before (e.g., less than 5 min or less than one minute) heating to initiate crosslinking; as opposed to adding the temperature sensitive additive to compositions that will be held at elevated temperatures before crosslinking is initiated.

When additives are added prior to melting or dissolving a protected sPUU polymer (element (vii) FIG. 1B), the protected sPUU polymer(s) may be in the form of, for example, granules or powder, or chopped fiber (tow); however, the process may be conducted using the solvent employed during the extending and blocking reactions. Compositions comprising a mixture of one or more protected sPUU polymer(s) (vii) of the present disclosure (e.g., as granules or tow) along with one or more optional additives are included within the scope of the present disclosure. For example, compositions comprising one or more protected sPUU polymer(s) (element vii of FIG. 1B) and either an electrically conductive additive (e.g., particles of a carbonaceous additive such as graphite) and/or a cathode active material are within the scope of the present disclosure. Similarly, compositions and shaped articles comprising one or more end-linked sPUUs and either an electrically conductive additive (e.g., particles of a conductive carbonaceous additive such as graphite) and/or a cathode active material are within the scope of the present disclosure.

The present disclosure includes and provides for compositions comprising any of a) one or more protected sPUU polymers (vii), b) one or more protected prepolymers (v), or c) an end-linked sPUU, in combination with one or more additives selected from the group consisting of lubricants, antioxidants, heat stabilizers, hydrolytic stabilizers, and acid scavengers. Those additives may each be present, for example, in an independently selected amount from about 0.1% to about 5% by weight, or from about 0.1% to about 4% by weight of the composition. By way of example, such compositions may comprise each of those additives in an independently selected amount from about 0.1% to about 0.5% by weight or from about 0.5% to about 1% by weight. Alternatively, such compositions may comprise those additives in an independently selected amount from about 1% to about 2% by weight or from about 2% to about 4% by weight. In some instances, those additives may be present in an independently selected amount from about 3% to about 5% by weight or from about 4% to about 5% by weight.

The present disclosure includes and provides for compositions comprising either one or more protected sPUU polymers (vii) or an end-linked sPUU in combination with one or more additives selected from the group consisting of lubricants, antioxidants, heat stabilizers, hydrolytic stabilizers, and acid scavengers. Those additives may be present, for example, in a total amount from about 0.1% to about 5% by weight or from about 0.1% to about 4% by weight. By way of example such compositions may comprise those additives in a total amount from about 0.1% to about 0.5% by weight or from about 0.5% to about 1% by weight. Alternatively, such compositions may comprise those additives in a total amount from about 1% to about 2% by weight or from about 2% to about 4% by weight. In some instances, those additives may be present in an amount from about 3% to about 5% or from about 4% to about 5% by weight. Additional ranges of individual additives are discussed separately.

### X. Dispersants

While the end-linked sPUUs of the present disclosure may be utilized without the addition of optional dispersants, dispersants can be advantageous when incorporating materials in the form of particles (e.g., electrically conductive materials or cathode active materials). Dispersants can be added to the sPUUs or compositions for preparing end-linked sPUUs to improve the uniformity of end-linked sPUU coatings on substrates and/or adhesion of the end-linked sPUUs to particulate materials and substrates (e.g., current collectors of electrochemical cell cathodes or anodes, or the metal/metalized layers of capacitors). The uniformity can be observed by the distribution of particulate throughout the end-linked sPUU polymer (e.g., in cross sections of a layer of binder viewed by electron microscopy). Accordingly, the end-linked sPUUs of the present disclosure comprising particulate materials including, but not limited to, one or more of fillers, electrically conductive materials, cathode active materials, and combinations of two or more thereof, may advantageously comprise one or more dispersants. Even where the end-linked sPUUs contain no particulate materials, they may comprise one or more dispersants that increase their adhesion to a substrate.

Suitable dispersants include hydrogenated nitrile butadiene rubber (HNBR). In some instances, the acrylonitrile content in HNBR may be from about 17% to about 50% by weight of the total composition, for example from about 30% to about 45%, such as from about 35% to about 43%, or from about 37% to about 41% as described in WO2023/012257. The hydrogenation process may be complete or incomplete. In some instances, the HNBR utilized as a dispersant may comprise up to about 10% residual double bonds (e.g., about 7.5%). In other instances, the HNBR dispersant may comprise up to about 5% or up to about 2.5% residual double bonds. In still other instances, the HNBR dispersant may comprise up to about 1% residual double bonds. The content of residual double bonds in an HNBR dispersant may be determined using IR spectroscopy relative to a sample of the HNBR that has not been hydrogenated.

The Mw range for HNBR dispersants will typically be from about 50,000 Da to about 500,000 Da (as measured using GPC). HNBR dispersants may have a Mw from about 75,000 Da to about 250,000 Da or from about 100,000 Da to about 200,000 Da. HNBR dispersants may have a Mw from about 125,000 Da to about 175,000 Da. In an aspect of the invention the HNBR dispersant has less than about 1% residual double bonds and about 39% acrylonitrile content. Current HNBR suppliers include Arlanxeo, which sells HNBR under the tradename Therban® (e.g. AT3904, AT3443, AT3404, and LT2004).

Other dispersants include butadiene/styrene copolymers, emulsion or solution polymerized polybutadiene, cis-polyisoprene, and isobutylene/diene copolymers, which have been described for their ability to act as dispersants of elastomers in solvents (see, e.g., U.S. Pat. No. 3,755,239). Poly(styrene-r-butadiene)-b-poly(poly(ethylene glycol) methyl ether methacrylate) (p(SB-b-PEGMA)), which is a biocompatible and amphiphilic polymer that finds use in suspending particulates such as silicas and other fillers in end-linked sPUU compositions, may be employed. That molecule comprises (i) an anchoring poly(styrene-butadiene) (SB) block that is non-polar and may adsorb or “anchor” to the surface of non-polar particles (such as silica) and (ii) a stabilization portion (PEGMA block) that is a polar, hydrophilic segment understood to extend from the particle surface into the dispersing medium creating a layer around each particle that inhibits/prevents clumping or flocculation. Natural rubber may also be used as a dispersant.

When present, the one or more dispersants (in total) may comprise, for example, from about 0.1% to about 5%, or from about 5% to about 10% by weight of the end-linked sPUU, or the polymer forming components of a composition for preparing an end-linked sPUU polymer or an article comprising the polymer (e.g., excluding solvent, and fillers). The dispersants may comprise from about 0.1% to about 0.5%, or from about 0.5% to about 1% by weight of an end-linked sPUU, or the polymer forming components of a composition for preparing an end-linked sPUU polymer or an article comprising the polymer. The dispersants may comprise from about 1% to about 2%, or from about 2% to about 4% by weight of an end-linked sPUU, or the polymer forming components of a composition for preparing an end-linked sPUU polymer or an article comprising the polymer. The dispersants may comprise from about 3% to about 4%, or from about 4% to about 5% of an end-linked sPUU by weight, or the polymer forming components of a composition for preparing an end-linked sPUU polymer or an article comprising the polymer.

### XI. Antioxidants

Antioxidants (e.g., hindered phenol antioxidants and/or secondary antioxidants such as phosphites) may be added to the end-linked sPUUs or compositions for preparing end-linked sPUUs where their use may expose the polymer to oxidative damage from, for example, peroxides, ozone, or free radicals (e.g., superoxide radicals). Antioxidants incorporated during end-linked sPUU synthesis (e.g., during synthesis of elastomeric sPUU chains of the end-linked polymer) can provide oxidative protection during storage, transportation, and use (service) of the end-linked sPUUs described herein or products incorporating those end-linked sPUUs. The incorporation of antioxidants serves multiple purposes including preventing degradation during heated processing operations such as spinning, preventing damage during mechanical shear, preventing thermal energy induced free radical formation, and preventing degradation during service (e.g. from exposure to oxygen or free radicals, UV radiation, thermal cycling, humidity etc.). Antioxidants may also improve electrochemical stability and/or may also provide supplementary protection against aging phenomena.

Some of the antioxidants/radical scavenging materials that can be employed in end-linked sPUUs and/or compositions for their preparation include antioxidants also used in alkali metal batteries (e.g., lithium-ion battery antioxidants such as phosphites, phenolics, sulfur-containing compounds, boron containing compounds, and mixtures of any thereof. Phosphites and/or phosphonates (e.g., triphenyl phosphite (TPP), tris(trimethylsilyl) phosphite) act as radical scavengers and help prevent oxidation of the end-linked sPUUs and may also protect the electrolyte solvent used in batteries (e.g., lithium-ion batteries). Phenolic compounds (e.g., hindered phenolic compounds) including but not limited to butylated hydroxytoluene (BHT) or ethylene bis(oxyethylene) bis-(3-(5-tert-butyl-4-hydroxy-m-tolyl)propionate) [CAS #36443-68-2] act as antioxidants and can inhibit free radical formation and damage resulting from free radical reactions with the end-linked sPUUs and/or battery components. Sulfur-containing compounds include but are not limited to thiophene derivatives and/or sulfone-based additives that can act to suppress oxidative damage. Boron based additives, such as tris(pentafluorophenyl)borane, can act as a Lewis acid to stabilize a number of the electrolytes used in lithium-ion batteries, and reduce oxidative reactions that can damage the end-linked sPUUs or battery components.

End-linked sPUUs and compositions for their preparation comprising one or more antioxidants may comprise, for example, up to about 5% or up to about 3% of the antioxidant by weight relative to the end-linked sPUU or polymer forming components in the compositions for their preparation. The antioxidant may be present from about 0.1% to about 3%, or from about 0.2% to about 3% by weight relative to the end-linked sPUU or polymer forming components in the compositions for their preparation. The antioxidant may be present from about 0.1% to about 1%, or from about 1% to about 2% by weight relative to the end-linked sPUU or polymer forming components in the compositions for their preparation. The antioxidant may be present from about 0.2% to about 3%, or from about 3% to about 4% by weight relative to the end-linked sPUU or polymer forming components in the compositions for their preparation. The antioxidant may be present from about 1% to about 2.5%, or from about 4% to about 5% by weight relative to the end-linked sPUU or polymer forming components in the compositions for their preparation.

### XII. Lubricants

Lubricants are optionally added to end-linked sPUUs, or compositions for preparing end-linked sPUUs, and may be added post production in the event they can be adsorbed and/or absorbed by the polymer. Lubricants can assist in the formation of end-linked sPUU polymers, e.g., by casting, extrusion or spinning. In many embodiments, such as where the end-linked sPUU polymers described herein are to be utilized as binders for alkali metal battery electrodes (e.g., as a binder of lithium-ion battery cathodes), lubricants may be omitted. When present, the lubricant may be a paraffin oil or a silicon oil, for example, selected from polydimethylsiloxane (PDMS) or polydiethylsiloxane (PDES). Lubricating clays that may be employed include hydroxylated hydrotalcite.

End-linked sPUUs and compositions for their preparation comprising a lubricant typically include lubricants in an amount up to about 5% or up to about 3% by weight relative to the end-linked sPUU or polymer forming components in the compositions for their preparation. The lubricant(s) may be present from about 0.1% to about 0.5%, or from about 0.2% to about 3% by weight relative to the end-linked sPUU or polymer forming components in the compositions for their preparation. The lubricant(s) may be present from about 0.1% to about 1%, or from about 1% to about 2% by weight relative to the end-linked sPUU or polymer forming components in the compositions for their preparation. The lubricant(s) may be present from about 0.2% to about 3%, or from about 3% to about 4% by weight relative to the end-linked sPUU or polymer forming components in the compositions for their preparation.

### XIII. Other Components

Among the other components that can be added to the end-linked sPUUs, or compositions for preparing end-linked sPUUs, described herein as additives include, but are not limited to, heat stabilizers, hydrolytic stabilizers (e.g., carbodiimides), acid scavengers, plasticizers, fillers (e.g., mineral fillers), and combinations thereof. Electrically non-conductive fillers that may be included in the end-linked sPUUs include but are not limited to boehmite, alumina, and silica. Other non-conductive fillers include but are not limited to calcium carbonate, barium sulfate, kaolin, diatomaceous earth, and talc. In addition, compositions and articles comprising end-linked sPUUs may contain pigments or colorants.

The total amount of other components present will vary depending on the intended use of the end-linked sPUU or the articles prepared from them. The total amount of other components may be in a range of less than 1% or from 1-5% relative to the end-linked sPUU, or polymer forming components of compositions for preparation of end-linked sPUU polymers or articles comprising those polymers. The total amount pf other components may be in a range of 5%-10%, or from 10-25% relative to the end-linked sPUU or polymer forming components of compositions for preparation of end-linked sPUU polymers or articles comprising those polymers. The total amount pf other components may be in a range of 25%-50%, or from 50-75% relative to the end-linked sPUU or polymer forming components of compositions for preparation of end-linked sPUU polymers or articles comprising those polymers. The total amount pf other components may be in a range of 75%-95%, or from 95-99% relative to the end-linked sPUU or polymer forming components of compositions for preparation of end-linked sPUU polymers or articles comprising those polymers. Higher levels are typically applicable to fillers.

### XIV. Electrically Conductive and/or Reactive End-Linked sPUU Compositions and Electrochemical Cells

The end-linked sPUUs of the present disclosure, or compositions for their production, may include one or more materials that are conductive and/or that function as redox active materials in an electrochemical cell such as a battery. In such applications the end-linked sPUUs act as a flexible binder retaining and supporting the conductive and/or redox active materials.

While the end-linked sPUUs described herein may be used as insulating materials, addition of electrically conductive materials (e.g., conductive polymers and particles) can render compositions comprising the end-linked sPUUs conductive. The conductivity permits the use of the flexible end-linked sPUUs as conductive material in, for example, flexible displays and electronics, biosensors, energy storage (e.g. capacitors and supercapacitors), corrosion inhibitors, and antistatic coatings.

Incorporation of redox active materials, such as cathode active materials, produces end-linked sPUU compositions suitable for a variety of uses including as anodes and/or cathodes of electrochemical cells such as lithium-ion battery secondary cells.

### XV. Electrically Conductive Materials

Where end-linked sPUU polymers act as a binder in a composition, article, or structure (element of an article) that is conductive, various electrically conductive materials may be incorporated into the polymer to alter its conductivity. Incorporation of the electrically conductive material is typically made pre polymerization in either the presence or absence of an added solvent(s). The electrically conductive material will typically be in the form of a particle, powder, or fiber (e.g., a nanofiber). Electrically conductive materials may be added to the end-linked sPUUs over a broad range of concentrations, such as from less than about 0.1% to about 30% on a weight basis of the composition or article comprising the end-linked sPUU polymer. The range of the electrically conductive material addition may be, for example, from about 0.1% to about 1% or from about 1% to about 10% by weight of the composition or article comprising the end-linked sPUU polymer. The range of the electrically conductive material addition may be, for example, from about 10% to about 25% or from about 25% to about 50% by weight of the composition or article comprising the end-linked sPUU polymer. The range of the electrically conductive material addition may be, for example, from about 20% to about 25% or from about 25% to about 30% by weight of the composition or article comprising the end-linked sPUU polymer. The range of the electrically conductive material addition may be, for example, from about 20% to about 25% or from about 25% to about 30% by weight of the composition or article comprising the end-linked sPUU polymer It should be noted, however, that the end-linked sPUU when used as a binder for conductive materials can be reduced to the minimum amount necessary to bind the material. Where a material does not require properties such as flexibility, the amount of end-linked sPUU binder can be as low as 1%. Accordingly, when binder is to be minimized, the binder may comprise, for example, about 1% to about 10% by weight of an article with the remainder comprised of conductive materials and other additives. However the binder may also comprise, for example, about 10% to about 30% by weight, or from about 40% to about 70% by weight, with the remainder comprised of conductive materials and other additives.

The electrically conductive material may comprise one or more nonmetallic materials, which may be, for example, a carbonaceous material. Carbonaceous electrically conductive materials may comprise one or more materials that comprise (e.g., comprise at least 50% or at least 75%) a carbon containing material selected from the group consisting of graphite, graphene, carbon black, nano carbon black (e.g., Super P® Li carbon black from Imreys, Paris, France), carbon fiber, carbon nanotubes, acetylene black, and combinations thereof (e.g., binary or ternary combinations). Carbonaceous electrically conductive materials may comprise one or more materials selected from the group consisting of graphite, graphene, activated carbon, carbon fiber, carbon nanotubes (CNT), carbon nanofibers (CNF) and combinations thereof (e.g., binary or ternary combinations). Carbonaceous electrically conductive materials may also comprise one or more materials selected from the group consisting of graphite, graphene, carbon black, CNT, acetylene black, binary conductive paste, ternary conductive paste, and combinations thereof (e.g., binary or ternary combinations). Conductive materials may also be metallic and nonmetallic composites such as nickel-plated CNTs (e.g., Ni-MWCNTs (Nickel Coated Multi-walled Carbon Nanotubes) such as CAS Number 308068-56-6/7440-02-0 from Ossila Ltd. Sheffield, UK).

Conductive carbonaceous materials that may be incorporated into the end-linked sPUUs of the disclosure may also comprise one or more conductive organic materials, such as a poly-aniline (PANI), polypyrrole (PPy), polythiophene (PT), poly(3,4-ethylenedioxythiophene) (PEDOT), and polyphenylene derivatives.

The electrically conductive material may comprise one or more metallic materials. Because metallic materials can react with the reactive components or even the electrolyte in batteries, they may be excluded from end-linked sPUUs and compositions for preparing end-linked sPUUs used in electrochemical applications such as secondary lithium-ion batteries. Conductive metallic materials include, but are not limited to, powders of non-noble metals such as one or more of: copper, silver, nickel, iron, tin, zinc, aluminum and alloys comprising any one or more thereof (e.g., at greater than about 0.05% or about 0.5% by weight). The metallic materials may also include, but are not limited to, powders or particles of noble metals, such as one or more of: gold, platinum, ruthenium, rhodium, palladium, osmium, iridium and alloys comprising any one or more thereof (e.g., at greater than about 0.05% or about 0.5% by weight of the conductive metallic material). Nonmetallic (e.g., carbonaceous) and metallic electrically conductive materials may be used in any combination and will typically have particles within a specified size range and morphology (e.g. particles or fibers). Materials present in a conductive polyurethaneurea composition as per this disclosure may be in the form of a particle, powder, or fiber. The particles may be prepared from materials that are crystalline or amorphous, and may be porous. Conductive particles, powders, or fibers may have an average largest dimension in the range of about 30 to about 50 microns (μm) or in the range of about 10 to about 30 μm. Conductive particles, powders, or fibers may have an average largest dimension in the range of about 1 to about 10 μm or in the range of about 0.1 to about 1 μm. Carbon nanofibers may, for example, have a diameter in the range of about 10 nanometers (nm) to about 600 nm and a length up to about 10 μm (e.g. in the range of about 1 μm to about 5 μm or about 5 to about 10 μm). Some carbon nanofibers may have diameters from about 50 to about 150 nm or about 100 to about 300 nm. Other carbon nanofibers may have diameters in the range of about 200 to about 600 nm (e.g., about 200 to about 400 nm or about 400 to about 600 nm). Single walled CNTs may have, for example, diameters in the range of about 0.5 to about 1.5 nm and multi-walled CNTs may have diameters exceeding 100 nm (e.g. about 5 to about 200 nm).

Unless stated otherwise, for particles of materials recited in this disclosure that fall within the range of about 20 nm to about 2800 μm, the size may be determined using laser light diffraction. For example, particle size may be determined using a MICROTRAC® Bluewave S3500 analyzer according to the manufacturer's instructions consistent with ISO 13320:2020. Where the determination of particle size of materials in a matrix is undertaken, the matrix may be dissolved provided the dissolution will not change the particle size. Where particles are embedded in a matrix, electron microscopy can be used as an alternative depending on the particle size and matrix involved.

For end-linked sPUUs intended to be used in spinning fibers, the diameter of the particle sizes is limited by the diameter of the fiber. Preferably the diameter of added particles is less than a sixth (about 16%) or more preferably less than one tenth (about 10%) of the fiber diameter. In some instances, the particle diameter can be less than about 5% or about 3% of the fiber diameter.

### XVI. Cathode Active Materials

The end-linked sPUUs described herein may be used as binders for the creation of cathodes or anodes of electrochemical cells. The finished cathode may contain electrically conductive materials such as carbonaceous material, and will typically either be prepared upon or contain a current collector, which is typically metal but may be another type of electrically conductive material. In some embodiments, the current collector is a metal foil that also acts as the supporting surface upon which end-linked sPUU compositions are formed.

Cathode active materials utilized in the preparation of, for example, secondary cells may be in particulate form. In some instances, cathode active materials utilized in the preparation of cathodes are in the size range of about 0.1 μm to about 1 μm, or from about 1 μm to about 5 μm, with less than 10% of the particles below the lower range limit and less than 10% of the particles above the upper range limit. In other instances, cathode active materials utilized in the preparation of cathodes are in the size range of about 5 μm to about 25 μm or about 10 μm to about 50 μm, with less than 10% of the particles below the lower range limit and less than 10% of the particles above the upper range limit. In other instances, cathode active materials utilized in the preparation of cathodes are in the size range of about 1.0 μm to about 10 μm, or from about 10 μm to about 100 μm; with less than 10% of the particles below the lower range limit and less than 10% of the particles above the upper range limit.

Cathode active materials associated with the end-linked sPUUs described herein include transition metal (M) complexes such as layered lithium metal oxide (LiMO2) cathode materials, wherein the metal “M” may be nickel. Cathode active materials also include lithium nickel manganese cobalt oxides (NMC), and high-nickel lithium nickel manganese cobalt oxide (high Ni NMC) or lithium-rich, lithium nickel manganese cobalt oxide (Li-rich NMC).

Some NMCs are of the formula, LibNi1-x-yCoxMnyAzO2 (0<x+y<1), where A is an element other than Li, Ni, Co, Mn or O and wherein 0≤z≤0.05. In some NMCs z is bound by 0<z≤0.03, or 0.001<z≤0.01, wherein 0.9≤b≤1.2. A may be selected from the group Al, B, Zr, Ba, Ca, Ti, Mg, Ta, Nb, V, Fe, Ru, Re, Pt and Mo, or selected from the group Al and Zr.

Lithium-rich NMC cathode materials may comprise lithium NMC oxides of the formula, LibNi1-x-yCoxMnyAzO2 (0<x+y<1), where A is an element other than Li, Ni, Co, Mn or O and wherein 0<z≤0.05, preferably 0<z≤0.03. In such lithium-rich NMCs z may be bound by 0.001<z≤0.01, wherein 1.05≤b≤1.2. A may be selected from the group Al, B, Zr, Ba, Ca, Ti, Mg, Ta, Nb, V, Fe, Ru, Re, Pt and Mo, or selected from the group Al and Zr.

High-nickel NMC cathode materials may comprise lithium NMC oxides represented by the formula LibNi1-x-yCoxMnyAzO2, wherein 0<x+y<0.4. Alternatively, x+y maybe bounded by 0<x+y<0.25, wherein 0≤z≤0.05 or 0<z≤0.03, or wherein 0.001<z≤0.01, and wherein 0.9≤b≤1.2. A may be selected from the group Al, B, Zr, Ba, Ca, Ti, Mg, Ta, Nb, V, Fe, Ru, Re, Pt and Mo, or selected from the group Al and Zr.

The ratio of the nickel in the high-nickel NMC material may be in the range of about 33 mol % to about 98 mol %. The ratio of nickel may be in the range of about 33 mol % to about 60 mol %, or from about 60 mol % to about 95 mol %. The ratio of nickel may also be in the range of about 60 mol % to about 80 mol %, or from about 80 mol % to about 95 mol %.

The NMC cathode materials may also comprise LibNi1-x-yCoxMnyAzO2, wherein 0<x+y<0.4, preferably 0<x+y<0.25, and wherein 0<z<0.05, preferably 0.002<z<0.03, more preferably 0.001<z<0.01, and wherein 0.9<b<1.1. A may be selected from the group Al, B, Zr, Ba, Ca, Ti, Mg, Ta, Nb, V, Fe, Ru, Re, Pt and Mo, or selected from the group Al and Zr.

The cathode active material may also comprise at least one material comprising an NMC oxide, a nickel cobalt manganese aluminum (NMCA), a nickel oxide (LMNO), a lithium manganese oxide (LMO), a lithium NMC oxide, a lithium nickel cobalt aluminum oxide, a lithium cobalt oxide, a lithium iron phosphate (LFP), or a combination of any thereof. The cathode active material may comprise at least one material comprising an NMC oxide or an NMCA. The cathode active material may comprise at least one material comprising an LMNO or an LMO) The cathode active material may comprise at least one material comprising a lithium NMC oxide or a lithium nickel cobalt aluminum oxide. The cathode active material may comprise at least one material comprising a lithium titanate or a lithium cobalt oxide. The cathode active material may comprise an LFP, such as LiFePO4.

### XVII. Current Collectors

Alkaline metal batteries, and particularly Li-ion batteries, are generally comprised of a stack of cells (e.g., secondary cells). Each cell is comprised of a cathode optionally having a cathode current collector, an electrolyte, and an anode optionally having an anode current collector. The cell may also have a separator between the anode and cathode (e.g., to prevent or limit the chance of the cathode and anode coming into contact).

The current collectors comprise an electrically conductive material, generally a metal. The metal may take a variety of shapes or forms, and may be a layer supported by another material (e.g., a thin layer of vapor deposited metal on a conductive or non-conductive polymer). The current collector of an anode or cathode may comprise a material selected independently from aluminum, brass, bronze, cobalt, copper, graphite, indium, magnesium, platinum, iron, nickel, nickel-zirconia, copper-zirconia, copper nickel-zirconia, copper cobalt-zirconia, zinc, and combinations thereof. The current collector of an anode or cathode may comprise a material selected independently from aluminum, nickel, cobalt, tungsten, copper, or a combination thereof. The current collector of an anode or cathode may comprise an electrically conductive carbon form or a carbonaceous material (e.g., CNTs). A current collector for a cathode or anode may comprise aluminum or an aluminum alloy (e.g., aluminum-indium), particularly in the form of a foil or as a vapor deposited layer on a polymer. Alternatively, the metal may be in the form of a foam (e.g., an aluminum or nickel foam) that offers high surface area.

A lithium-ion battery may comprise (i) a cathode that may comprise a current collector comprised of an aluminum-based material (e.g., aluminum or an aluminum alloy such as an aluminum-indium alloy), particularly in the form of a foil or as a vapor deposited layer on a polymer, and/or (ii) an anode that may comprise an anode current collector that may be comprised of a copper-based material (e.g., copper or a copper alloy), particularly in the form of a foil or as a vapor deposited layer on a polymer.

A lithium-ion battery may comprise (i) a cathode that may comprise a cathode current collector comprised of an aluminum-based material (e.g., aluminum or an aluminum alloy such as an aluminum-indium alloy), particularly in the form of a foil or as a vapor deposited layer on a polymer, and/or (ii) a carbonaceous anode (e.g., comprising graphite, carbon powder, carbon black, etc.) that may comprise an anode current collector that may be comprised of copper (e.g., copper or a copper alloy), particularly in the form of a wire or foil/layer (e.g., as a vapor deposited layer on a polymer).

Aluminum-based cathode current collectors and copper-based anode current collectors may be used in Lithium Cobalt Oxide (LCO), LMO, Nickel Cobalt Aluminum Oxide (NCA), NMC oxide, LFP, or Lithium Titanium Oxide (LTO) electrochemical cells (e.g., batteries). In an embodiment, those electrochemical cells may have a carbonaceous anode such as an anode comprised of graphite.

### XVIII. Methods of End-Linked sPUU Preparation and Their Properties

### XIX. Preparation of sPUUs

As discussed above, the end-linked sPUU polymers described herein may be made by any number of processes two of which are exemplified in FIG. 1B. The processes described in that figure start with the reaction of one or more glycols (i) (e.g., diols of polyethers, polyesters or polycarbonates, including their copolymers or mixtures) with one or more diisocyanates (ii) in an amount equal to or in a slight excess relative to the amount of hydroxyl end groups to form an isocyanate-terminated prepolymer (iii). From prepolymer (iii), there are two routes to end-linked sPUUs and shaped articles made with them. In the first route the prepolymer is reacted with one or more blocking agents (iv), resulting in the formation of a protected prepolymer (v). The protected prepolymer is then combined with one or more chain extenders (vi) and one or more crosslinkers (viii), which may be added separately in any desired order or in combination. Chain terminators (ix), which are optional, may be added with any one or more of the blocking agents, extenders, or crosslinkers, or they may be excluded. Upon heating, the blocked isocyanates are activated (e.g., deblocked by releasing the blocking agents) and the isocyanates react with the amine groups of the extender (vi), crosslinker (viii) and any chain terminator (ix) that may have been added thereby forming the end-linked sPUU polymer. If the heating is done in conjunction with forming the polymer, the result is a shaped article. Although solvent addition is indicated at any number of points in the synthetic routes for the preparation of end-linked sPUUs, it should be noted that solvent addition may be made at any suitable point. Indeed, all routes for the preparation of end-linked sPUU polymers or articles comprising them (e.g., routes A and B in FIG. 1B) described or exemplified herein are utilize one or more solvents in the synthetic process.

In the second route exemplified in FIG. 1B as route B, prepolymer (iii) is reacted with both a blocking agent (iv) and an extender (vi), and optionally with a chain terminator (ix) desired to form a protected polymer (protected sPUU polymer, vii). The protected polymer is combined with crosslinker (viii). Upon heating the combined materials, the blocked isocyanates are activated (e.g., deblocked by releasing the blocking agents) and the isocyanates react with the amine groups of the crosslinker (viii) and any chain terminator (ix) thereby forming the end-linked sPUU polymer. If the heating is done in conjunction with forming the polymer, the result is a shaped article.

Although FIG. 1B indicates certain points at which solvents are added or present, the solvents necessary may be added at any phase of end-linked sPUU preparation. In most instances, the solvent will be removed just before or in conjunction with the crosslinking reaction to minimize solvent remaining in the polymer or article (e.g., spun fibers). For example, heating of the composition in conjunction with the spinning process can evaporate the solvent and deblock isocyanates permitting the crosslinking reaction to occur. Extenders (vi), terminators (ix), and additives (x) must not be so volatile that they evaporate before reaction to form the end-linked sPUUs, particularly when proceeding through route A of FIG. 1B, where they will be subject to the heat required for deblocking the protected isocyanates.

The amount of crosslinking agents has an impact on the crosslinking (end-linking) density and, accordingly, should be controlled to achieve desired performances. Ideally, all regenerated isocyanate groups upon heat activation are reacted with amino groups from the crosslinking agents (or crosslinking agents and chain terminators, when both are present as in FIG. 1B, route A) to provide the highest efficiency of the end-linking. For some crosslinking agents like a branched PEI [CAS #9002-98-6], which has reactive primary amines, secondary amines, and unreactive tertiary amines, attempts to estimate or calculate the crosslinking efficiency can become quite complex. One method to assess the effect the amount of crosslinking agent addition has is by gel content analysis of the crosslinked polymer (the amount of solvent insoluble polymer formed) versus the amount of crosslinking agent added. This is exemplified in Example 17.

The weight percentage to get the highest crosslinking density will vary depending on the crosslinking agent and the amine concentrations (in milliequivalent per gram); however, the technique from Example 17 can be used to identify suitable ranges. Additionally, properties such as mechanical properties (e.g., tensile strength) and ionic conductivity, should be considered in determining the most suitable range or optimum amount of a crosslinking agent when selecting a polymer for a specific use (e.g., as a binder for electrodes). Crosslinking agent may be, for example, in the range of 0.1 to 10.0 wt %, or 0.3 to 5.0 wt %, based on the total weight of the end-linked polymer. For example, crosslinking agent may be, for example, in the range of 0.1 to 1.0 wt %, or 1.0 to 3.0 wt % based on the total weight of the end-linked polymer. Crosslinking agent may also be, for example, in the range of 3.0 to 7.0 wt %, or 7.0 to 10.0 wt % based on the total weight of the end-linked polymer. The wt % is particularly relevant to polymeric amines such as PEI. As an alternative to weight percentages, the relative ratio of protected (blocked) isocyanate groups to the isocyanate reactive amino groups in the crosslinking agent can be specified. Isocyanate reactive amine groups include primary and secondary amines, but not tertiary amines. Theoretically, the ideal ratio of protected isocyanates to amines (isocyanate reactive amines) is 1:1, but can be expanded to a range of from 1:0.5 to 1:5. The range may also be from about 1:0.5 to about 1:2 or from 1:2 to about 1:5. The range may also be from about 1:1 to about 1:1.1 or from 1: to 1:1.05

When preparing end-linked sPUUs by route B, it is possible to control the length (molecular weight), hard segment molecular weight (HSMW), and soft segment molecular weight (SSMW) of the protected polymer (vii), and accordingly those aspects of the end-linked sPUU using techniques known in the art. See, e.g., US Pat. Pub. No. 2021/0087388A1, which is incorporated by reference for the methods/techniques of preparing sPUU polymers of defined molecular weight and having defined SSMW:HSMW ratios (MW being the weight average molecular weight).

It will be apparent to those of skill in the art that both the extended glycol approach, described in US Pat. Pub. No. 2021/0087388A1, and the under-capping process approach can be used to prepare sPUUs as protected prepolymers (vii). The under capping approach comprises adding a controlled amount of a second diisocyanate to an isocyanate terminated prepolymer which is produced by reacting a glycol at a low capping ratio (typically less than 1.50) with a first diisocyanate. The first diisocyanate and the second diisocyanate may be the same or different. The mixture, including the added second diisocyanate and the capped glycol prepolymer from the first diisocyanate, is dissolved into a solvent, and a diamine chain extender and one or more blocking agents (and optionally chain terminator(s)) are then added to produce the protected sPUU polymer (vii) with engineered soft and hard segment molecular weights. The capping ratio in making the capped glycol prepolymer and the amount of second diisocyanate added to the capped glycol can be controlled to provide the desired SSMW/HSMW molecular weight ratio of the protected sPUU polymer (vii).

The ability to control the molecular weight (Mw) and SSMW/HSMW ratios of the sPUU chains in the end-linked sPUUs is important to the product properties including but not limited to their resistance to various environmental factors. While the end-linked sPUUs described herein are less soluble, if not completely insoluble, in most solvents (e.g., solvents or electrolytes in batteries such as lithium-ion batteries), control of the other parameters, such as elastic modulus, susceptibility to oxidation etc., is affected by the size and composition of the end-linked polymer chains. In addition, control of Mw also affects processing conditions including slurry solids content and viscosity of compositions about to be end-linked.

### XX. Physical Properties

The end-linked sPUUs of the present disclosure are elastomeric in nature. The diameter of end-linked sPUU filaments is greater than the largest dimension of any particulate materials that are incorporated into the polymer, e.g., at least 4 times greater in diameter or at least 5 times greater. The end-linked sPUU filaments may have a diameter of about 10 μm to about 100 μm. By way of example, the filaments may be about 10 μm to about 25 μm, or about 25 μm to about 35 μm. Other end-linked sPUU filament diameters may be from about 35 μm to about 75 μm or 35 μm to about 100 μm. The particulates incorporated into the end-linked sPUU filaments may have a diameter in their largest dimension that is one-fourth or one fifth of those diameter values.

In an embodiment end-linked sPUU yarn may be from about 10 denier (or den) to about 1,500 den. In an embodiment the yarn is from about 10 den to about 100 den, or from about 100 den to about 250 den. In other embodiments, the yarn may be about 250 den to about 500 den, or from about 500 den to about 1,000 den. Other ranges of end-linked sPUU yarn include from about 1,000 den to about 1,500 den. Thicker yarns, for example above 250 den or above 500 den, may be cut into segments and provide pellet-like materials that minimize loss of fiber to “dust” in subsequent processing. The thickness may be determined by any suitable method, for example ASTM D2591-07(2020).

The end-linked sPUUs described herein and fibers prepared from them may have a variety of characteristics and properties that are distinctive. By way of example, the protected polymers (protected sPUU polymers, vii) incorporated into end-linked sPUUs may have characteristics including Mn, Mw, Mz, polydispersity, soft segment glass transition temperature (SSTg), soft segment midpoint of the melting range (SSTm), soft segment enthalpy of fusion SSΔH (sometimes denoted ΔHf), and the midpoint of the hard segment melting range (HSTm) that are unique.

The protected sPUU polymers (vii) incorporated into end-linked sPUUs provided for in the present disclosure may have, for example, a number average molecular weight (Mn) in a range of about 25,000 Da to about 75,000 Da, or from about 29,000 Da to about 73,000 Da as measured by GPC) They also may have an Mn in a range of about 25,000 Da to about 35,000 Da, or from about 35,000 Da to about 55,000 Da. They also may have an Mn in a range of about 55,000 Da to about 65,000 Da, or from about 65,000 Da to about 75,000 Da. They also may have an Mn in a range of about 50,000 Da to about 75,000 Da, or from about 50,000 Da to about 70,000 Da.

The protected sPUU polymers (vii) incorporated into end-linked sPUUs provided for in the present disclosure may have, for example, an average molecular weight (Mz) in a range of about 170,000 Da to about 650,000 Da, or from about 175,000 Da to about 635,000 Da as measured by GPC. They may have a Mz in a range of about 170,000 Da to about 250,000 Da or from about 250,000 Da to about 350,000 Da. They may have a Mz in a range of about 190,000 Da to about 240,000 Da or from about 240,000 Da to about 340,000 Da. They may have a Mz in a range of about 340,000 Da to about 440,000 Da or from about 440,000 Da to about 530,000 Da. They may have a Mz in a range of about 350,000 Da to about 550,000 Da, or from about 550,000 Da to about 650,000 Da. They also may have a Mz in a range of about 400,000 Da to about 650,000 Da or from about 500,000 Da to about 635,000 Da.

The protected sPUU polymers (vii) incorporated into end-linked sPUUs provided for in the present disclosure may have, for example, a weight average molecular weight (Mw) in a range of about 100,000 Da to about 350,000 Da, or from about 200,000 Da to about 350,000 Da as measured by GPC. They may have a Mw in a range of about 100,000 Da to about 150,000 Da or from about 150,000 Da to about 200,000 Da. They may have a Mw in a range of about 200,000 Da to about 350,000 Da or from about 250,000 Da to about 350,000 Da. The protected sPUU polymers (vii) incorporated into end-linked sPUUs may have a Mw in a range of about 100,000 Da to about 125,000 Da or in the range of about 125,000 Da to about 200.00 Da. The protected sPUU polymers (vii) incorporated into end-linked sPUUs may have a Mw in a range of about 200,000 Da to about 250,000 Da, or from about 250,000 Da to about 300,000 Da. The protected sPUU polymers (vii) incorporated into end-linked sPUUs may have a Mw in a range of about 230,000 Da to about 270,000 Da, or from about 270,000 Da to about 300,000 Da. The protected sPUU polymers (vii) incorporated into end-linked sPUUs may have a Mw in a range of about 300,000 Da to about 325,000 Da, or from about 325,000 Da to about 350,000 Da. The protected sPUU polymers (vii) incorporated into end-linked sPUUs may also have a Mw in a range of about 80,000 Da to about 100,000 Da, or from about 100,000 Da to about 120,000 Da as measured by GPC.

To determine Mz, Mw, and/or Mn, GPC may be performed on a liquid chromatography system equipped with a UV detector (or alternatively a light scattering detector, or a refractive index detector) and a suitable gel permeation matrix. Unless stated otherwise the GPC method utilizes an HPLC (Agilent 1100 series chromatography system) with an isocratic solvent pump and a UV/visible detector (e.g., a diode array detector). Chromatography is carried out on two modified styrene-divinyl benzene GPC columns (e.g., I-MBHMW-3078, 300 mm×7.8 mm columns, Malvern Panalytical) placed in series to perform the analytical separation. The columns are protected by an upstream guard filter having a 2 μm stainless steel frit (Upchurch Scientific) placed in-line. Chromatography may be conducted using dimethylacetamide (DMAc) with LiCl at 0.1% wt at a flow rate of 1 ml/minute with the columns held at 60 °C. Poly(styrene) standards may be utilized to calibrate the chromatography system. Detection is typically conducted at 280 nm using a UV detector when a UV chromophore (e.g., an aromatic ring) is present, however, in the absence of a suitable chromophore a refractive index or light scattering detector may be employed. Mz, Mw, and/or Mn analysis may be conducted using ChemStation software (Rev. A.10.02, Agilent), which controls the GPC system and acquires data with molecular weight information processed and calculated in its GPC Data Analysis module (Rev. A.02.02, Agilent). Values given in this disclosure represent the peak value observed by GPC. Where a chromatogram has more than one peak, the size is taken to be that of the peak with maximum intensity. Calibration of the chromatography system is based on monodispersed polystyrene standards (Agilent) and further optimized with a single, ‘broad’ standard sample that is more similar to polyurethane ureas. The broad standard is a permanently terminated polymer that is produced using n-butyl amine as a terminator and which has Mw and Mn values previously determined to be 104,000 and 33,000 g/mol, respectively. For chromatographic analysis, approximately 5 mg of the polymer is dissolved in approximately 1 mL of DMAc with LiCl at 0.1% wt. Samples are shaken for a minimum of 2 hours on a laboratory shaker to ensure total dissolution of the polymer sample. Samples that are difficult to dissolve may require higher levels of LiCl (up to 2% by weight) and/or up to 48 hours of shaking. The broad standard is similarly treated to ensure dissolution.

The protected sPUU polymers (vii) incorporated into end-linked sPUU provided for in the present disclosure may have, for example, a polydispersity index (Mw/Mn) of about 2.2 to about 3.0 or from about 3.0 to about 3.5. The polydispersity index may also be in a range of, for example, about 3.5 to about 4.0 or from about 4.0 to about 4.5. The polydispersity index may also be in a range of, for example, about 4.5 to about 5.0 or from about 5.0 to about 5.5. The polydispersity index may also be in a range of, for example, about 5.5 to about 6.0 or from about 6.0 to about 6.5. The polydispersity index may also be in a range of, for example, about 6.5 to about 7.0 or from about 7.0 to about 7.5

Values of the soft segment glass transition temperature (SSTg), soft segment midpoint of the melting range (SSTm), soft segment enthalpy of fusion SSΔH, and midpoint of the hard segment melting range (HSTm) are determined by differential scanning calorimetry (DSC). Unless stated otherwise, glass transition temperatures (Tg and SSTg), SSTg, SSTm, SSΔH, and HSTm may be determined consistent with ASTM D3418-21. Where glass transition temperatures, including SSTg, are not readily discernable using DSC per ASTM-3418-21, the glass transition temperature may be assessed consistent with ASTM E1356-2025 (ASTM E1356-25) which will be the accepted value.

The SSTg of the end-linked sPUU polymers described herein may be, for example, less than about −70 °C or less than about −60 °C. Nonlimiting examples of SSTg temperature ranges include from about −60 °C to about −66 °C or from about −6 °C to about −70 °C. Other SSTg ranges include from about −64 °C to about −68 °C or from about −68 °C to about −75 °C.

The SSTm of the end-linked sPUU polymers described herein may be, for example, less than about 6 °C or less than about 4 °C. Nonlimiting examples of SSTm ranges include from about −1.5 °C to about −1 °C, or from about −1 °C to about 0 °C. Other SSTm ranges include from about 0 °C to about 3 °C or from about 3 °C to about 6 °C.

The SSΔH of the end-linked sPUU polymers described herein may be, for example, in the range of about 16 to about 28 Joules/g (J/g), or from about 17 to about 27 J/g. Other SSΔH ranges include from about 16 to about 18 J/g, or from about 18 to about 20 J/g. Other SSΔH ranges include from about 17.5 to about 22.5 J/g, or from about 22.5 to about 27 J/g.

The HSTm of the end-linked sPUU polymers described herein may be, for example, in the range of about 275 °C to about 300 °C, or from about 278 °C to about 297 °C. Other SSTm ranges include from about 278 °C to about 286 °C or from about 286 °C to about 296 °C.

The end-linked sPUUs described herein, and fibers prepared from them, may have shrinkage, elasticity, elongation at break and solubility in organic solvents that serve to define the polymers.

Fibers of end-linked sPUUs described herein typically have an excellent elongation at break, for instance as measured with the general method of ASTM D2731-21. For example, fibers of the end-linked sPUUs described herein may have an elongation at break of at least 300%, or at least 400%. Fibers of the end-linked sPUUs described herein may have an elongation at break of at least 500%, or at least 600%. Fibers of the end-linked sPUUs described herein may have an elongation at break of at least 700%, or at least 800%. The elongation at break of end-linked sPUUs may also be described by way of ranges, such as from about 300% to about 500% or from about 400% to about 600%. Alternatively, the ranges for elongation at break may be from about 500% to about 700% or from about 700% to about 800%.

End-linked sPUU polymers of the present disclosure may be used to produce cloth with low set, high elongation and flat stretch/recovery. Set percent measures the permanent deformation an elastomer retains after being subjected to stress (compression or elongation) and then released. As used herein “low set” means a set percentage less than about 20%, more preferably less than about 16%. “High elongation” as used herein means an elongation greater than about 500%. “Flat stretch/recovery” as used herein means flatness index of stretch and recovery of the spandex, determined by the ratio of 5TM100/5TP300, which is the ratio of the recovery power or unload power at 100% extension to the stretch power or load power at 300% extension measured in the fifth 0-300% stretch/recovery cycle. Fibers prepared via compositions and methods of the present invention exhibit a 5TM100/5TP300 ratio of greater than 0.09 in general.

As indicated above, strength and elastic properties of the end-linked sPUU fibers are measured in accordance with the general method of ASTM D 2731-21. Three samples of each fiber approximately 100 mm in length were used for each measurement. Samples are kept in a controlled environment at 21+/−1.1 °C (700+/−2 °F) and a relative humidity of 65%±2% for 24 hours (hrs)+/−4 hrs prior to testing under the same conditions of temperature and humidity. Samples are subject to four 0-300% elongation cycles for each of the measurements, with each cycle comprising (i) elongation rate of 50 centimeters per minute (cm/min), and (ii) relaxation to 0% extension at 50 cm/min. Load power 1TP200 is the stress on the spandex during initial extension, and is measured on the first cycle at 200% and load power 5TP300 is the stress on the end-linked sPUU during the fifth extension at 50 cm/min to 300%; measurements are made after an 18 second stress decay, and are reported as gram-force for a given decitex (e.g., dtex in g/10,000 meters). Unload power of 5TM100 and 5TM200 are the stress at an extension of 100% and 200%, respectively, for the fifth unload cycle (unloading is conducted at a rate of 50 cm/min) is also reported in gram-force. Percent elongation at break is measured on a sixth extension cycle. Tests are conducted on an Instron model 5500 or model 5965. Equipment is calibrated and certified yearly by Instron (ASTM E4-Load cell verifications; ASTM E2309-Displacement verifications; ASTM E2658-Speed verifications).

Percent set is measured on samples that have been subjected to five 0-300% elongation/relaxation cycles. The percent set, SET %, is then calculated as SET %=100×(Lf−Lo)/Lo where Lo and Lf are the fiber length when held straight without tension before (originally) and after the five elongation/relaxation cycles, respectively. End-linked sPUUs described herein may have, for example, a SET % of less than about 30% or less than about 25%. End-linked sPUUs described herein may also have a SET % of less than about 23% or less than about 21%.

Unless stated otherwise, viscosity of polymer solutions is measured using a Brookfield RV Viscometer (Model DV2T) equipped with an SC4-27 spindle, and a small sample adaptor with a water jacket for polymer solution viscosity measurement. The temperature is controlled at 40 °C. During measurement a rotation speed that keeps the torque in a range of 30% to 50% is employed.

The end-linked sPUUs described herein by themselves generally are not electrically conductive and may be used to prepare a variety of insulating materials. Dielectric materials generally refers to insulating materials that are poor conductors of electricity but that can become polarized in an electromagnetic field. The dielectric constant or relative permittivity (E or D/K), which characterizes a material's ability to store electrostatic energy in an applied electric field, is a dimensionless value (the ratio of the permittivity of a material relative to a vacuum (where the E of a vacuum is 1.0). Importantly, end-linked sPUUs of the present disclosure can act as dielectric materials that do not comprise fluorinated polymers but are suitable for replacement of traditional fluorinated polymers such as PVDF in many electronic applications requiring dielectric materials, such as capacitors.

End-linked sPUUs of the present disclosure generally act as non-electrically conductive materials as described above and may be used as electrical insulating components. The conductivity, however, may be substantively modified by the addition of one or more electrically conductive additives (conductive materials) described above to form a doped end-linked sPUU. Conductivity will vary based upon factors including the end-linked sPUU, the added materials, the concentration of added materials, and the temperature. The end-linked sPUUs described herein may have a conductivity of about 10⁻⁶ Siemens per meter (S/m) to about 10⁻⁸ S/m or about 10⁻⁸ S/m to about 10⁻¹⁰ S/m. The end-linked sPUUs described herein may also have a conductivity of about 10⁻¹⁰ S/m to about 10⁻¹² S/m or about 10⁻¹² S/m to about 10⁻¹⁵ S/m. When doped with conductive materials, the conductivity of the end-linked sPUUs may be substantially increased depending upon the additive, the amount combined with the end-linked sPUU, the temperature, and a variety of other factors. For example, the end-linked sPUUs described herein doped with one or more conductive materials may have a conductivity at 20 °C of about 10⁻⁶ S/m to about 10⁻³ S/m or about 10⁻³ S/m to about 1 S/m. Ranges for the conductivity of end-linked sPUUs described herein doped with one or more conductive materials at 20 °C include about 1 S/m to about 10² S/m or about 10² S/m to about 104 S/m. Other ranges for the conductivity end-linked sPUUs described herein doped with one or more conductive materials at 20 °C include about 10⁻⁶ S/m to about 10⁻³ S/m or about 10⁻³ S/m to about 105 S/m. In cases where a high percentage of highly conductive doping material is utilized, the doped end-linked sPUUs described herein may have a conductivity at 20 °C of about 103 S/m to about 10⁶ S/m. With low percentages of end-linked sPUU binder (e.g., less than 10%) and a substantial load of highly conductive material (e.g., 90% metal powder such as copper), conductivities of the doped end-linked sPUUs may be even higher, approaching that of tin (9×10⁶ S/m) or iron (1×10⁷ S/m) at 20 °C.

Where conduction of current is important, it is desirable for the end-linked sPUUs described herein to adhere to other conductive components of an article (e.g., metal components such as current collectors of cathodes or anodes of electrochemical cells) including but not limited to the cathodes of batteries such as lithium-ion batteries. The end-linked sPUUs described herein may have peel strength from, for example, about 3 to about 85 Newtons per meter (N/m) tested using ASTM D3330/D3330M-04 (2018), depending upon the specific end-linked sPUU and the conductive substrate it is being contacted with.

End-linked sPUUs resist degradation and swelling by solvents find use under conditions where otherwise identical sPUUs that have been subject to chain termination rather than end-linking or crosslinking find service. The end-linked sPUUs described herein resist dissolution or dispersion, or are insoluble in 1-butylpyrrolidin-2-one (NBP), N-methyl-2-pyrrolidone (NMP), and dimethylformamide (DMF). Other solvents for the dissolution or dispersion of the sPUUs include, but are not limited to, 2-Methyltetrahydrofuran (2-MeTHF), and N,N-Dimethyl-1,3-dioxolane-4-methanol. N,N-dimethylacetamide (DMAc) may also be used as a solvent.

The end-linked sPUUs described herein can display resistance to degradation by solvents comprising one or more of lithium hexafluorophosphate, lithium tetrafluoroborate, lithium perchlorate, and combinations thereof that are used in many electrochemical cells. The end-linked sPUUs described herein are also resistant to degradation by one or more solvents used as electrolytes in other primary and/or secondary cell batteries described herein below. The resistance of the end-linked sPUUs described herein to degradation, softening, and/or swelling in solvents, such as carbonate solvents frequently used in the electrolyte of lithium-ion batteries, makes them suitable for a variety of applications in the Li-ion battery field, including but not limited to binders for cathodes/anodes, insulators (e.g., at the edges of electrodes), and battery casing components.

### XXI. Forming of Articles Comprising sPUUs

This disclosure provides for articles comprising end-linked sPUUs prepared by any of the methods known in the art. Because the end-linked sPUUs are formed in a reaction (crosslinking to the ends of the polymer), the methods of forming typically take advantage of the heating involved in deblocking the isocyanate groups as part of the shaping. Accordingly, known methods including, but not limited to, spinning, molding (e.g., extrusion molding), blowing (solution blow molding), injection molding, compression molding (e.g., sintering pelleted or powdered forms of sPUUs), casting (e.g., from solvent solubilized sPUUs), spray or curtain coating, spin coating, machining, foaming, and the like. can be used with heating to cause the end-linking reaction and formation of the final article. By way of example, solution blowing, injection molding, and compression molding, can all be conducted using heated molds that will trigger deblocking and end-linked sPUU formation. Similarly, spray, curtain, and spin coating can be conducted on articles preheated to a temperature that will result in deblocking of isocyanates and cause the end-linking reaction to occur. Foaming and spinning into fibers can be conducted by heating the composition above the deblocking temperature immediately before spinning fiber or expanding the composition into a foam. Additionally, formation of sheets, such as using a Mayer rod or other means to spread composition comprising the crosslinking agent and protected prepolymers (v) or protected polymers (vii) on to a surface that is then heated, may similarly be conducted.

Where two or more blocking agents are employed they may be selected to have deblocking temperatures within 5 °C or 10 °C of each other or more than 10 °C apart. It is possible to form the end-linked sPUU polymer into an article using a first reaction that deblocks a first blocking agent, thus reconstituting a portion of the isocyanates that can react with the crosslinking agent, and shape or reshape the article; and then complete the crosslinking by a second reaction conducted at a higher temperature that releases a second blocking agent from the remaining isocyanates. In such a two-step process the two or more blocking agents may have deblocking temperatures greater than 10 °C apart or greater than 15 °C apart, optionally with both blocking agents having deblocking temperatures greater than the boiling point of any solvent(s) present. Alternatively, the difference in the deblocking temperatures between the first and second blocking agents may be greater than 20 °C apart or greater than 25 °C apart. Shaping of the end-linked sPUU into an article in such staged end-linking may be conducted at any one or more points in the process, such as concurrent with the first reaction, between the first and second reaction, or during the second reaction (curing reaction).

As mentioned above, where two or more blocking agents with different deblocking temperatures (a lower and a higher deblocking temperature) are employed when making protected prepolymers (v) or protected polymers (vii), the polymerization and shaping may be conducted using heating at two or more different levels. In an initial phase the temperature may be elevated to a point that causes some or all (e.g., more than 50%) of the blocking agent with a lower deblocking temperature to be released. Depending on the amount of blocked isocyanate groups present and the ratio of blocking agents with lower and higher deblocking temperatures, heating to the lower deblocking temperature may result in a spectrum of intermediate states from a flowable material with increased viscosity, through a semisolid material (e.g., a formable gel or paste), to making an incompletely cured solid. All of those intermediate states may be used in subsequent forming processes. The increased viscosity flowable materials may be used to coat articles where the increased viscosity permits the coating to remain in place (e.g., without running etc.) until heating to a final cure of the end-linked sPUU. The semisolid materials and incompletely cured solids can be molded or reshaped to define or refine their shape. Subsequent heating to a temperature for a period of time at which the deblocking agent with the higher deblocking temperature releases the majority (e.g., at least 90% or at least 95%) of the remaining isocyanates permits curing of the material into an article of the desired shape.

A period of final curing at a temperature that causes deblocking of most (e.g., more than 95% or more than 98%) of the blocking agent in a formed article to be released may follow any forming process regardless of whether the process was conducted using a blocking agent activated at a single temperature or two or more blocking agents that are activated at different temperatures.

The end-linked sPUUs of the present disclosure may be formed into fibers by spinning (e.g., dry spun, or wet spun). Those fibers not only may be used as a source of the end-linked sPUUs but may be incorporated into other articles. Where the fibers are incompletely cured (e.g., they are made with two blocking agents and the higher temperature deblocking agent has not been activated), the fibers may be shaped into an article or part of a reinforcing fiber network, and then subsequently fully cured. The fibers themselves can be an article (a staple fiber) or be incorporated into an article. Such fibers may be formed into fill or spun into thread or yarn. Cloth may be formed with the spun fiber, for example, by felting into unwoven cloth, or by weaving thread or yarn to form a woven cloth. Fibers comprising the end-linked sPUU polymers, compositions comprising the disclosed end-linked sPUU polymers, and articles of manufacture comprising the end-linked sPUUs (e.g., in fiber form) are included within the scope of this disclosure. Nonlimiting examples of such articles of manufacture of the present invention include fabrics (woven and nonwoven) and garments. In one nonlimiting embodiment, the fabrics and garments are for apparel and/or hygiene applications. In another nonlimiting embodiment, the fibers are incorporated into a “smart textile” that can be used to sense environmental conditions including, but not limited to, perceiving biometrics (e.g., vital signs) and/or biomechanics of an individual wearing garments or equipment comprising the smart textile. Smart textiles may be in the form of, for example, spun, woven, and/or braided fibers or composite yarns. Electrically conductive end-linked sPUUs are of particular use in smart textiles.

The linear density of the yarns useful in some aspects can range from about 15 denier (D) (16.5 dtex) to about 450D, including from about 15 D to about 300 D (330 dtex), including from about 30 D to about 100 D (33 dtex to 110 dtex) for apparel uses. Heavier denier, such as greater than 450 D, may be useful to achieve other properties. Historically, higher deniers such as 500-1,200 D may be preferred for hygiene end use. The linear denier may also be from about 1,200 to about 1,600 or from about 1,600 to about 2,000 D.

The end-linked sPUUs described herein may also be used as “potting compounds” to seal and/or insulate fragile and sensitive microelectronic components. Additionally, the end-linked sPUUs may provide dielectric properties, as well as high resistance to water, chemicals, temperature fluctuation, and potentially destructive physical contact. The end-linked sPUUs described herein find use as binders used in electrochemical cells including lithium-ion batteries where they find particular use as binders in the preparation of cathodes. The end-linked sPUUs may also provide impact resistance to electronic and other articles or assemblies (e.g., electronic assemblies) due to their elastic nature.

### XXII. Preparing and Forming Electrochemical Cells and Their Components—Anodes and/or Cathodes

An aspect of the present disclosure is directed to the formation of anodes and/or cathodes of electrochemical cells. The electrochemical cells may be primary cells (batteries) or secondary cells (rechargeable batteries). They may also be, for example, a sacrifice anode used in galvanic protection or electroplating. Electrodes comprising the end-linked sPUUs of the present disclosure as binders, such as the cathodes of metal ion batteries (e.g., lithium-ion secondary cells), are generally formed on current collectors that function as electrically conductive material that permits electrons to move in or out of the cell. Preferably the composition comprising one or more end-linked sPUU polymers used in forming the electrode will adhere to the current collector. Adhesion to the current collector (e.g., typically an aluminum sheet in lithium-ion battery cathodes) preferably results from interaction with the end-linked sPUUs, but may be enhanced by additives, such as HNBR.

The present disclosure includes and provides for a method of preparing a cathode of a battery (a primary or secondary cell) comprising one or more end-linked sPUU polymers as a binder for the cathode active material, the method comprising:
(i) providing a composition (e.g., a slurry) comprising
   a) cathode active material and either
      A) a protected prepolymer (see FIG. 1B, (v)) having one or more blocking agents as protecting groups, a chain extender (vi), and one or more crosslinking agents (viii)
      or
      B) a protected polymer (see FIG. 1B, (vii)) having one or more blocking agents as protecting groups, and one or more crosslinking agents (viii) and
   b) solvent as necessary or desirable (e.g., to dissolve the protected polymer or protected prepolymer);
(ii) coating all or part of a substrate with the composition (e.g., coating one side of a current collector such as an aluminum sheet); and
(iii) heating to a temperature above the deblocking temperature of the one or more blocking agent(s) of the protected prepolymer or the protected polymer to cause the end-linked sPUU formation;
wherein
   the composition optionally comprises a dispersant (such as HNBR) and/or one or more electrically conductive additive(s), and
   the method optionally comprises the removal of solvent(s) after coating either before or concurrent with heating to cause the end-linking.

The method includes and provides for the addition of other additives as part of the protected prepolymer, protected polymer, or the composition along with the cathode active material and crosslinking agent(s).

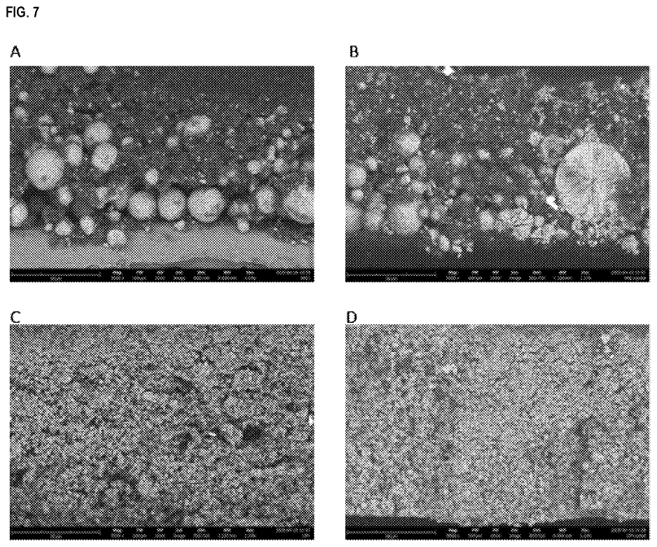

A scanning electron micrograph (SEM) of a cross-section through a battery cathode comprising an aluminum current collector and NMC particles as the cathode active material in a matrix of end-linked sPUU polymer before (pristine) and after repeated charge and discharge cycles (cycled) is provided in FIG. 7 at A and B, respectively.

An SEM of a cross-section through a battery cathode comprising an aluminum current collector and LFP particles as the cathode active material in a matrix of end-linked sPUU polymer before (pristine) and after repeated charge and discharge cycles (cycled) is provided in FIG. 7 at C and D, respectively.

Heating the coating applied to the substrate may be conducted in a single step that results in the end-linkage formation to form a solid and to drive off any solvent if necessary or desired. Heating the coating may take place gradually or in a stepped fashion. Where the composition is made with protected prepolymer or protected polymer that incorporates two or more blocking agents that have lower and higher deblocking temperatures, heating the coating to a temperature that deblocks the lower temperature blocking agent may be followed by heating to a temperature that deblocks the higher temperature blocking agent. Heating gradually or in a stepwise fashion allows most or all of any solvent present to be evaporated from the composition. Solvent(s) may be selected to evaporate at or below the lowest deblocking temperature.

The cathode may be the cathode of a lithium-ion battery. The current collector may comprise any suitable metal including aluminum or nickel. The current collector may be in the form of a foamed metal such as aluminum foam or nickel foam. Alternatively, the current collector may comprise a metal sheet or layer applied on the surface of another material (e.g., vapor phase deposited aluminum on polymer). The current collector also may comprise an electrically conductive polymer, or a form of carbon or a carbonaceous material that is suitably conductive. The current collector also may comprise an electrically conductive polymer, or a form of carbon or a carbonaceous material that is suitably conductive.

In methods of preparing a cathode, the electrically conductive additive(s), when present, may be selected from one or more metallic and/or one or more non-metallic materials. The one or more electrically conductive additive(s) may be carbonaceous electrically conductive materials. Carbonaceous electrically conductive materials may be selected from those described hereinabove.

The composition used to form the cathode comprises a solvent, and may be a slurry or solution, where the solvent is selected for its ability to dissolve any dispersant (e.g., HNBR) that may be employed as well as the protected prepolymer (v) or protected polymer (vii). Some suitable solvents are or comprise, but are not limited to, dimethyl formamide (DMF), 1-butylpyrrolidin-2-one (NBP), N-methyl-2-pyrrolidone (NMP), and combinations thereof. The compositions used to prepare end-linked sPUUs of the present disclosure offer several advantages over typical fluorinated polymer (e.g., PVDF) slurries used in battery formation that are prepared in solvents such as NMP. In contrast with the fluorinated polymers, the non-fluorinated protected prepolymers and nonfluorinated protected polymers used to form end-linked sPUUs are highly soluble in solvents such as NMP.

The solubility of the protected prepolymers (v) or the protected polymers (vii) described herein in diverse organic solvents, including NMP, allows their use in the formation of solutions or slurries to prepare electronic materials, including the electrodes of electrochemical cells, under conditions that are problematic for PVDF and similar fluorinate polymers. Unlike PVDF, which can gel or separate from solvents including NMP when exposed to moisture or water, the protected prepolymers (v) or the protected polymers (vii) used to prepare end-linked sPUUs are soluble at a concentration of 5% and even up to about 10% (on a weight basis) in NMP. In addition, upon exposure to air PVDF and related fluorinated polymers used to prepare compositions high in nickel (e.g., cathodes with high-nickel NMC cathode active materials) can undergo dehydrofluorination and crosslinking, causing the slurry to gel over time. The non-fluorinated materials described herein do not suffer from that complication. Additionally, gel formation by fluorinated polymers can cause particles suspended in dissolved polymer solutions/suspensions to agglomerate, thereby forming lumps or blisters in the slurry that can prohibit forming uniform coatings (e.g., on a cathode current collector). The compositions comprising the components of end-linked sPUUs for preparing electrodes (e.g., cathodes of Li-ion batteries) are an improvement over compositions relying on fluorinated polymers such as PVDF. Accordingly, the protected prepolymer(s) (v), chain extender(s) (vi), and crosslinking agent(s) (viii) (see, e.g., FIG. 1B route A), or the protected polymer(s) (vii) and crosslinking agent(s) (viii) (see, e.g., FIG. 1B route B), used to prepare end-linked sPUUs, can be used in compositions that include one or more solvent(s) for the preparation of electrodes. Such compositions may comprise, for example: about 40% to about 65% of an electrode active material (e.g., a cathode active material such as NMC), about 30% to about 55% of solvent (e.g., NMP), about 2% to about 6% of either the protected prepolymer(s) (v), chain extender(s) (vi), and crosslinking agent(s) (viii), or the protected polymer(s) (vii) and crosslinking agent(s) (viii), and about 1% to about 5% of a conductive material (e.g., carbon black). Use of high levels of the end-linked polymer forming materials may result in sufficiently high viscosities to require either limiting the amount of solids suspended, increasing the amount of solvent, or altering the methods of spreading the composition (e.g., use of successive Mayer rods to spread the composition and form uniform coatings).

By way of example either the protected prepolymer(s) (v), chain extender(s) (vi), and crosslinking agent(s) (viii) (see, e.g., FIG. 1B route A), or the protected polymer(s) (vii) and crosslinking agent(s) (viii) (see, e.g., FIG. 1B route B) that will form an end-linked sPUU polymer and act as a binder for the cathode active material may be present in compositions for preparing a cathode, or in the cathode, in a total amount from about 0.1 to about 3 wt %, or from about 1 to about 2 wt %, of the cathode's final weight (excluding the weight of solvent present in the composition). Those components (as the end-linked sPUU) may be present in a total amount from about 0.2 to about 6 wt %, such as from about 0.2 to about 4 wt % of the cathode's final weight (in the absence of solvent). Alternatively, those components (as the end-linked sPUU) may be present in a total amount from about 0.2 to about 1.5 wt %, such as from about 0.3 to about 1.2 wt %, of the cathode's final weight (in the absence of solvent).

The protected prepolymer (v), chain extender (vi), and crosslinker (viii), or the protected polymer (vii) and crosslinker (viii) that will form an end-linked sPUU polymer and act as a binder for the cathode active material may be present in compositions for preparing a cathode, or in the cathode, in a total amount from about 0.1 to about 3 wt %, or from about 1 to about 2 wt %, of the cathode's final weight (excluding solvent and any support/current collector). Those components (as the end-linked sPUU) may be present in a total amount from about 0.2 to about 6 wt %, such as from about 0.2 to about 4 wt % of the cathode's final weight (excluding solvent and any support/current collector). Alternatively, those components (as the end-linked sPUU) may be present in a total amount from about 0.2 to about 1.5 wt %, such as from about 0.3 to about 1.2 wt %, of the cathode's final weight (excluding solvent and any support/current collector).

Cathode active materials are often present in compositions for preparing a cathode, or in the cathode, from about 85% to about 99.8 wt % or about 90% to about 99.8 wt % (excluding any solvent and/or any support/current collector), with the remainder of the weight comprising end-linked sPUU binder. Cathode active materials are often present in compositions for preparing a cathode, or in the cathode, from about 94 to about 99.8 wt %, such as from about 96 to about 99.8 wt % (excluding any solvent and/or any support/current collector). They may also be present from about 97 wt % to about 99.6 wt %, such as from about 97.6 to about 99.4 wt % (excluding any solvent and/or any support/current collector). The weight of additives (e.g., dispersants, antioxidants, lubricants, and other components) and/or electrically conductive materials present in compositions that will act as a binder may be considered part of the weight of the end-linked sPUU polymer forming materials when calculating weight percentages of the binder and cathode active materials.

The cathode may be, for example, a NMC-, LFP-, NMCA-, LMNO-, or LMO-cathode. The cathode may also be a NMC- or LFP-cathode. In an embodiment, the cathode is a NMC-cathode.

The cathode may have a surface layer comprising a thin layer comprising an inert material selected from the group consisting of Al, B, Cu, Al₂O₃, TiO₂, ZnO, LiF, La₂O₃, NbO₂, ZrO₂, Li₂O, HfO₂, GaO₂, GeO₂, CeO₂, MgO, CaO, AlF₃, LiAlF₄, MgF₂, Zn₂OF₂, LbFO, LiCFs, LbN, TiN, Li₂CO₃, CaCO₃, ZnCO₃, La₂(CO₃)₃, Nb(CO₃)₂, MgCO₃, Li₂S, ZnS, GaS₂, TiS₂, NbS₂, HfS₂, CaS, La₂S₃, BaSO₄, Li₃PO₄, AlPO₄, WF₄, W(PO₄)₂, SiO₂, SiC, Si, carbon or mixtures of any two or more thereof. In some embodiments, the inert material comprises a hafnium oxide, lithium hafnium oxide, lithium fluoride-lithium carbonate composite, or composite materials containing LiF, La₂O₃, NbO₂, ZrO₂, Li₂O, GaO₂, GeO₂, CeO₂, MgO, CaO, AlF₃, LiAlF₄, MgF₂, Zn₂OF₂, Li₃FO, LiCFs, LbN, TiN, Li₂CO₃, CaCO₃, ZnCO₃, La₂(CO₃)₃, Nb(CO₃)₂, MgCO₃, Li₂S, ZnS, GaS₂, TiS₂, NbS₂, HfS₂, CaS, La₂S3, BaSO₄, Li₃PO₄, AlPO₄, WF₄, W(PO₄)₂, lithium niobium oxides, lithium hafnium oxides, lithium lanthanum oxides, lithium silicon oxide, or lithium aluminum phosphate, or mixtures thereof.

### XXIII. Electrochemical Cells/Batteries

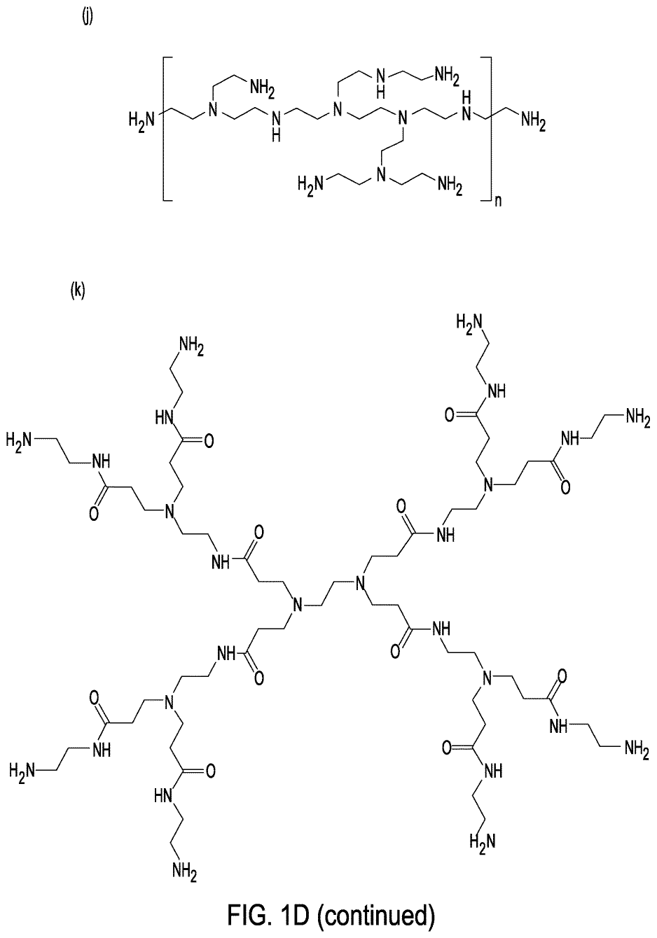

The present disclosure includes and provides for electrochemical cells. Those electrochemical cells include both primary and secondary cells (batteries), comprising one or more anode(s), one or more cathode(s), and an electrolyte. The cells optionally comprise a separator between the one or more anodes and one or more cathodes to prevent contact that could reduce or short out the battery's electrical output (current and/or voltage). At least one of the one or more cathode(s) and/or one or more anode(s) of the battery may have a binder that comprises an end-linked sPUU polymer described herein. The electrochemical cells (e.g., batteries) may have one or more cathode(s) comprising a binder that is comprised of one or more sPUU polymers described herein, which can display elastomeric behavior. The end-linked sPUUs used as a binder in the anode(s) and/or cathode(s) of the batteries optionally comprise an electrically conductive material. The end-linked sPUUs may be incorporated into the electrode as a binder intercalated between electrode (e.g., cathode) active materials creating a solid electrode (e.g. on the surface of a current collector as shown in FIG. 2, for example, or in the form of a woven or nonwoven article (e.g., sheet). In addition to acting as a binder for materials at the cathode and/or anode, the end-linked sPUUs described herein may be formed into other battery components including an insulating edge on electrodes (see, e.g., FIG. 2). The elastomeric and solvent resistant properties of the end-linked sPUUs also permit them to be used as, for example, padding or impact absorption materials, between or around other articles including battery cells. Foams of end-linked sPUUs, prepared with either open or closed cells, may find particular use in electrodes of electrochemical cells (such as rechargeable batteries) or in supporting and padding components of such electrochemical cells.

The electrolyte used in the electrochemical cells (e.g., secondary cells) will typically be a liquid electrolyte. Where the electrochemical cell is a lithium-ion battery, the electrolyte may comprise at least one lithium salt and at least one solvent. Solvents may be selected from carbonate solvents and fluorinated carbonate solvents. Carbonate solvents also may be cyclic carbonates such as ethylene carbonate (EC) or propylene carbonate (PC). By way of example, lithium salts may be dissolved in carbonate solvent, comprising ethylene carbonate (EC) and/or dimethyl carbonate (DMC). Solvents may be selected from diC1-4 ethers (such as their nonfluorinated or fluorinated equivalents) and ionic liquids. Alternatively, the electrolyte may comprise at least one lithium salt and an ionic liquid.

In an aspect of the invention, the solvent is selected from the group consisting of 1,2-dimethoxyethane (DME), N-propyl-N-methylpyrrolidinium bis(fluorosulfonyl)imide (PYR13-FSI), N-propyl-N— methylpyrrolidinium bis(trifluoromethanesulfonyl)imide (PYR13-TFSI), 1-butyl-1-methylpyrrolidinium bis(fluorosulfonyl)imide (PYR14-FSI), 1-butyl-1-methylpyrrolidinium bis(trifluoromethanesulfonyl)imide (PYR14-TFSI), 1-ethyl-3-30 methylimidazolium bis(fluorosulfonyl)imide (EMIM-FSI), 1-ethyl-3-methylimidazolium bis(trifluoromethanesulfonyl)imide (EMIM-TFSI). The solvent comprises one or more of DMC, ethyl methyl carbonate (EMC), diethylcarbonate (DEC), EC, and PC, and their fluorinated equivalents.

An electrochemical cell such as a lithium-ion battery may comprise an above-mentioned cathode active material. In one embodiment, the electrochemical cell is a lithium-ion battery (e.g. a lithium-ion secondary cell) comprising a NMC cathode.

As discussed above, the cathode and/or anode of the electrochemical cells (e.g., batteries) described herein may comprise a current collector. The current collector may be metallic and selected independently for the cathode and anode of the cell.

Current collectors for the cathode (negative electrode of a galvanic cell) may comprise, for example, copper, stainless steel, titanium, silver, palladium, nickel, alloys thereof and combinations thereof. When stainless steel is employed, it may be surface treated with carbon, nickel, titanium or silver. Aluminum or aluminum-cadmium alloy can also be used as the cathode current collector. Indeed, cathodes may comprise particles of a cathode active material in an end-linked sPUU binder formed upon a current collector (e.g., an aluminum foil or a layer of aluminum on a polymer backing). Conductive non-metallic materials may also be used as a current collector and as a substrate for preparing a cathode.

The anode may comprise a carbonaceous material such as one or more of carbon black, graphite, graphene, activated carbon, carbon fiber, etc. In an embodiment, a metallic fiber such as a metal mesh, etc., a metallic powder such as copper, silver, nickel, aluminum, etc., or an organic conductive material such as a polyphenylene derivative, etc., also may be used. The conductive material may be used as a current collector in the anode. For alkali-metal batteries such as lithium-ion batteries, the anode current collector may be comprised of copper, including for example, copper foil or copper mesh. Non-metallic materials including carbonaceous materials and/or polymers treated or combined with an electrically conductive material, such as a conductive polymer, may also serve as the current collector.

Separators may comprise and be prepared from polyolefin-based polymers or an end-linked sPUU of the present disclosure. Separators may be porous (e.g., a porous polymer film) such as a matrix of porous end-linked sPUUs of the present disclosure or porous polyolefin-based polymers. The porous film may comprise woven or non-woven end-linked sPUU or polyolefin polymers. Non-woven separators may be in the form of perforated, felted, solution-blown, or sintered polymers. When the separator comprises a polyolefin, it may comprise, for example, one or more of an ethylene homopolymer, a propylene homopolymer, an ethylene/butene copolymer, an ethylene/hexene copolymer, and an ethylene/methacrylate copolymer. As an alternative, porous woven or nonwoven fabric may be employed including but not limited to glass fiber or a polyethylene terephthalate fiber fabric. Polymeric separators may comprise any number of fillers provided the fillers do not render the polymer electrically conductive at a level that will interfere with the operation of the battery. Among the fillers that may be employed are non-electrically conductive inorganic materials (e.g., ceramics). Examples of suitable ceramic materials are the reaction products of metals with oxygen and/or water, for example metal oxides, metal hydroxides and metal oxide hydroxides. Such compounds include but are not limited to aluminum oxide hydroxide (e.g. boehmite). or aluminum oxide (i.e. alumina, or Al₂O₃). The filler may also comprise a mixture of aluminum oxide and boehmite.

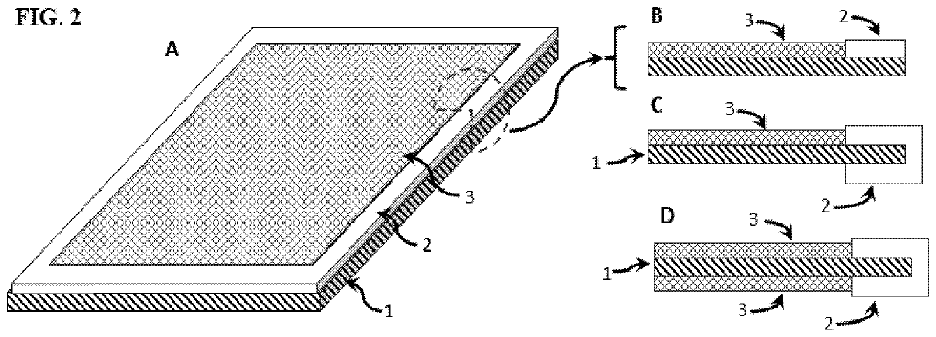

In addition to their use in anodes and/or cathodes as a binder for active materials, the end-linked sPUUs of the present disclosure, or electrically nonconductive compositions comprising them, may be used as an insulator at the edge of electrodes of various configurations (see, e.g., FIG. 3). The nonconductive compositions comprising end-linked sPUUs used as insulators in batteries may comprise the same types of fillers used in separators described herein.

### CERTAIN ASPECTS

1. An end-linked segmented polyurethaneurea (end-linked sPUU) polymer comprising:
   one or more polyamine crosslinking agents, each having an amine functionality greater than two, said crosslinking agents being bound to more than two linear sPUU polymer chains (e.g., on average) at their ends through urea linkages formed with amine groups of the polyamine crosslinking agent;
   wherein the linear sPUU polymer chains are comprised of soft segments, hard segments, and one or more diamine chain extenders, and the soft segments comprise one or more linear glycols (e.g., selected from the group consisting of linear polyether glycols, linear polyester-glycols, linear polycarbonate-glycols and combinations of any thereof that may comprise terminal hydroxyl groups and having a hydroxyl functionality of two or less).
2. An end-linked sPUU polymer comprising:
   (i) one or more protected linear prepolymers (v) comprising
      (a) one or more linear glycols (i) (e.g., one or more linear glycols comprising a linear polyether glycol, linear polyester-glycol, linear polycarbonate-glycol or combinations of any thereof that may comprise terminal hydroxyl groups and having a hydroxyl functionality up to two or equal to two), wherein at least one of the one or more linear glycols optionally has a number average molecular weight (Mn) from about 650 to about 5,000 Da, reacted with
      (b) one or more diisocyanates (ii),
   to form an isocyanate capped prepolymer (iii) that is subsequently reacted with
      (c) one or more isocyanate reactive thermolabile blocking agents (iv), and optionally one or more chain terminators (ix),
   to form the one or more protected prepolymers (v) comprising blocked isocyanate end groups; which protected prepolymers (v) are then reacted with
   (ii) one or more diamine chain extenders (vi), wherein at least one of the diamine chain extenders optionally has a molecular weight (e.g., Mw) less than 300 Da, and one or more polyamine crosslinking agents (viii) each having an amine functionality greater than two,
   to form the end-linked sPUU polymer by heating to remove the blocking agent and permit the previously blocked isocyanate groups to react with the one or more chain extenders and one or more crosslinkers, wherein the one or more polyamine crosslinking agents are bound to more than two linear sPUU polymer chains (e.g., on average) at their ends through urea linkages formed with the amine groups of the polyamine crosslinking agent. A skilled artisan will understand that end-linked sPUU polymers as set forth in aspect 2 are prepared in solution (in organic solvents such as DMAc) although the final end-linked sPUU polymer is insoluble.
3. An end-linked sPUU polymer comprising:
   (i) one or more protected polymers (vii) comprising
      (a) one or more linear glycols (i) (e.g., one or more linear glycols comprising a linear polyether glycol, linear polyester-glycol, linear polycarbonate-glycol or combinations of any thereof that may comprise terminal hydroxyl groups and having a hydroxyl functionality of about two), wherein at least one of the one or more linear glycols optionally has a number average molecular weight (Mn) from about 650 to about 5,000 Da, reacted with
      (b) one or more diisocyanates (ii),
   to form isocyanate capped prepolymer (iii) that is subsequently reacted with
      (c) one or more isocyanate reactive thermolabile blocking agents (iv), one or more diamine chain extenders (vi), wherein at least one of the diamine chain extenders optionally has a molecular weight less than 300 Da, and optionally one or more chain terminators (ix),
   to form the one or more protected polymers (vii) comprising blocked isocyanate end groups; which protected polymers (vii) are then reacted with
   (ii) one or more polyamine crosslinking agents (viii), each having an amine functionality greater than two, to form the end-linked sPUU polymer by heating to remove the blocking agents and permit the previously blocked isocyanate groups to react with the one or more crosslinking agents (e.g., to form urea linkages), wherein the one or more polyamine crosslinking agents are bound to more than two linear sPUU polymer chains (e.g., on average) at their ends through urea linkages formed with the amine groups of the polyamine crosslinking agent. A skilled artisan will understand that end-linked sPUU polymers as set forth in aspect 3 are prepared in solution (in organic solvents such as DMAc) although the final end-linked sPUU polymer is insoluble.
4. The end-linked sPUU polymer of any of aspects 1-3, wherein the polyamine crosslinking agent comprises one or more molecules less than 500 Da or less than 1,000 Da and optionally having from 3-8 amine groups at least one of which is a primary amine.
5. The end-linked sPUU polymer of any of aspects 1-3, wherein the one or more polyamine crosslinking agents comprises a crosslinking agent with a weight average molecular weight (Mw) in a range selected from: about 300 Da to about 1,000,000 Da; from about 300 Da to about 200,000 Da; from about 300 Da to about 2,000 Da; from about 2,000 Da to about 10,000 Da; from about 10,000 Da to about 30,000 Da; from about 30,000 Da to about 50,000 Da; from about 10,000 Da to about 50,000 Da; from about 50,000 Da to about 100,000 Da; from about 100,000 Da to about 200,000 Da; and from about 200,000 Da to about 1,000,000 Da.
6. The end-linked sPUU polymer of any of aspects 1-5, wherein the polyamine crosslinking agent comprises one or more polymers selected from the group consisting of: a poly(methylene amine), poly(vinyl amine), poly(allyl amine), poly(aminoethyl acrylate), poly(aminoethyl methacrylate), poly(N-amino ethylene imine), poly(aminopropyl methyl siloxane) or its copolymers, poly(ethylene imine) (PEI), and a polyamidoamine (PAMAM).
7. The end-linked sPUU polymer of any of aspects 1-6, wherein the polyamine crosslinking agent comprises a PAMAM) or a PAMAM dendrimer.
8. The end-linked sPUU polymer of any of aspects 1-7, wherein the polyamine crosslinking agent comprises a branched PEI or a PEI dendrimer.
9. The end-linked sPUU polymer of any of aspects 1-8, wherein the polyamine crosslinking agent has an amine functionality greater than 3 or greater than 4.
10. The end-linked sPUU polymer of any of aspects 1-9, wherein the polyamine crosslinking agents comprise primary amine functionalities, or comprise primary amine functionalities and optionally secondary amine functionalities.
11. The end-linked sPUU polymer of any of aspects 1-10, wherein the linear sPUU polymer chains (e.g., elastomeric sPUU polymer chains) and/or the protected polymer (vii) comprise hard segments (HS) and soft segments (SS), and wherein a hard segment (HS) content by weight percent (HS wt %) is in a range selected from the group consisting of: from about 4% to about 16%, from about 5.75% to about 15.25%, from about 4.5% to about 8.0%, from about 8.0% to about 15.23%, from about 8% to about 10%, from about 10% to about 12%, from about 11% to about 15, from about 5% to about 7%, from about 7% to about 9%, from about 9% to about 11%, and from about 11% to about 12% by weight of the sPUU polymer chains or the protected polymer (vii).
12. The end-linked sPUU polymer of any of aspects 1-11, wherein the linear sPUU polymer chains (e.g., elastomeric sPUU polymer chains) and/or the protected polymer (vii) comprise hard segments (HS) and soft segments (SS), and wherein the soft segment (SS) content by percent (SS wt %) is in a range selected from the group consisting of: from about 84% to about 96%, from about 84% to about 94.5%, from about 84% to about 90%, and from about 90% to about 96% by weight of the sPUU polymer chains or the protected polymer (vii).
13. The end-linked sPUU polymer of aspect 11 or aspect 12, wherein the linear sPUU polymer chains and/or the protected polymer (vii) have a soft segment molecular weight (SSMW) to hard segment molecular weight (HSMW) (SSMW/HSMW) ratio (i.e., soft segment Mn/hard segment Mn) in a range selected from: about 5 DA to about 20 Da (e.g., 20.2 Da), about 5.5 Da to about 16.25 Da, about 5 Da to about 10 Da, about 10 Da to about 15 Da, about 14 Da to about 16.5 Da, about 16.5 Da to about 20.2 Da, about 9 Da to about 11 Da, and about 11 Da to about 12 Da.
14. The end-linked sPUU polymer of any of aspects 1-13, wherein the linear sPUU polymer chains (the sPUU polymer component) and/or the protected polymers (vii) (prior to end-linking) comprise a hard segment (HS) and a soft segment (SS), with a hard segment molecular weight (HSMW) in a range selected from: about 400 Da to about 750 Da, about 400 Da to about 550 Da, about 550 Da to about 725 Da, and about 500 Da to about 600 Da.
15. The end-linked sPUU polymer of any of aspects 1-14, wherein the linear sPUU polymer chains (the sPUU polymer component) and/or the protected polymers (vii) (prior to end-linking) comprise a hard segment (HS) and a soft segment (SS), with a soft segment molecular weight (SSMW) in a range selected from: about 4,000 Da to about 10,000 Da; about 4,000 Da to about 6,0000 Da; about 6,000 Da to about 8,000 Da; about 4,500 Da to about 5,750 Da; and about 8,000 Da to about 10,000 Da.
16. The end-linked sPUU polymer of any of aspects 1-15, wherein the linear sPUU polymer chains (the sPUU polymer component) and/or the protected polymers (vii) (prior to end-linking) have a number average molecular weight (Mn) in a range selected from: about 25,000 Da to about 75,000 Da; about 10,000 Da to about 100.00 Da; about 10,000 Da to about 50,000 Da; about 50,000 Da to 100,000 Da; about 25,000 Da to about 30,000 Da and about 30,000 Da to about 35,000 Da, as measured by gel permeation chromatography (GPC).
17. The end-linked sPUU polymer of any of aspects 1-15, wherein the linear sPUU polymer chains (the sPUU polymer component) and/or the protected polymers (vii) (prior to end-linking) may have a weight average molecular weight (Mw) in a range selected from: about 10,000 Da to about 250,000 Da, about 10,000 Da to about 150,000 Da, about 20,000 Da to about 150,000 Da, about 10,000 Da to about 25,000 Da, about 25,000 Da to about 60,000 Da, about 60,000 Da to about 100,000 Da, about 80,000 Da to about 120,000 Da, about 100,000 to about 120,000 Da, about 100,000 Da to about 250,000 Da, about 100,000 Da to about 150,000 Da, about 150,000 Da to about 200,000 Da, about 200,000 Da to about 225,000 Da, and about 225,000 Da to about 250,000 Da, as measured by GPC.
18. The end-linked sPUU polymer of any of aspects 1-15, wherein the linear sPUU polymer chains (the sPUU polymer component) and/or the protected polymers (vii) (prior to end-linking) may have an average molecular weight (Mz) in a range selected from: about 175,000 Da to about 635,000 Da, about 175,000 Da to about 300,000 Da, and about 300,000 Da to about 675,000 Da, as measured by GPC.
19. The end-linked sPUU polymer of any of aspects 1-18, wherein the linear sPUU polymer chains (the sPUU polymer component) and/or the protected polymers (vii) (prior to end-linking) have a polydispersity index (Mw/Mn) of about 2.2 to about 3.0 or from about 3.0 to about 3.5.
20. The end-linked sPUU polymer of any of aspects 1-18, wherein the linear sPUU polymer chains (the sPUU polymer component) and/or the protected polymers (vii) (prior to end-linking) have a polydispersity index (Mw/Mn) of about 3.5 to about 4.0 or from about 4.0 to about 4.5.
21. The end-linked sPUU polymer of any of aspects 1-18, wherein the linear sPUU polymer chains (the sPUU polymer component) and/or the protected polymers (vii) (prior to end-linking) have a polydispersity index (Mw/Mn) of about 4.5 to about 5.5 or from about 5.5 to about 6.5.
22. The end-linked sPUU polymer of any of aspects 1-18, wherein the linear sPUU polymer chains (the sPUU polymer component) and/or the protected polymers (vii) (prior to end-linking) have a polydispersity index (Mw/Mn) of about 6.5 to about 7.5 or from about 7.5 to about 8.5.
23. The end-linked sPUU of any of aspects 1-22, wherein the one or more linear glycols comprise a linear polyether glycol (e.g., a linear polyether glycol with a hydroxyl functionality of 2).
24. The end-linked sPUU of aspect 23, wherein the linear polyether glycol is a linear macrodiol obtained by ring-opening polymerization and/or copolymerization or by condensation polymerization of C2-C12 polyhydric alcohols (e.g., diols) or mixtures thereof.
25. The end-linked sPUU of aspect 23 wherein the linear polyether glycol is (a) a polyether glycol that may be prepared by ring opening polymerization of one or more of ethylene oxide, propylene oxide, trimethylene oxide, tetrahydrofuran, and 3-methyltetrahydrofuran, or (b) a polyether glycol that may be prepared by condensation polymerization of ethylene glycol, 1,3-propanediol, 1,4-butanediol, 1,5-pentanediol 1,6-hexanediol, 2,2-dimethyl-1,3 propanediol, 3-methyl-1,5-pentanediol, 1,7-heptanediol, 1,8-octanediol, 1,9-nonanediol, 1,10-decanediol, 1,12-dodecanediol or a mixture thereof.
26. The end-linked sPUU of aspect 23, wherein the linear polyether glycol comprises a linear poly(tetramethylene ether) glycol (PTMEG) with a hydroxyl functionality of 2.
27. The end-linked sPUU of any 23, wherein the linear polyether glycol comprises poly(tetramethylene ether) glycol having an Mn of about 1,700 Da to about 2,100 Da and a hydroxyl functionality of 2.
28. The end-linked sPUU of any of aspects 1-22, wherein the one or more linear glycols comprise a linear polyester-glycol or a linear polycarbonate-glycol (e.g., a linear polyester-glycol or a linear polycarbonate-glycol with a hydroxyl functionality of 2).
29. The end-linked sPUU of aspect 28, wherein when the linear glycol comprises a linear polyester glycol it comprises a polyester glycol produced by condensation polymerization of one or more C2-C12 aliphatic dicarboxylic acids and one or more C2-C12 diols.
30. The end-linked sPUU of aspect 29, wherein (a) the one or more C2-C12 aliphatic dicarboxylic acids are selected from the group consisting of malonic acid, succinic acid, glutaric acid, adipic acid, pimelic acid, suberic acid, azelaic acid, sebacic acid, undecanedicarboxylic acid, dodecanedicarboxylic acid, and mixtures thereof, and/or (b) the one or more C2-C12 diols are selected from the group consisting of ethylene glycol, 1,3-propanediol, 1,4-butanediol, 1,5-pentanediol 1,6-hexanediol, neopentyl glycol, 3-methyl-1,5-pentanediol, 1,7-heptanediol, 1,8-octanediol, 1,9-nonanediol, 1,10-decanediol, 1,12-dodecanediol and mixtures thereof.
31. The end-linked sPUU of any of aspects 28-30, wherein the linear polyester glycol has a melting temperature in the range of about 5 °C to about 55 °C and/or a hydroxyl functionality of about 2.
32. The end-linked sPUU of aspect 28, wherein when the glycol comprises a linear polycarbonate glycol it comprises a polycarbonate glycol produced by condensation polymerization of phosgene, chloroformic acid ester, dialkyl carbonate or diallyl carbonate and one or more aliphatic polyols.
33. The end-linked sPUU of aspect 32, wherein the one or more aliphatic polyols are one or more C2-C12 aliphatic diols.
34. The end-linked sPUU of aspect 33, wherein the one or more C2-C12 aliphatic diols are selected from the group consisting of diethylene glycol, 1,3-propanediol, 1,4-butanediol, 2-methyl-1,4-butanediol, 1,5-pentanediol, 3-methyl-1,5-pentanediol, 1,6-hexanediol, neopentyl glycol, 1,7-heptanediol, 1,8-octanediol, 1,9-nonanediol, 1,10-decanediol, 1,12-dodecanediol, and mixtures thereof.
35. The end-linked sPUU of any of aspects 32-34, wherein the linear polycarbonate polyol has a melting temperature in the range of about 5 °C to about 55 °C and/or a hydroxyl functionality of about 2.
36. The end-linked sPUU of any of aspects 1-35, wherein the one or more linear glycols has an Mn from about 650 to about 5,000 Da, or from about 650 Da to about 2,500 Da.
37. The sPUU of any of aspects 1-36, wherein the one or more diamine chain extenders is a mixture of two or more compounds each comprising two isocyanate reactive amines (e.g., primary or secondary amines), and optionally, at least one (e.g., all) of the diamines in the mixture has a molecular weight (e.g., Mw) less than 300 Da.
38. The sPUU of any of aspects 1-37, wherein the one or more diamine chain extenders is selected from the group consisting of hydrazine, alicyclic diamines, aliphatic diamines, aromatic diamines, and a mixture of diamines, wherein at least one of the diamines has a molecular weight (e.g., Mw) less than 300 Da.
39. The end-linked sPUU of aspect 38, wherein the one or more diamine chain extenders comprises hydrazine or an aliphatic diamine.
40. The end-linked sPUU of any of aspects 1-37, wherein the one or more diamine chain extenders is selected from the group consisting of: 1,2-ethylenediamine, 1,4-butanediamine, 1,2-butanediamine, 1,3-butanediamine, 1,3-diamino-2,2-dimethylbutane, 1,6-hexamethylenediamine, 1,12-dodecanediamine, 1,2-propanediamine, 1,3-propanediamine, 2-methyl-1,5-pentanediamine, 1-amino-3,3,5-trimethyl-5-aminomethylcyclohexane, 2,4-diamino-1-methylcyclohexane, N-methylamino-bis(3-propylamine), 1,2-cyclohexanediamine, 1,4-cyclohexanediamine, 4,4′-methylene-bis(cyclohexylamine), 2,2-dimethyl-1,3-propanediamine, meta-tetramethylxylenediamine, 1,3-diamino-4-methylcyclohexane, 1,3-cyclohexane-diamine, 1,1-methylene-bis(4,4′-diaminohexane), 3-(aminomethyl)-3,5,5-trimethylcyclohexan-1-amine, 1,3-pentanediamine (1,3-diaminopentane) and m-xylylene diamine.
41. The end-linked sPUU of any of aspects 1-37, wherein the one or more diamine chain extenders is a mixture of two or more aliphatic compounds each comprising two isocyanate reactive amines selected from the group consisting of: 1-amino-3,3,5-trimethyl-5-aminomethylcyclohexane, 2,4-diamino-1-methylcyclohexane, N-methylamino-bis(3-propylamine), 1,2-cyclohexanediamine, 1,4-cyclohexanediamine, 4,4′-methylene-bis(cyclohexylamine), 2,2-dimethyl-1,3-propanediamine, meta-tetramethylxylenediamine, 1,3-diamino-4-methylcyclohexane, 1,3-cyclohexane-diamine, 1,1-methylene-bis(4,4′-diaminohexane), 3-aminomethyl-3,5,5-trimethylcyclohexane, 1,3-pentanediamine (1,3-diaminopentane) and m-xylylene diamine.
42. The end-linked sPUU of any of aspects 1-37, wherein the one or more diamine chain extenders comprises one or more poly(ethylene oxide) and/or poly(propylene oxide) diamines.
43. The end-linked sPUU of any of aspects 1-37, wherein the one or more diamine chain extenders comprises ethylene diamine (EDA).
44. The end-linked sPUU of any of aspects 1-43, wherein (i) the linear sPUU polymer chains comprise one or more diisocyanates reacted to form urethane and/or urea linkages, and (ii) the linear sPUU polymer chains are bound to the crosslinking agent through a urea bond formed by a diisocyanate of the one or more diisocyanates.
45. The end-linked sPUU of any of aspects 2-44, wherein the one or more diisocyanates comprises (i) one or more aromatic and/or (ii) one or more non-aromatic isocyanates.
46. The end-linked sPUU of any of aspects 2-45, wherein the one or more diisocyanates comprise at least one non-aromatic isocyanate selected from the group consisting of: 4,4′-methylenebis(cyclohexyl isocyanate), 1,4-cyclohexyl diisocyanate, isopheronediisocyanate (5-isocyanato-1-(isocyanatomethyl)-1,3,3-trimethylcyclohexane, and mixtures thereof. Among the nonaromatic diisocyanates that may be employed are HDI (hexamethylene diisocyanate), and heptamethylene diisocyanate.
47. The end-linked sPUU of any of aspects 2-44, wherein the one or more diisocyanates comprises a single diisocyanate selected from the group consisting of: 4,4′-methylenebis(phenyl isocyanate), 2,4′-methylenebis(phenyl isocyanate), 1,4-phenylenediisocyanate, 4,4′-methylenebis(cyclohexyl isocyanate), 1,4-cyclohexyl diisocyanate, 2,4-toluene diisocyanate, and 2,6-toluene diisocyanate.
48. The end-linked sPUU of any of aspects 2-44, wherein the one or more diisocyanates comprises two or more diisocyanates selected from the group consisting of: 4,4′-methylenebis(phenyl isocyanate), 2,4′-methylenebis(phenyl isocyanate), 1,4-phenylenediisocyanate, 4,4′-methylenebis(cyclohexyl isocyanate), 1,4-cyclohexyl diisocyanate, 2,4-toluene diisocyanate, and 2,6-toluene diisocyanate.
49. The end-linked sPUU of any of aspects 2-44, wherein the one or more diisocyanates comprise 4,4′-methylenebis(phenyl isocyanate) and 2,4′-methylenebis(phenyl isocyanate).
50. The end-linked sPUU of any of aspects 1-49, wherein a portion (e.g., less than 50% or less than 25%) of the sPUU polymer chains further comprises one or more isocyanate reactive chain terminating groups.
51. The end-linked sPUU of aspect 50, wherein the portion the sPUU polymer chains that further comprises one or more isocyanate reactive chain terminating groups is less than 15% or less than 5%.
52. The end-linked sPUU of any of aspects 2-51, wherein the one or more blocking agents is selected from blocking agents comprising hydroxyl, mercaptan, amide, cyclic amide, or imide functionalities.
53. The end-linked sPUU of any of aspects 2-51, wherein the one or more blocking agents is selected from (i) cyclic nitrogen compounds including, e.g., imidazole/imidazoline, pyrazole, and triazoles or (ii) compounds comprising oxime or amidine functionalities.
54. The end-linked sPUU of any of aspects 1-53, wherein the end-linked sPUU is an elastomer having an elongation at break in the range of 300% to 500%, or in the range of 500% to 800% at 21+/−1.1 °C (700+/−2 °F) and a relative humidity of 65%±2%.
55. The end-linked sPUU of any of aspects 1-54, having a SET % less than about 40% or less than about 16%.
56. The end-linked sPUU of any of aspects 1-55, having a flat stretch/recovery determined by a 5TM100/5TP300 ratio of greater than 0.09.
57. The end-linked sPUU of any of aspects 1-56, having a conductivity of about 10⁻⁶ Siemens per meter (S/m) to about 10⁻⁸ S/m or about 10⁻⁸ S/m to about 10⁻¹⁰ S/m.
58. The end-linked sPUU of any of aspects 1-56, having a conductivity of about 10⁻¹⁰ S/m to about 10⁻¹² S/m or about 10⁻¹² S/m to about 10⁻¹⁵ S/m.
59. The end-linked sPUU of any of aspects 1-58, wherein the end-linked sPUU does not comprise any fluorinated components.
60. An article or composition comprising the end-linked sPUU of any of aspects 1-59.
61. The article or composition of aspect 60 wherein the article or composition comprises 0.2% to 10%, or 10% to 50%, of the end-linked sPUU by weight.
62. The article or composition of aspect 60 wherein the article or composition comprises
   A) 50% to 70%, or 70% to 85%, of the end-linked sPUU by weight or
   B) 85% to 95%, or 95% to 100%, of the end-linked sPUU by weight.
63. An article or composition comprising an end-linked sPUU of any of aspects 1-59 and an amount of one or more dispersants (e.g., one or more dispersants in a total amount of from about 0.1% to about 4% by weight, such as from about 0.1% to about 0.5% by weight).
64. The article or composition of aspect 63, wherein the one or more dispersants is a butadiene rubber, or a hydrogenated butadiene rubber (e.g., fully or partially hydrogenated).
65. An article or composition of any of aspects 60-64, further comprising one or more electrically conductive materials.
66. The article or composition of aspect 65, wherein the one or more electrically conductive materials is in the form of particles, powders, or fibers.
67. The article or composition of aspect 66, wherein the particles, powders, or fibers have a largest dimension in the range of about 30 microns (μm) to about 50 μm or in the range of about 10 μm to about 30 μm.
68. The article or composition of aspect 66, wherein the particles, powders, or fibers have a largest dimension in the range of about 1 μm to about 10 μm or in the range of about 0.1 μm to about 1 μm.
69. The article or composition of aspect 66, wherein the particles, powders, or fibers have a D50 value in the range of about 30 μm to about 50 μm or in the range of about 10 μm to about 30 μm.
70. The article or composition of aspect 66, wherein the particles, powders, or fibers have a D50 value in the range of about 1 μm to about 10 μm or in the range of about 0.1 μm to about 1 μm.
71. The article or composition of any of aspects 65-70, wherein the electrically conductive material is a non-metallic or metallic electrically conductive material.
72. The article or composition of aspect 71, wherein the non-metallic electrically conductive material is a carbonaceous material.
73. The article or composition of aspect 71 or aspect 72, wherein the non-metallic electrically conductive material comprises one or more of graphene, carbon fiber, carbon nanotubes (CNT), and/or carbon nanofibers (CNF).
74. The article or composition of aspect 71 or aspect 72, wherein the non-metallic electrically conductive material comprises one or more of graphite, graphene, carbon fiber, CNT, and/or CNF.
75. The article or composition of aspect 71, wherein the non-metallic electrically conductive material comprises a conductive organic material (e.g., a conductive polyacetylene, polyphenylene vinylene, or polypyrrole polymer).
76. The article or composition of aspect 71, wherein the electrically conductive material is a metallic electrically conductive material.
77. The article or composition of aspect 76, wherein the metallic electrically conductive material comprises one or more of: aluminum, cobalt, copper, iron, tin, magnesium, manganese, nickel, silver, zinc, and alloys or mixtures thereof.
78. The article or composition of aspect 76, wherein the metallic electrically conductive material comprises gold, platinum, ruthenium, rhodium, palladium, osmium, iridium and alloys thereof.
79. The article or composition of aspect 71, wherein the electrically conductive material comprises a zirconium alloy or a zirconia.
80. The article or composition of any of aspects 60-79, further comprising one or more additives selected from the group consisting of lubricants, antioxidants, heat stabilizers, hydrolytic stabilizers, and acid scavengers.
81. The article or composition of any of aspects 60-80, further comprising one or more fillers (e.g., electrically non-conductive fillers).
82. The article or composition of aspect 81, wherein the one or more fillers comprises one or more mineral fillers.
83. The article or composition of any of aspects 60-82, wherein the article or composition comprises about 88% to about 99.9% of the end-linked sPUU, optionally about 0.1% to about 2% of a dispersant, optionally up to about 3% of a lubricant and/or filler, optionally up to 4% of an electrically conductive material by weight, and optionally up to 3% of one or more additional additives (e.g., one or more antioxidants).
84. The article or composition of any of aspects 65-83, wherein the ratio of electrically conductive material to end-linked sPUU is from about 1:40 to about 40:1 or from about 1:20 to about 20:1 by weight.
85. The article or composition of aspect 84 wherein the end-linked sPUU and electrically conductive material together comprise from about 80% to 100% or from about 90% to 100% of the article or composition by weight.
86. The article or composition of any of aspects 60-85, wherein the end-linked sPUU, dispersant, and/or electrically conductive material does not comprise any fluorinated components.
87. The article or composition of any of aspects 63-86, wherein the article or composition comprises in total from about 0.1% to about 4%, about 0.1% to about 0.5%, about 0.5% to about 1%, about 0.1% to about 2%, about 2% to about 4%, about 3% to about 4%, or about 4% to about 5% of one or more dispersants by weight of the composition or article comprising the end-linked sPUU polymer.
88. The article or composition of any of aspects 65-87, wherein the article or composition comprises in total from about 0.1% to about 50%, about 0.1% to about 1%, about 1% to about 10%, about 10% to about 25%, or about 25% to about 50% of the electrically conductive material by weight.
89. The article or composition of any of aspects 60-88, wherein the article or composition comprises the one or more additives (e.g., in a total amount from about 0.1% to about 0.5% by weight or from about 0.5% to about 1% by weight).
90. The article or composition of any of aspects 60-88, wherein the article or composition comprises the one or more additives (e.g., in a total amount from about 1% to about 2% by weight or from about 2% to about 4% by weight).
91. The article or composition of any of aspects 60-90, wherein the article or composition comprises one or more fillers in an amount from about 0.1% to about 0.5% by weight or from about 0.5% to about 1% by weight.
92. The article or composition of any of aspects 66-90, wherein the article or composition comprises one or more fillers in an amount from about 1% to about 2% by weight or from about 2% to about 4% by weight.
93. The article or composition of any of aspects 60-92, wherein the article is an electronic component, and optionally wherein the composition forms a conformal coating over all or part of an underlying substrate (e.g., a conductive or non-conductive substrate).
94. The electronic component of aspect 93, wherein the article or composition forms all or part of an electrically conductive element of the electronic component that conducts electrical current (e.g., a metallic element such as a wire, a current collector or an electrode) or forms a non-conductive element that contacts, encases, and/or houses conductive (e.g. metallic) elements.
95. An article or composition (e.g., a binder composition) for an electrochemical cell cathode and/or anode, comprising an end-linked sPUU or article or composition of any of aspects 1-94, optionally wherein the cathode and/or anode are a cathode and/or an anode of a primary or secondary cell.
96. The article or composition of any of aspects 60-95, further comprising a cathode active material.
97. The article or composition of aspect 96, wherein the cathode active material comprises one or more metallic elements.
98. The article or composition of aspect 97, wherein at least one of the one or more metallic elements is selected from the group consisting of lithium, sodium, nickel, cobalt, manganese, magnesium, and aluminum.
99. The article or composition of aspect 97, wherein at least one of the one or more metallic elements is selected from the group consisting of: lithium and sodium.
100. The article or composition of any of aspects 97-99, wherein at least one of the one or more metallic elements is present as metal (e.g., in one or more alloys), or as one or more salts, complexes, or compounds (e.g., metal hydrides).
101. The article or composition of any of aspects 96-100, wherein the cathode active material comprises at least one of a nickel manganese cobalt oxide (NMC), a lithium iron phosphate (LFP), a nickel manganese cobalt aluminum (NMCA), a lithium manganese nickel oxide (LMNO), and/or a lithium manganese oxide (LMO).
102. The article or composition of aspect 101, wherein the cathode active material comprises at least one of a LFP, a LMNO, or a LMO.
103. The article or composition of aspect 101, wherein the cathode active material comprises at least one of a NMC and a NMCA.
104. The article or composition of any of aspects 96-103, wherein the cathode active material is in the form of particles or a powder.
105. The article or composition of aspect 104, wherein the particles of cathode active material comprise particles in the size range of about 0.1 micron (μm) to about 1 μm, or from about 1 μm to about 5 μm.
106. The article or composition of aspect 104, wherein the particles of cathode active material comprise particles in the size range of about 1.0 micron (μm) to about 10 μm, or from about 10 μm to about 100 μm.
107. The article or composition of any of aspects 60-104, wherein the article or composition does not comprise any fluorinated components and/or any fluorinated organic polymers.
108. The article or composition of any of aspects 96-107, wherein the cathode active material comprises from about 77% to about 85% by weight or from about 85% to about 90% by weight (e.g., in the absence of solvent and any support/current collector) of the article or composition.
109. The article or composition of any of aspects 96-107, wherein the cathode active material comprises from about 90% to about 95% by weight or from about 95% to about 99.8% by weight (e.g., in the absence of solvent and any support/current collector) of the article or composition.
110. The article of any of aspects 60-109, wherein the article is a cathode or anode of an electrochemical cell (e.g., a primary or secondary cell).
111. The cathode or anode of an electrochemical cell of aspect 110, wherein the end-linked sPUU is a binder for anode or cathode components (e.g., a cathode or anode active material such as graphite), an electrical insulator (e.g., at the edge of an electrode, see, e.g., FIG. 2), or a mechanical padding or a spacer for the electrode.
112. The cathode or anode of aspect 110 or aspect 111, wherein the cathode or anode comprises an electrically conductive current collector (e.g., with a conductivity greater than 5×10⁵ S/m or greater than 10⁶ S/m) in electrical contact with the article or composition of any of aspects 60-109.
113. The cathode or anode of aspect 112, wherein the article or composition(s) forms a coating (e.g., a conformal coating) on all or part of the surface of the current collector.
114. The cathode and/or anode of any of aspects 110-113, wherein the current collector is in the form of a sheet or rod.
115. The cathode or anode of any of aspects 110-113, wherein the current collector is comprised of a metal selected independently from the group consisting of aluminum, nickel, cobalt, tungsten, copper, and a combination of any thereof.
116. A battery electrode assembly comprising an anode and/or a cathode of any of aspects 110-115.
117. A primary cell battery comprising a cathode, anode or battery electrode assembly of any of aspects 110-116.
118. A secondary cell battery comprising a cathode, anode or battery assembly of any of aspects 110-116.
119. The battery electrode assembly of any of aspects 116-117 further comprising an electrolyte.
120. The battery electrode assembly of any of claims 116-118, wherein the electrolyte comprises a lithium salt (hexafluorophosphate, lithium tetrafluoroborate, lithium perchlorate, and combinations thereof) dissolved in one or more of dimethyl carbonate (DMC), ethyl methyl carbonate (EMC), diethylcarbonate (DEC), ethylene carbonate (EC), and propylene carbonate (PC), and their fluorinated equivalents.
121. The battery electrode assembly of claim 120, wherein the lithium salts may be selected from the group consisting of: lithium hexafluorophosphate (LiPF6), lithium bis(fluorosulfonyl)imide (LiFSI), lithium bis(trifluoromethanesulfonyl) imide (LiTFSI), lithium (fluorosulfonyl) (trifluoromethanesulfonyl) imide (LiFTFSI), lithium bis(pentafluoroethanesulfonyl)imide (LiBETI), lithium (pentafluoroethanesulfonyl) (trifluoromethanesulfonyl) imide (LiPTFSI), lithium trifluoromethanesulfonate (LiOTf), lithium bis(oxalato)borate (LiBOB), lithium difluoro(oxalato) borate (LiDFOB), lithium difluorobis(oxalato)phosphate (LiDFOP), lithium tetrafluoro(oxalato)phosphate (LiTFOP), lithium tetrafluoroborate (LiBF4), lithium nitrate (LiNO₃) lithium 2-trifluoromethyl-4,5-dicyanoimidazole (LiTDI).
122. The battery electrode assembly of any of aspects 116-121, wherein the cathode active material is comprised of lithium.
123. The use of a battery electrode assembly of any of aspects 116-122 as a power source for one or more devices selected from the group consisting of: laptop computers, cellular phones, tablets, electric vehicles, cameras, watches, electric bicycles, moving vehicle batteries, portable rechargeable battery devices, smoking devices, personal transporter devices (e.g., a Segway®, hoverboard, scooter, etc.), payment devices, global positioning devices, surveillance systems, tracking devices, personal hygiene devices, medical devices, and aviation equipment.
124. The use of a battery electrode assembly of any of aspects 116-122 as power storage for solar energy sources, wind energy sources, and/or uninterrupted power supplies.
125. A method of producing a cathode or anode for an electrochemical cell, the method comprising:
   A) providing a current collector having a surface optionally comprising an insulator on part of its surface (e.g., an insulator comprising an end-linked sPUU of any of aspects 1-59);
   B) providing a coating composition comprising a solvent (e.g., DMAc) in which is dissolved either:
      (a) protected prepolymer(s) (v) comprising blocked isocyanate end groups, chain extender(s) (vi), and polyamine crosslinking agent(s) (viii) (e.g., having an amine functionality greater than 2), or
      (b) protected polymer(s) (vii) comprising blocked isocyanate end groups, and polyamine crosslinking agent(s) (viii) (e.g., having an amine functionality greater than 2);
   C) applying the coating composition to at least a portion of the surface of the current collector to form a coated portion; and
   D) optionally drying the coating composition applied to the current collector to remove the solvent, and heating the current collector coated on all or part of its surface with the coating composition to a temperature high enough to deblock the protected prepolymers or protected polymers, thereby reconstituting active isocyanates that can react with the amine groups in the crosslinking agent(s) and/or the crosslinking agent(s) and chain extender(s) to form a coating of end-linked sPUU on the coated portion of current collector.
126. The method of aspect 125, wherein the coating composition further comprises a cathode active material, and the coating of end-linked sPUU is in electrically conductive contact with the current collector, and optionally wherein the method produces a cathode of an electrochemical cell.
127. The method of aspect 125 or aspect 126, wherein the coating composition further comprises an electrically conductive material.
128. The method of aspect 125 wherein the end-linked sPUU is not electrically conductive, and the coating is an insulator on the coated portion of the current collector.
129. The method of any of aspects 125-128, wherein the coating composition further comprises an antioxidant and/or dispersant.
130. The method of any of aspects 125-129, wherein the coating composition further comprises one or more other components selected from the group consisting of: heat stabilizers, hydrolytic stabilizers, acid scavengers, plasticizers, fillers, pigments, colorants, and combinations thereof.
131. The method of any of aspects 125-130, wherein the coating composition comprises a lubricant.
132. A method of forming a shaped article comprising an end-linked sPUU, the method comprising
   A) providing a composition comprising a solvent (e.g., DMAc) in which is dissolved either:
      (a) protected prepolymers (v) comprising blocked isocyanate end groups, chain extender(s) (vi), and polyamine crosslinking agent(s) (viii) (e.g., having an amine functionality greater than 2), or
      (b) protected polymer(s) (vii) comprising blocked isocyanate end group(s), and polyamine crosslinking agent(s) (viii) (e.g., having an amine functionality greater than 2);
   B) shaping the composition by casting, injection molding, blowing, weaving, spinning (e.g., into fiber), felting, or extruding the composition, or coating (e.g., spin coating) the composition on a surface; and
   C) while the composition is in the desired shape, heating the composition to a temperature sufficiently high to deblock the protected prepolymers or protected polymers, thereby reconstituting active isocyanates that can react with the amine groups in the crosslinking agent(s) and/or the crosslinking agent(s) and chain extender(s) to form the shaped article comprising the end-linked sPUU.
133. The method of aspect 132, wherein the shaped article is an article of any of aspects 60-93.
134. The method of aspect 132 or aspect 133, wherein the composition further comprises an antioxidant and/or dispersant.
135. The method of any of aspects 132-134, wherein the composition further comprises one or more other components selected from the group consisting of: heat stabilizers, hydrolytic stabilizers, acid scavengers, plasticizers, fillers, pigments, colorants, and combinations thereof.
136. The method of any of aspects 132-135, wherein the composition comprises a lubricant.
137. The method of any of aspects 132-136, wherein the composition further comprises an electrically conductive material.
138. The method of any of aspects 132-137, wherein the shaped article is a fiber (e.g., an elastomeric fiber that may be produced by spinning).
139. The method of aspect 138, wherein the fiber is produced by dry spinning the composition.
140. The method of aspect 138, wherein the fiber is produced by wet spinning the composition.
141. The method of any of aspects 132-140, wherein the composition further comprises a cathode active material and/or an electrically conductive material.
142. The method of any of aspects 125-141, wherein the solvent is, or comprises, a non-aqueous solvent.
143. The method of aspect 142, wherein the non-aqueous solvent comprises one or more of: 1-butylpyrrolidin-2-one (NBP), N-methyl-2-pyrrolidone (NMP), N-Butyl-2-pyrrolidone, 2-Methyltetrahydrofuran (2-MeTHF), and N,N-Dimethyl-1,3-dioxolane-4-methanol.
144. The method of aspect 142, wherein the non-aqueous solvent comprises one or more of NBP and NMP.
145. The method of aspect 142, wherein the non-aqueous solvent comprises NMP.
146. The method of any one of aspects 125-145, wherein the coating composition or composition is stable at a holding temperature in the range of 35 °C-45 °C for about 24 hours to about 72 hours or about 72 hours to about 168 hours.
147. The method of any one of aspects 125-145, wherein the coating composition or composition is stable at a holding temperature in the range of 35 °C-45 °C up to about 240 hours or up to about 336 hours.
148. The method of aspect 146 or aspect 147, wherein the stability is based upon the change in viscosity relative to the initial viscosity value of the composition or coating composition.
149. The method of aspect 148, wherein the composition or coating composition is considered stable at a viscosity value that is less than 1.25-fold or less than 1.5-fold of the initial viscosity value.
150. The method of aspect 148, wherein the composition or coating composition is considered stable at a viscosity value that is less than 2-fold or less than 4-fold of the initial viscosity value.
151. A method of determining the range of crosslinking agent addition relative to the total polymer forming components in compositions for preparing end-linked sPUU polymer(s) (or preparing shaped articles comprising end-linked sPUU polymer(s)), the method comprising:
   A) providing a series of equivalent individual aliquots of
      (a) protected prepolymer(s) (v) comprising blocked isocyanate end groups, and chain extender(s) (vi) dissolved in a solvent (e.g., a dry/water-free non-aqueous solvent such as DMAc), or
      (b) protected polymer(s) (vii) comprising blocked isocyanate end groups dissolved in a solvent (e.g., a non-aqueous solvent such as DMAc);
   B) adding increasing amounts of crosslinking agent(s) (viii) to the individual aliquots;
   C) heating the samples to release blocking agents from the protected polymer(s) or protected prepolymer(s) thereby releasing previously blocked isocyanates and causing solvent insoluble end-linked sPUU polymer formation;
   D) collecting the insoluble end-linked sPUU polymer (e.g., as a solvent swollen polymer or gel), and optionally washing it in the solvent; and
   E) drying the insoluble polymer and determining the yield of end-linked sPUU polymer by a) the total weight of polymer recovered or b) the weight fraction of the total polymerizable materials present in the aliquots (including the crosslinking agent added).
152. The method of aspect 151, wherein the range of crosslinking agents (viii) is the amount that produces (a) greater than 90% of the maximum polymer recovered, or b) greater than 95% of the maximum polymer recovered from the aliquots.
153. The method of aspect 151, wherein the range of crosslinking agent (viii) is the amount that produces (a) a weight fraction greater than 90%, or (b) a weight fraction greater than 95% based on the total polymerizable materials present in the aliquots.
   The methods of aspects 151 to 153 may be utilized in conjunction with (e.g., as precursors to) any of the methods of aspects 125-150, or in the preparation of any of the end-linked sPUU containing compositions, or articles comprising an end-linked sPUU appearing in aspects 1-124, and accordingly may comprise any of the components recited in those aspects.
154. A fiber (e.g., an elastomeric fiber), thread, yarn, or fabric, comprising the end-linked polyurethaneurea of any of aspects 1-59 (e.g., from about 50% to about 80%, or from about 80% to 100% by weight) of the end-linked polyurethaneurea).
155. A fabric comprising from about 0.5% to about 10% or about 10% to about 25% of the fiber of aspect 154 by weight.
156. A fabric comprising from about 25% to about 40% or about 40% to about 50% of the fiber of aspect 154 by weight.
157. A fabric comprising from about 50% to about 75% or about 75% to about 100% of the fiber of aspect 154 by weight.
158. The fiber, thread, yarn, or fabric of any of aspects 154-157, further comprising (e.g., as part of the fiber) one or more other components selected from the group consisting of: heat stabilizers, hydrolytic stabilizers, acid scavengers, plasticizers, fillers, pigments, colorants, and combinations thereof.
159. The fiber, thread, yarn, or fabric of any of aspects 154-158, further comprising a lubricant (e.g., applied to the fiber).
160. The fiber, thread, yarn, or fabric of aspect 159, wherein the lubricant is a silicon oil (e.g., PDMS), a mineral oil, or a wax.
161. The fiber, thread, yarn, or fabric of aspect 159 or aspect 160, wherein the fiber, thread, yarn, or fabric comprises about 0.5% to about 4% by weight of the lubricant.
162. A garment comprising fiber, thread, yarn, or fabric of any of aspects 154-161.
163. A stable heat curable single component composition (one-package) for preparing an end-linked sPUU comprising:
   A) a solvent; and
   B) either (a) protected prepolymer(s) (v), chain extender(s) (vi), and polyamine crosslinking agent(s) (viii), or
      (b) protected polymer(s) (vii) and polyamine crosslinking agent(s) (viii);
   wherein the crosslinking agent(s) have an amine functionality greater than two or an amine functionality greater than 3.
164. The stable heat curable single component composition of aspect 163, wherein the composition is stable for at least 14 days at temperatures up to 40 °C.
   The single component composition of aspects 163 and 164 may be utilized in conjunction with (e.g., as precursors to) any of the methods of aspects 125-150, or in the preparation of any of the end-linked sPUU compositions, or articles comprising an end-linked sPUU appearing in aspects 1-124 and accordingly may comprise any of the components recited in those aspects.

### EXAMPLES

Examples provided herein are representative non-limiting illustrations of the principles and practice of the teachings of this disclosure. Throughout the individual examples that follow, the apply:
Terathane® 1800 is a linear poly(tetramethylene ether) glycol (PTMEG), with a number average molecular weight of 1,800 (commercially available from Invista, S. à. r. L., of Wichita, KS and Wilmington, DE);
Isonate® 125MDR is a pure mixture of diphenylmethane diisocyanate (MDI) containing 98% 4,4′-MDI isomer and 2% 2,4′-MDI isomer (commercially available from the Dow Company, Midland, Michigan);
Dytek®A is 2-methyl-1,5-pentamethylenediamine (MPMD) (commercially available from Invista, S. à. r. L., of Wichita, KS and Wilmington, DE) (a chain extender, vi in FIG. 1B);
EDA stands for ethylenediamine (a chain extender, vi in FIG. 1B);
DETA stands for diethylenetriamine (a chain extender, vi in FIG. 1B); and
DEA stands for N,N-diethylamine as the isocyanate reactive the block agent (iv).

### Example 1 A Non-End-Linked sPUU Polymer (Comparative)

Terathane® 1800 glycol of 100.00 parts by weight was mixed and reacted with Isonate® 125MDR MDI of 23.47 parts to form an isocyanate-terminated prepolymer (see, e.g., iii in FIG. 1B) with a percent of isocyanate groups (—NCO) at 2.60% of the prepolymer. This prepolymer was then dissolved in N,N-dimethylacetamide (DMAc) of 165.52 parts. This diluted prepolymer solution was allowed to react with a mixture of amines in DMAc solution, containing 1.94 parts of chain extender EDA, 0.42 parts of chain extender Dytek®A, 0.03 parts of chain extender DETA, 0.42 parts of the isocyanate blocking agent DEA and 71.05 parts of dimethyl acetamide (DMAc) using a high speed disperser to form a homogenous solution of protected sPUU polymer (see, e.g., FIG. 1B element vii) with a polymer solids about 34.8% and a viscosity of 2600 poises measured at 40 °C. In this polymer, about three-fourths (75%) of the polymer chain ends were in the form of blocked isocyanate groups, and based on calculations, the those groups at a concentration of 45 meq per kg of the polymer solids.

Proceeding along route C of FIG. 1B the polymer solution was spun into a single thread of 40 denier yarn with 4 filaments twisted together at a wound-up speed of 930 meters per minute. Prior to entering the spinning cell, which was flushed with nitrogen gas of 375 °C at a flow rate of 5.5 kg per hour, the polymer solution temperature was controlled at 50 °C. The dried yarn was applied a silicone oil-based finish prior to winding-up into a tube. This yarn was soluble in DMAc. The as-spun yarn properties of this test item were measured and listed in Table 2.

### Example 2 An End-Linked sPUU Polymer

A solution of protected sPUU polymer (vii) was made according to Example 1. A total of 1600 grams of the solution was mixed with 2.2 grams of a solution of water-free branched polyethylenimine [(PEI) CAS No. 9002-98-6] in DMAc (PEI/DMAc at a 50/50 weight ratio). The PEI crosslinking agent (viii) had a weight average molecular weight (Mw) ~25,000 (Lupasol® Waterfree, by BASF, Rensselaer, NY, Mw by light scattering (LS), with the value provided by the supplier) and a number average molecular weight (Mn) ~10,000 by gel GPC. The mixed polymer solution was spun into a single thread of 40 denier yarn with 4 filaments, using the same condition as described in Example 1. The as-spun yarn was not soluble in DMAc. The as-spun yarn properties of this test item were measured and listed in Table 2.

### Example 3 An End-Linked sPUU Polymer

The same materials, procedures and conditions were used as described in Example 2 except that 6.5 grams of a solution of 50/50 weight ratio of the PEI/DMAc was mixed with the 1600 grams of protected sPUU polymer (vii) solution prepared in Example 1. The as-spun 40 denier yarn was not soluble in DMAc. The as-spun yarn properties of this test item were measured and listed in Table 2.

### Example 4 An End-Linked sPUU Polymer

The same materials, procedures and conditions were used as described in Example 2 except that 10.9 grams of a solution of 50/50 weight ratio of the PEI/DMAc was mixed with the 1600 grams of protected sPUU polymer (vii) solution prepared in Example 1. The as-spun 40 denier yarn was not soluble in DMAc. The as-spun yarn properties of this test item were measured and listed in Table 2.

TABLE 2
Comparison of as-spun yarn properties with and without end-linking

| | PEI | 1TP200 | 5TM200 | 5TM100 | 6SET | 6ELO | 6TEN | DEN-SKEIN |
|---|---|---|---|---|---|---|---|---|
| Example | (%) | (gf) | (gf) | (gf) | (%) | (%) | (gf) | (DEN) |
| 1* | 0.0 | 7.55 | 1.18 | 0.73 | 21.5 | 480 | 59.5 | 43.7 |
| 2 | 0.2 | 7.03 | 0.97 | 0.59 | 24.0 | 496 | 48.5 | 41.8 |
| 3 | 0.6 | 6.63 | 1.16 | 0.71 | 20.0 | 497 | 49.5 | 42.3 |
| 4 | 1.0 | 6.80 | 1.25 | 0.72 | 20.14 | 487 | 50.1 | 42.7 |

*comparative example not end-linked

The strength and elastic properties of the spandex fibers were measured in this example and throughout the patent in accordance with the general method of ASTM D 2731-72. Three filaments, a 5.0 cm gauge length and a 0-300% elongation cycle were used for each of the measurements. The samples were cycled five times at a constant elongation rate of 50 centimeters per minute. Load power (1TP200), the stress on the spandex during initial extension, was measured on the first cycle at 200% extension and is reported as centinewtons (cN) for a given linear density. Unload power (5TM200) is the stress at an extension of 200% for the fifth unload cycle and is also reported in centinewtons. The measure 6SET refers to SET % following 5 elongation cycles (in the 6 the cycle). Percent elongation at break after the sixth (6ELO) and tenacity were measured on a sixth extension cycle. Stress decay (%) was measured as the percentage of the stress reduction in the fifth cycle after a 30 second delay at 300%. Tests are conducted on an Instron model 5500 or model 5965 calibrated as discussed above. 6TEN is the breaking tensile strength measured on a sixth extension cycle. DEN-SKEIN is the denier (thickness) of yarn or thread in grams per 9,000 meters.

Other attributes of the finished polymer or yarn that are often considered are the percent solvent residue determined by infrared spectroscopy and the amount of lubricant applied to the finished polymer or yarn on a percent weight basis. For some applications, such as the preparation of electrochemical cell components, residual solvent (e.g., DMAc) are reduced to negligible levels that do not affect the performance of the cell (near zero percent (0%) by weight) and lubricants are not added and/or applied. For textile goods residual solvent may be, for example, less than 2% or less than 1% (e.g., in the range of 0.5% to 2%) of the polymer or yarn by weight. Often residual solvent will be less than 0.5% or less than 0.2% (e.g., in the range of 0.1% to 0.5%) of the polymer or yarn by weight. For textile goods lubricant may be, for example, less than about 5% or less than about 4% of the polymer or yarn by weight. Alternatively, lubricant may be, for example, less than about 3% or less than about 2.6% of the polymer or yarn by weight (e.g., in the range of 2%-3% by weight).

It can be seen from the above examples that dry spinning of a solution mixture of a segmented polyurethane with blocked isocyanate end groups with a polyamine crosslinking agent can make an end-linked sPUU fiber, as evidenced by its insolubility in DMAc in the original solvent from which it is spun, and no significant negative impact to the yarn properties is observed due to the end-linking mechanism within the test and measurement variability.

### Example 5 A Non-End-Linked sPUU Polymer (Comparative)

Terathane® 1800 glycol of 100.00 parts by weight was mixed and reacted with Isonate® 125MDR MDI of 22.59 parts to form an isocyanate-terminated prepolymer (see, e.g., iii in FIG. 1B) with a percent of isocyanate groups (—NCO) at 2.38% of the prepolymer. This prepolymer was then dissolved in N,N-dimethylacetamide (DMAc) of 166.09 parts. This diluted prepolymer solution was allowed to react with a mixture of amines in DMAc solution, containing 1.96 parts of chain extender EDA, 0.025 parts of chain extender DETA, 0.40 parts of isocyanate blocking agent DEA and 71.18 parts of DMAc using a high speed disperser to form a homogenous solution of protected sPUU polymer (see, e.g., FIG. 1B vii) with a polymer solids about 34.5% and a viscosity of 2500 poises measured at 40 °C. In this polymer, about three-fourths (75%) of the polymer chain ends were blocked isocyanate groups, based on calculations, at a concentration of 43 meq per kg of the polymer solids.

This polymer solution thus formed was mixed with 21.78 parts of a slurry of additives in DMAc with 43.8% solids, which consisted of a white pigment, a blue toner, an antioxidant, a bleach resistant agent, a dye assist agent, a spinning aid and the polymer solution from Example 1 for adjusting the viscosity of the slurry.

This polymer solution mixture was spun into 24 threads of 40 denier yarns, each with 4 filaments twisted together at a wound-up speed of 950 meters per minute. Prior to entering the spinning cell, which was flushed with nitrogen gas of 428 °C at a flow rate of 46.3 kg per hour, the polymer solution temperature was controlled at 85 °C. The dried yarn was applied a silicone oil-based finish prior to winding-up into a tube. This as-spun yarn was soluble in DMAc.

### Example 6 An End-Linked sPUU Polymer

A first solution of protected sPUU polymer (see, e.g., FIG. 1B element vii) with additives made according to Example 5 was mixed with a second solution comprising a crosslinking agent immediately prior to spinning. The second solution containing the crosslinking agent comprised the polymer solution from Example 5 before mixing with additives (50.00% by weight), DMAc (46.36% by weight), and water-free branched polyethylenimine [CAS #9002-98-6] as a crosslinking agent (3.64% by weight). The PEI had a weight average molecular weight (Mw) of about 25,000 by light scattering and a number average molecular weight (Mn) of about 10,000 by GPC). Mixing was accomplished by combining the first and second solutions at a flow rate of 16.71 just prior to mixing and spinning into 24 threads of 40 denier yarns, using the same conditions described in Example 5, except that the polymer solution temperature was controlled at 55 °C prior to entering the spinning cell. The as-spun yarn was not soluble in DMAc.

The following examples illustrate the present invention in form of coated films with crosslinking reaction of polyurethaneurea polymers during (Example 7 through 11) and after (Example 12 through 16) the film formation.

### Example 7 A Non-End-Linked sPUU Polymer Film (Comparative)

The solution of protected sPUU polymer (see, e.g., FIG. 1B element vii) in DMAc as prepared in Example 1 was used to coat a film on an aluminum foil with a 20 mil (1 mil is one thousandth of an inch) blade. The coated film, while still wet was immediately transferred to a nitrogen gas flushed heated oven with at 125 °C for 60 minutes, during which time nitrogen gas flushing continued. The dried film was peeled off the aluminum foil and soaked in DMAc solvent at a weight ratio of solvent to solid of 9 to 1. Within 24 hours, the polymer film was dissolved back into the solvent.

After standing at room temperatures for 48 hours, this polymer solution had a viscosity of 2950 poises measured at 40 °C by a Brookfield viscometer as discussed above.

### Example 8 An End-Linked sPUU Polymer Film

The solution of protected sPUU polymer (see, e.g., FIG. 1B element vii) in DMAc as prepared in Example 1, 200 grams, was mixed with 0.15 grams of a solution of 50/50 weight ratio of the PEI/DMAc as described in Example 2, before coated and dried into a film as disclosed in Example 7. The dried film was insoluble when soaked in DMAc solvent with a weight ratio of solvent to solid at 9 to 1, it absorbed the solvent and swelled in volume instead. After 6 days, the weight ratio of the swelled film with absorbed solvent to the original dried film was at 9.9. Putting this swelled film back into the heated oven for drying at 125 °C for 60 minutes essentially gave back the original weight of dried film before soaking in the DMAC solvent.

After standing at room temperatures for 48 hours, this mixed polymer solution containing PEI had a viscosity of 3217 poises measured at 40 °C by a Brookfield viscometer as described above.

### Example 9 An End-Linked sPUU Polymer Film

The same procedure was followed as in Example 8, except that 200 grams of the solution of protected sPUU polymer was mixed with 0.28 grams of a solution of 50/50 weight ratio of the PEI/DMAc to prepare the mixture for film coating and drying. The dried film was insoluble when soaked in DMAc solvent with a weight ratio of solvent to solid at 9 to 1, it absorbed the solvent and swelled in volume instead. After 6 days, the weight ratio of the swelled film with absorbed solvent to the original dried film was at 5.4.

After standing at room temperatures for 48 hours, this mixed polymer solution containing PEI had a viscosity of 3167 poises measured at 40 °C by a Brookfield viscometer as discussed above.

### Example 10 An End-Linked sPUU Polymer Film

The same procedure was followed as in Example 8, except that 200 grams of the solution of protected sPUU polymer was mixed with 0.56 grams of a solution of 50/50 weight ratio of the PEI/DMAc to prepare the mixture for film coating and drying. The dried film was insoluble when soaked in DMAc solvent with a weight ratio of solvent to solid at 9 to 1, it absorbed the solvent and swelled in volume instead. After 6 days, the weight ratio of the swelled film with absorbed solvent to the original dried film was at 5.5.

After standing at room temperatures for 48 hours, this mixed polymer solution containing PEI had a viscosity of 3317 poises measured at 40 °C by a Brookfield viscometer.

### Example 11 An End-Linked sPUU Polymer Film

The same procedure was followed as in Example 8, except that 200 grams of the solution of protected sPUU polymer was mixed with 1.40 grams of a solution of 50/50 weight ratio of the PEI/DMAc to prepare the mixture for film coating and drying. The dried film was insoluble when soaked in DMAc solvent with a weight ratio of solvent to solid at 9 to 1, it absorbed the solvent and swelled in volume instead. After 6 days, the weight ratio of the swelled film with absorbed solvent to the original dried film was at 4.4.

After standing at room temperatures for 48 hours, this mixed polymer solution containing PEI had a viscosity of 3233 poises measured at 40 °C by a Brookfield viscometer.

### Example 12 (Comparative)

The solution of protected sPUU polymer (see, e.g., FIG. 1B element vii) in DMAc as prepared in Example 1 was used to coat a film on a Mylar® polyester sheet with a 20 mil (1 mil is one thousandth of an inch) blade. The coated film was dried at room temperatures overnight in a vented box with nitrogen gas flushing. The formed film was then heat treated in an oven at 125 °C for 60 minutes. The heat-treated film was peeled off the Mylar® sheet and soaked in DMAc solvent at a weight ratio of solvent to solid of 9.5 to 1. Within 24 hours, the polymer film was dissolved in the solvent.

### Example 13

The same procedure was followed as in Example 12, except that the mixture of protected sPUU polymer and PEI in DMAc as prepared in Example 8 was used for film coating, drying and heat treatment. The heat-treated film was insoluble in soaked DMAc, it instead swelled.

### Example 14

The same procedure was followed as in Example 12, except that the mixture of protected sPUU polymer and PEI in DMAc as prepared in Example 9 was used for film coating, drying and heat treatment. The heat-treated film was insoluble in soaked DMAc, it instead swelled.

### Example 15

The same procedure was followed as in Example 12, except that the mixture of protected sPUU polymer and PEI in DMAc as prepared in Example 10 was used for film coating, drying and heat treatment. The heat-treated film was insoluble in soaked DMAc, it instead swelled.

### Example 16

The same procedure was followed as in Example 12, except that the mixture of protected sPUU polymer and PEI in DMAc as prepared in Example 11 was used for film coating, drying and heat treatment. The heat-treated film was insoluble in soaked DMAc, it instead swelled.

### Example 17 Polyamine Crosslinking Agents and Crosslinking Agent Addition Range Determination

To demonstrate the technique for determining suitable ranges of crosslinking agent for end-linking reactions a protected sPUU polymer (vii) with ethylene diamine blocked isocyanate groups was prepare and reacted with varying amounts of PEI as a crosslinking agent and subjected to analysis.

For the synthesis of the protected sPUU (vii) a glycol (i) poly(tetramethylene ether) glycol (PTMEG) with a number average molecular weight of 1800 (Terathane© 1800) 100.00 parts by weight was mixed and reacted with Isonate® 125MDR MDI (ii) of 23.47 parts, with the capping ratio (NCO/OH) at 1.69, to form an isocyanate-terminated prepolymer (iii) with a percent of isocyanate groups (—NCO) at 2.60% of the prepolymer. This prepolymer was then dissolved in 165.52 parts N,N-dimethylacetamide (DMAc). The dissolved prepolymer solution was allowed to react with a mixture of amine chain extenders (vi) and a blocking agent (iv), containing 1.94 parts of EDA (vi), 0.42 parts of Dytek®A (vi), 0.03 parts of DETA, 0.42 parts of DEA (iv) dissolved in 71.05 parts of DMAc. using a high speed disperser to form a homogenous solution of the protected polyurethaneurea (vii) in solution with a polymer solids about 34.8% and a viscosity of 2600 poises measured at 40 °C.

Samples of the protected polymer (vii) were mixed with various amounts of water free PEI (Lupasol® WF, from BASF), 50 wt % solids in DMAc to have a range of PEI from 0 to 1.0 wt % in total polymer solids. These solutions were placed in aluminum sample pans which formed a thin layer at the bottom of the pan. These samples were heated in a nitrogen flushed oven at 125 °C for 60 minutes for drying. After drying, the samples were cooled and conditioned at room temperatures for 24 hours. The heat-treated films peeled off from the aluminum pan, with precise weights in a range of 0.6 to 0.8 grams, were then soaked in about 9 grams of DMAc for 5 days at room temperatures. All samples except for the one without the crosslinking agent were to some degree insoluble in DMAc after soaking, although swelling was visible, indicating the formation of crosslinked structure. These soaked and swollen films were then removed from the solvent and dried in the oven at 125 °C for 60 minutes to remove the absorbed solvent. After drying, the solid gels were weighed precisely to determine the gel content by weight after cooling down and conditioned for 24 hours at 22 °C. The gel content expressed as the % wt based on the total weight of solids is plotted in FIG. 3 against the amount of the crosslinking agent used in the end-linking reaction. The data indicate that the optimum amount of the PEI crosslinking agent needed to produce the highest end-linking density was in the range of about 0.2% to about 0.5 wt % PEI (at least about 98% of the polymer solids were in insoluble gel). The range of acceptable amounts of PEI may be somewhat broader (e.g., greater than 95% of the polymer solids are in the insoluble gel) or narrower depending on the specific end use of the end-linked sPUU. Final optimization within the acceptable range of crosslinking agent should consider the desired properties in the specific end use.

### Example 18 Stability of Compositions Comprising Blocked Isocyanate Groups and Crosslinking Agents at Holding (Pre-End-Linking Reaction) Temperatures

In order to evaluate the stability of composition comprising a polymer or a protected prepolymer the viscosity of compositions was assessed. For the evaluation samples of the protected polymer (vii) prepared as in Example 17 were mixed with various amounts of the crosslinking agent PEI (Lupasol® WF, from BASF), 50 wt % solids in DMAc to have a range of PEI content (0%, 0.1%, 0.2%, 0.4%, and 0.99% by weight. The initial viscosity was measured in a Brookfield viscosimeter as discussed above and the samples were then held at 40 °C for two weeks with the viscosity measured again on day 7 and day 14. The results plotted in FIG. 4 show initial viscosities of approximately 3000 poises at 40 °C for all samples. The data indicate that at a holding temperature of 40 °C the protected polymer underwent time dependent reaction with the crosslinking agent, but that diethylamine blocking group was suitably stable at all PEI concentrations for up to 7 days. By day 15 substantial increases in viscosity were observed, indicating that the ability to hold compositions prior to initiating end-linking reactions is limited. Holding time will be dependent upon, among other things, the blocking agent and its deblocking temperature, the shaping/forming technique used to create articles from the composition, and the specific requirements of the final end-linked sPUU and article.

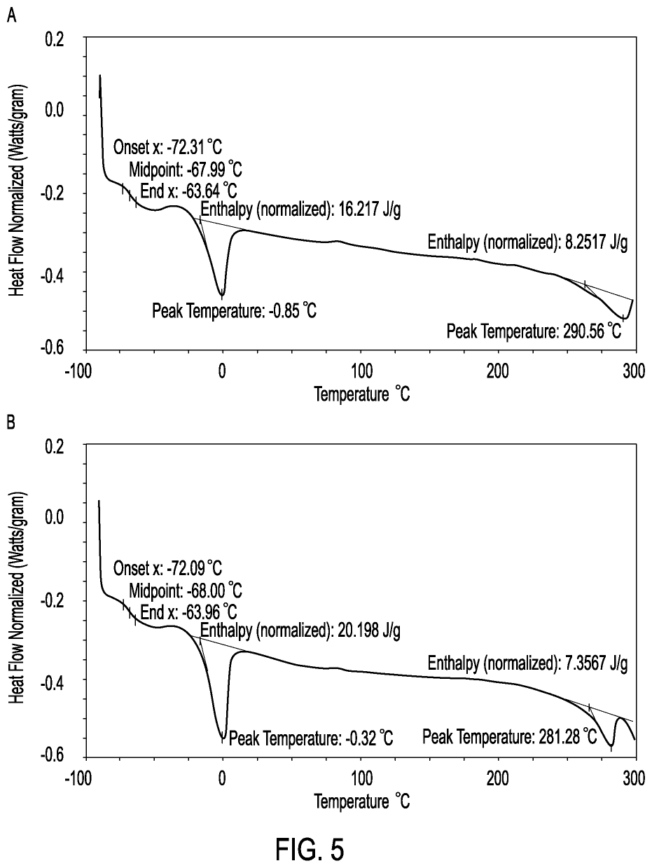

Differential scanning calorimetry (DSC, conducted consistent with ASTM 3418-21) and thermogravimetric analysis (TGA, conducted consistent with ASTM E1131-20) were conducted on the polymer sample end-linked with 0.4% PEI crosslinker and insoluble in DMAc. As a comparison for DSC and TGA testing an otherwise identical sPUU control sample not subject to crosslinking (soluble in DMAc) was used. The comparative testing shows essentially no change in the glass transition temperature (about −68 °C), melting near 0 °C, or the long plateau from about 25 °C to 250 °C related to the elastomeric soft segment between the end-linked and control sample. In the end-linked sample the hard segment peak decreases from about 290 °C to about 281 °C as would be expected due to the interference of end-linked PEI polymer which does not permit the hard segments to align/crystalize in the end-linked polymer. See Table 3 and FIG. 5. at A (control sample) and at B end-linked sample. TGA analysis of the control and end-linked polymer samples under air and nitrogen shows the degradation in air is shifted to higher temperatures in the end-linked sample.

TABLE 3

| Feature | Control Sample | | End-Linked Sample | |
|---|---|---|---|---|
| Glass Transition onset | −72.31 | (°C) | −72.09 | (°C) |
| Glass Transition | −67.99 | (°C) | −68.00 | (°C) |
| midpoint | | | | |
| Glass Transition end | −63.64 | (°C) | −63.96 | (°C) |
| Soft Segment Melting | −0.85 | (°C) | −0.32 | (°C) |
| Soft Segment Melting | 16.217 | Joules/gram | 20.198 | Joules/gram |
| Enthalpy | | | | |
| Hard Segment Melting | 290.56 | (°C) | 281.28 | (°C) |
| Hard Segment Melting | 8.2517 | Joules/gram | 7.3567 | Joules/gram |
| Enthalpy | | | | |

### Example 19

Secondary cells were prepared by combining particles of NMC (85:05:10) 99 parts to 1 part of a composition comprising (a) the protected polymer (vii), and (b) PEI as a crosslinking agent (0.4% relative to the vii) as in Example 17. The materials were mixed with DMAc and layered on to an aluminum foil current collector. Solvent was evaporated and the sample heated to bring about end-linking (e.g., at 125 °C) thereby forming a cathode for a lithium-ion secondary cell. The same process was employed to prepare a cathode with LFP (88:4:8) as the cathode active material in place of the NMC. SEM image of cross sections through the cathodes before assembly into batteries and after repeated electrochemical cycling are shown in FIG. 7. A control cathode was prepared using 1% PVDF and NMC dissolved in DMAc.

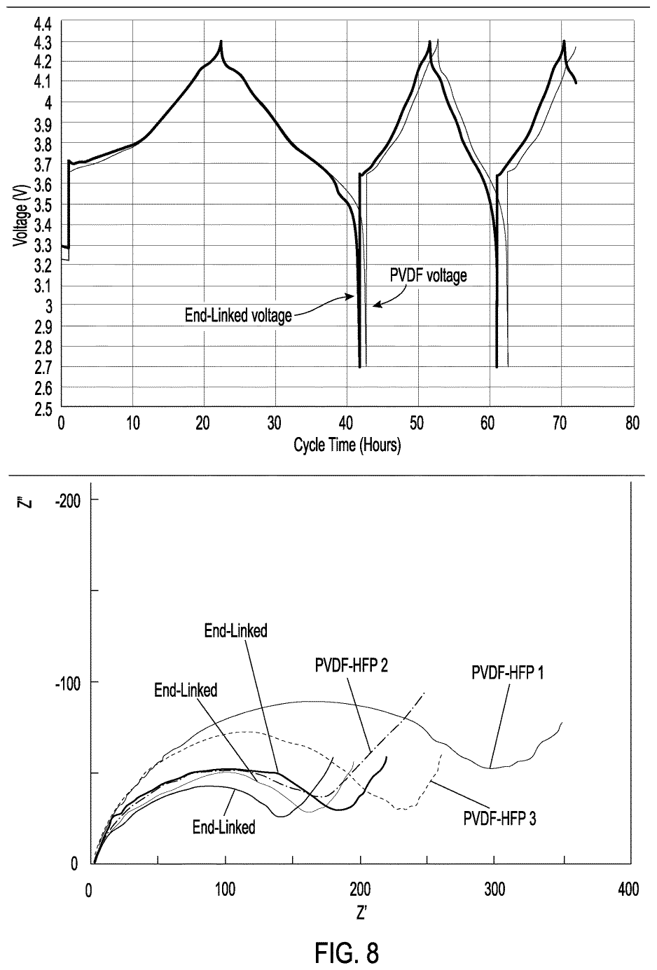

The cathodes described above were assembled into lithium ion secondary cells using an electrolyte comprising dimethyl carbonate (DMC), diethylcarbonate (DEC), ethylene carbonate (EC) (at a 1:1:1 volume ratio) as the liquid component of the electrolyte and Li hexafluorophosphate as the electrolyte salt. The anode was graphite. FIG. 8 (upper portion) shows a voltage trace of an NMC secondary cell charge and discharge cycle with end-linked sPUU as a binder compared with a control cell with PVDF as a binder. The initial cycling shows secondary cells with the cathode having end-linked sPUU as the NMC binder is reliable and its performance substantially matches the cathode with PVDF binder. Measurements of electrochemical impedance of three cells with NMC cathodes bound by the end-linked sPUU and three cells using PVDF as a binder were made. The results (see the lower portion of FIG. 8) show the cells with end-linked sPUU binders have a lower impedance and hence resistance to the flow of ions indicating the cells are capable of operating at a higher current density.

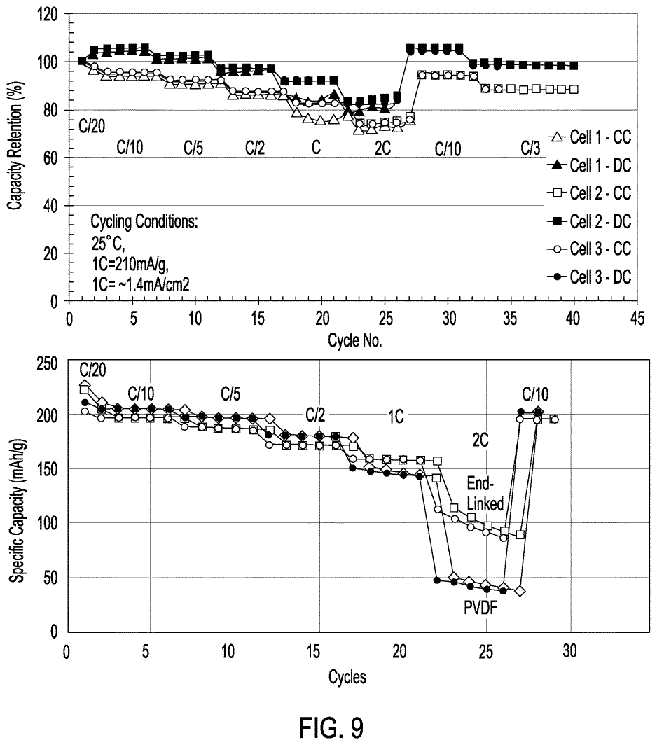

Three NMC cell were compared for their ability to be charged (cc) and discharged (dc) repeatedly at different current densities expressed as “C” (210 milli amperes/g (mA/g) or a multiple or fraction of C. The capacity to charge and discharge is recorded as a series of charge and discharge cycles relative to the initial cycle at C/20. The data indicate that the test cells with NMC electrodes bound by end-linked sPUUs can be charged effectively from C/20 to C, but that capacity retention decreases particularly at C or 2 C current density. The capacity retention is recovered by again charging the cells at lower current densities such as C/10 or C/3. See FIG. 9 (upper plot). Comparison of cells having NMC cathode with PVDF and end-linked sPUU binders shows that at they perform comparably through multiple charging cycles until charging at about 2 C in current density, at which point the PVDF has a lower specific capacity (expressed in milliampere hours/gram or mAh/g). The specific capacity lost to charging at high current density (e.g. 2C) can be recovered by charging at lower current densities (e.g., C/10) as shown in the lower plot of FIG. 9.

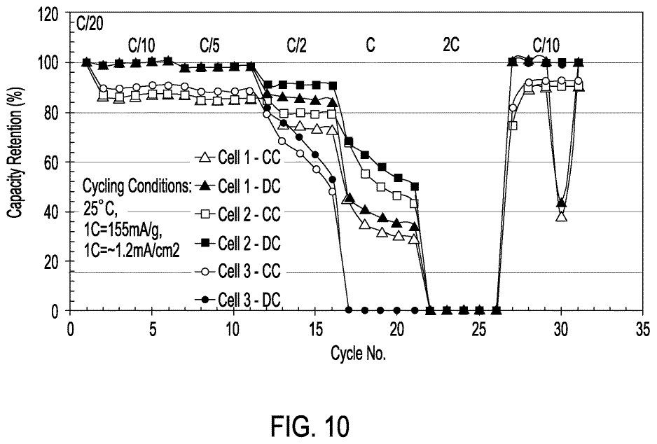

FIG. 10 shows the capacity retention relative to that upon initial charging of three cells prepared with LFP cathodes and end-linked sPUU binders. Like the cells with NMP cathodes the capacity retention decreases at greater cycling current densities. At a current density of 155 mA/g (1C for these cells) or above the capacity retention is substantively reduced, but can be recovered in whole or in part by charging at lower current densities such as C/10.

1.-9. (canceled)

10. A method of producing a cathode for an electrochemical cell comprising an end-linked segmented polyurethane urea (sPUU) as a binder for cathode active material method comprising:
A) providing a current collector having a surface optionally comprising an insulator on part of its surface;
B) providing a coating composition comprising the particles of cathode active material and a solvent in which is dissolved either:
(a) one or more protected prepolymer(s) comprising blocked isocyanate end groups, one or more chain extender(s), and one or more polyamine crosslinking agent(s), or
(b) one or more linear protected polymer(s) with chains comprising blocked isocyanate end groups and one or more polyamine crosslinking agent(s),
wherein
(i) the protected prepolymer comprises one or more linear glycols that have been reacted with one or more isocyanates and one or more isocyanate blocking agents to form the protected prepolymer,
(ii) the protected polymer comprises one or more linear glycols that have been reacted with one or more isocyanates, a diamine chain extender, and one or more isocyanate blocking agents to form the protected polymer,
(iii) the one or more linear glycols comprise one or more linear polyether glycols, linear polyester-glycols, linear polycarbonate-glycols or combinations of any thereof, and
(iv) the blocked isocyanate groups are protected with thermolabile protecting groups;
C) applying the coating composition to at least a portion of the surface of the current collector to form a coated portion;
D) drying the coating composition applied to the current collector to remove the solvent; and
E) heating the current collector coated on all or part of its surface with the coating composition to a temperature high enough to remove the thermolabile protecting group and deblock the protected prepolymers or protected polymers, thereby reconstituting active isocyanates that can react with the amine groups in the one or more crosslinking agents and/or the one or more crosslinking agents and one or more chain extenders to form a coating of end-linked sPUU comprising linear polyurethaneurea polymer chains on the coated portion of the current collector.

11. The method of claim 10, wherein the cathode active material comprises one or more metallic elements.

12. The method of claim 11, wherein the coating composition further comprises an electrically conductive material.

13. The method of claim 12, wherein the linear polyurethaneurea polymer chains comprise soft segments and hard segments, having a soft segment to hard segment weight ratio, SSMW/HSMW (i.e., soft segment Mn/hard segment Mn), from about 5 Daltons (Da) to about 20 Da.

14. The method of claim 13, wherein the one or more crosslinking agents comprise a polymeric polyamine crosslinking agent selected from the group consisting of: linear poly(methylene amine), poly(vinyl amine), poly(allyl amine), poly(aminoethyl acrylate), poly(aminoethyl methacrylate), poly(N-amino ethylene imine), poly(aminopropyl methyl siloxane) or its copolymers, branched poly(ethylene imine), a dendrimeric polyethylenimine (PEI), a highly branched PEI, and a polyamidoamine (PAMAM) dendrimer.

15. The method of claim 14, wherein the one or more crosslinking agents are PEI with a weight average molecular weight (Mw) from about 800 Da to about 25,000 Da.

16. A cathode of an electrochemical cell made by the method of claim 10.

17. The cathode of claim 16, wherein the sPUU comprises from about 0.2% to about 6% and the cathode active material comprises from about 94% to about 99.8% of the cathode composition excluding any solvent.

18. The cathode of claim 17, wherein the cathode active material comprises at least one of a nickel manganese cobalt oxide (NMC), a lithium iron phosphate (LFP), a nickel manganese cobalt aluminum (NMCA), a lithium manganese nickel oxide (LMNO), and/or a lithium manganese oxide (LMO).

19. The cathode of claim 17, wherein the cathode active material comprises at least one of a lithium iron phosphate (LFP), a lithium manganese nickel oxide (LMNO), or a lithium manganese oxide (LMO).

20. The method of claim 11, wherein the one or more metallic elements is selected from the group consisting of lithium, sodium, nickel, cobalt, manganese, magnesium, and aluminum.

21. The method of claim 20, wherein the cathode active material comprises at least one of a nickel manganese cobalt oxide (NMC), a lithium iron phosphate (LFP), a nickel manganese cobalt aluminum (NMCA), a lithium manganese nickel oxide (LMNO), and/or a lithium manganese oxide (LMO).

22. The method of claim 20, wherein the current collector comprises a material selected independently from the group consisting of aluminum, brass, bronze, cobalt, tungsten, copper, graphite, indium, magnesium, platinum, iron, nickel, nickel-zirconia, copper-zirconia, copper nickel-zirconia, copper cobalt-zirconia, zinc, and combinations thereof.

23. The method of claim 20, wherein the current collector comprises a material selected independently from the group consisting of aluminum, nickel, cobalt, tungsten, copper, and a combination thereof.

24. The method of claim 23, wherein the current collector is comprised of a foamed metal, a metal sheet, a metal layer applied on the surface of a polymer, an electrically conductive polymer, or a carbon or carbonaceous material.

25. A cathode of an electrochemical cell made by the method of claim 15.

26. A cathode of an electrochemical cell made by the method of claim 24.

27. A cathode of a lithium-ion electrochemical cell comprising a current collector having a surface all or part of which is coated with a coating comprised of particles of a cathode active material and a binder, wherein:
(i) the binder is comprised of an end-linked segmented polyurethaneurea (sPUU) comprising linear polyurethaneurea;
(ii) the end-linked sPUU adheres to the current collector;
(iii) the cathode active material comprises lithium, sodium, nickel, cobalt, manganese, magnesium, or aluminum; and
(iv) the coating is in electrical contact with the current collector.

28. The cathode of claim 27, wherein:
the current collector is in the form of a metal sheet, foil, or layer on a polymer backing and wherein the metal is comprised of aluminum or nickel;
the end-linked sPUU comprises a soft segment comprising one or more linear polyether glycols; and
the sPUU adheres to the current collector with a peel strength of 3-85 N/m as determined under ASTM D3330/D3330M-04 (2018).

29. The cathode of claim 27, wherein the cathode active material comprises at least one of a nickel manganese cobalt oxide (NMC), a lithium iron phosphate (LFP), a nickel manganese cobalt aluminum (NMCA), a lithium manganese nickel oxide (LMNO), and/or a lithium manganese oxide (LMO).
